(19) United States
(12) Patent Application Publication
(10) Pub. No.: US 2022/0272685 A1
(43) Pub. Date: Aug. 25, 2022

(54) METHOD AND APPARATUS FOR DYNAMIC MULTI-BEAM OPERATIONS

(71) Applicant: Samsung Electronics Co., Ltd., Suwon-si (KR)

(72) Inventors: Md. Saifur Rahman, Plano, TX (US); Eko Onggosanusi, Coppell, TX (US); Emad N. Farag, Flanders, NJ (US)

(21) Appl. No.: 17/667,347

(22) Filed: Feb. 8, 2022

Related U.S. Application Data
(60) Provisional application No. 63/149,151, filed on Feb. 12, 2021.
(60) Provisional application No. 63/154,366, filed on Feb. 26, 2021.
(60) Provisional application No. 63/242,938, filed on Sep. 10, 2021.
(60) Provisional application No. 63/274,755, filed on Nov. 2, 2021.

(51) Int. Cl. H04W 72/04; H04L 5/00

(52) U.S. Cl. CPC H04W 72/046; H04L 5/0048; H04L 5/001

(57) ABSTRACT

A method for operating a user equipment (UE) comprises receiving configuration information including a list of CCs and a set of TCI states; receiving a TCI state update that is common for the list of CCs; and for each CC(i) in the list of CCs, where i is a CC index: determining a beam bᵢ based on the TCI state update, and applying the beam bᵢ for reception of a DL control channel or a DL data channel associated with the CC(i), wherein the beam bᵢ is determined based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

### CROSS-REFERENCE TO RELATED APPLICATIONS AND CLAIM OF PRIORITY

The present application claims priority to U.S. Provisional Patent Application No. 63/149,151, filed on Feb. 12, 2021, U.S. Provisional Patent Application No. 63/154,366, filed on Feb. 26, 2021, U.S. Provisional Patent Application No. 63/242,938, filed on Sep. 10, 2021, and U.S. Provisional Patent Application No. 63/274,755, filed on Nov. 2, 2021. The content of the above-identified patent documents is incorporated herein by reference.

### TECHNICAL FIELD

The present disclosure relates generally to wireless communication systems and more specifically to methods for enabling dynamic multi-beam operations.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE. For a millimeter wave communication systems, the reference signal can correspond to a spatial beam, and the CSI can correspond to a beam report which indicates a preferred spatial beam for communication. In such beamformed systems, a beam indication mechanism is needed in order to align the spatial beams at both gNB and UE.

### SUMMARY

Embodiments of the present disclosure provide methods and apparatuses to enable dynamic multi-beam operations in a wireless communication system.

In one embodiment, a UE in a wireless communication system is provided. The UE includes a transceiver configured to receive configuration information including a list of component carriers (CCs) and a set of transmission configuration indicator (TCI) states; and receive a TCI state update that is common for the list of CCs. The UE further includes a processor operably coupled to the transceiver. The processor is configured to: for each CC(i) in the list of CCs, where i is a CC index: determine a beam bᵢ based on the TCI state update, and apply the beam bᵢ for reception of a downlink (DL) control channel or a DL data channel associated with the CC(i), wherein the beam bᵢ is determined based on a spatial property used to receive or transmit a reference signal (RS) rᵢ, and wherein the TCI state update includes a source RS s and, for each CC(i) in the list of CCs, the source RS s provides a reference to the RS rᵢ for determination of the beam bᵢ for the CC(i).

In another embodiment, a BS in a wireless communication system is provided. The BS includes a processor configured to generate configuration information including a list of CCs and a set of TCI states; and generate a TCI state update that is common for the list of CCs. The BS further includes a transceiver operably coupled to the processor. The transceiver is configured to: transmit the configuration information; transmit the TCI state update; and for each CC(i) in the list of CCs, where i is a CC index: transmit a DL control channel or a DL data channel associated with the CC(i) for reception via a beam bᵢ, wherein the beam bᵢ is based on the TCI state update, wherein the beam bᵢ is based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

In yet another embodiment, a method for operating a UE is provided. The method comprises: receiving configuration information including a list of CCs and a set of TCI states; receiving a TCI state update that is common for the list of CCs; and for each CC(i) in the list of CCs, where i is a CC index: determining a beam bᵢ based on the TCI state update, and applying the beam bᵢ for reception of a DL control channel or a DL data channel associated with the CC(i), wherein the beam bᵢ is determined based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates an uplink multi-beam operation according to embodiments of the present disclosure;

FIG. 11 illustrates an uplink multi-beam operation according to embodiments of the present disclosure;

FIG. 12 illustrates a downlink multi-beam operation according to embodiments of the present disclosure;

FIG. 13 illustrates an example of common beam indication across multiple CCs according to embodiments of the present disclosure;

FIG. 14 illustrates an example of a dedicated DCI indicating the common beam for the reception of DL control and data according to embodiments of the present disclosure;

FIG. 15 illustrates an example of receiving DL-TCI-DCI and DL-DCI in the same slot or subframe according to embodiments of the present disclosure;

FIG. 16 illustrates an example of the receiving DL-TCI-DCI and DL-DCI at different time-frequency resources within the same slot according to embodiments of the present disclosure;

FIG. 17 illustrates an example of a dedicated DCI indicating the common beam for the transmission of UL control and data according to embodiments of the present disclosure;

FIG. 18 illustrates an example of receiving UL-TCI-DCI and UL-DCI in the same slot or subframe according to embodiments of the present disclosure;

FIG. 19 illustrates an example of a dedicated DCI indicating the common beam for all DL and UL channels according to embodiments of the present disclosure;

FIG. 20 illustrates an example of receiving TCI-DCI and DL-DCI in the same slot or subframe according to embodiments of the present disclosure;

FIG. 21 illustrates an example of receiving TCI-DCI and UL-DCI in the same slot or subframe according to embodiments of the present disclosure;

FIG. 22 illustrates an example of receiving TCI-DCI, UL-DCI, and DL-DCI in the same slot or subframe according to embodiments of the present disclosure;

FIG. 23 illustrates examples of configuring common TCI state pool and common TCI state ID across multiple CCs according to embodiments of the present disclosure;

FIG. 24 illustrates a flow chart of a method for operating a UE according to embodiments of the present disclosure; and

FIG. 25 illustrates a flow chart of a method for operating a BS according to embodiments of the present disclosure.

### DETAILED DESCRIPTION

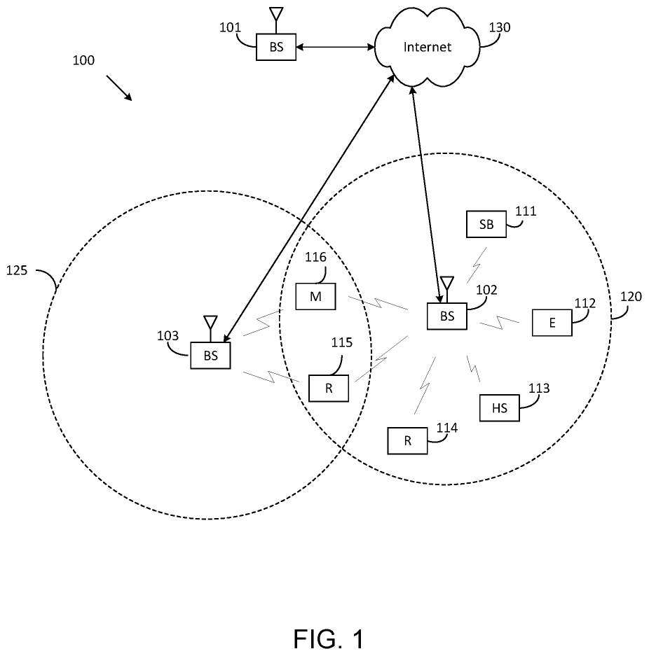

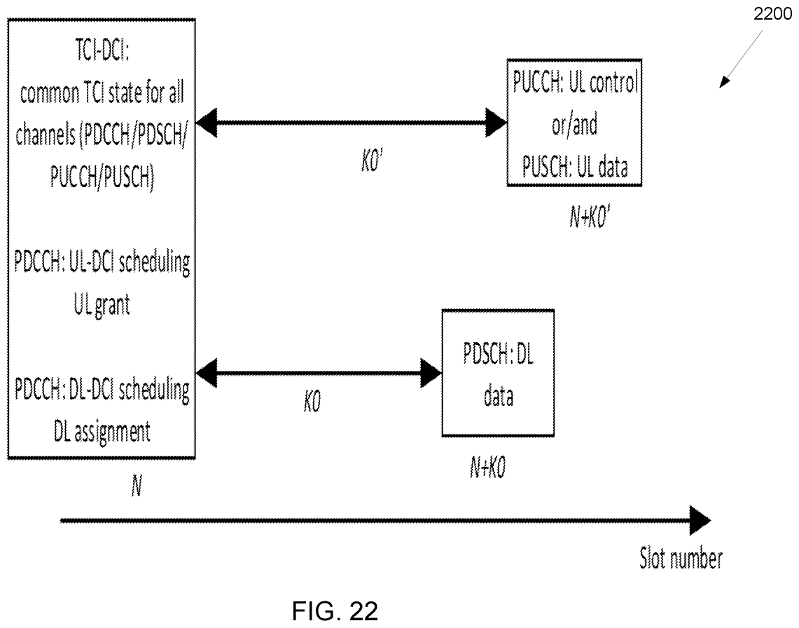

FIG. 1 through FIG. 25, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v v17.0.0, “E-UTRA, Physical Layer Procedures” (herein “REF 3”); 3GPP TS 36.321 v v17.0.0, “E-UTRA, Medium Access Control (MAC) protocol specification” (herein “REF 4”); 3GPP TS 36.331 v v17.0.0, “E-UTRA, Radio Resource Control (RRC) protocol specification” (herein “REF 5”); 3GPP TS 38.211 v v17.0.0, “NR, Physical channels and modulation” (herein “REF 6”); 3GPP TS 38.212 v v17.0.0, “E-UTRA, NR, Multiplexing and channel coding” (herein “REF 7”); 3GPP TS 38.213 v17.0.0, “NR, Physical Layer Procedures for Control” (herein “REF 8”); 3GPP TS 38.214 v17.0.0; “NR, Physical Layer Procedures for Data” (herein “REF 9”); 3GPP TS 38.215 v17.0.0, “NR, Physical Layer Measurements” (herein “REF 10”); 3GPP TS 38.321 v17.0.0, “NR, Medium Access Control (MAC) protocol specification” (herein “REF 11”); and 3GPP TS 38.331 v17.0.0, “NR, Radio Resource Control (RRC) Protocol Specification” (herein “REF 12”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving configuration information including a list of CCs and a set of TCI states; receiving a TCI state update that is common for the list of CCs; and for each CC(i) in the list of CCs, where i is a CC index: determining a beam bᵢ based on the TCI state update, and applying the beam bᵢ for reception of a DL control channel or a DL data channel associated with the CC(i), wherein the beam bᵢ is determined based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i). One or more of the gNBs 101-103 includes circuitry, programing, or a combination thereof, for generating configuration information including a list of CCs and a set of TCI states; generating a TCI state update that is common for the list of CCs; transmitting the configuration information; transmitting the TCI state update; and for each CC(i) in the list of CCs, where i is a CC index: transmitting a DL control channel or a DL data channel associated with the CC(i) for reception via a beam bᵢ, wherein the beam bᵢ is based on the TCI state update, wherein the beam bᵢ is based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

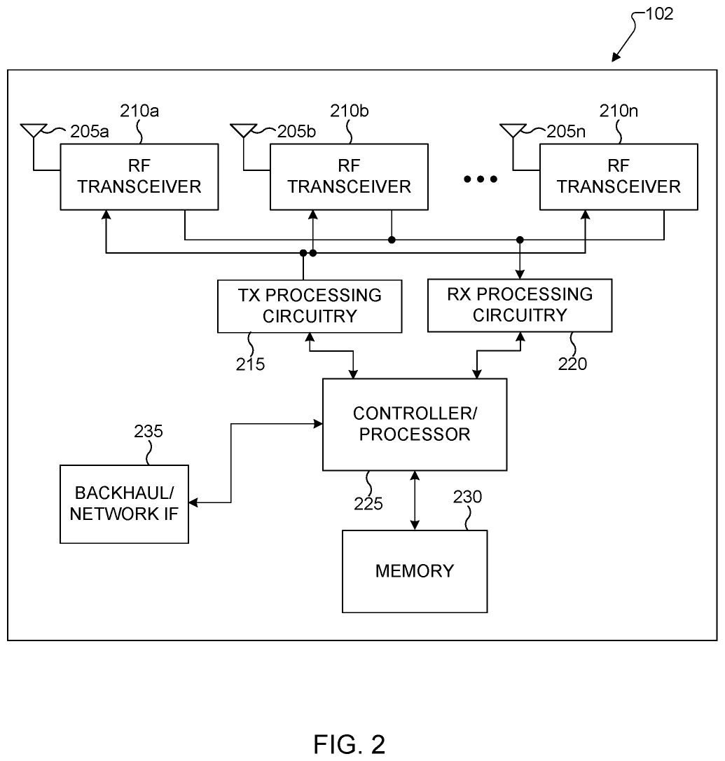

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of DL channel signals and the transmission of UL channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

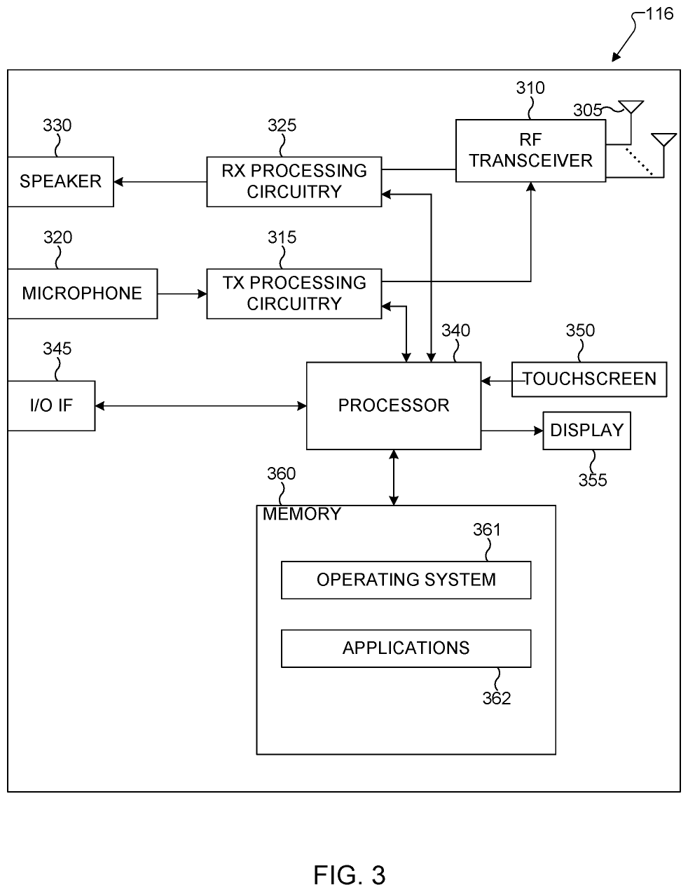

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving configuration information including a list of CCs and a set of TCI states; receiving a TCI state update that is common for the list of CCs; and for each CC(i) in the list of CCs, where i is a CC index: determining a beam bᵢ based on the TCI state update, and applying the beam bᵢ for reception of a DL control channel or a DL data channel associated with the CC(i), wherein the beam bᵢ is determined based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i). The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

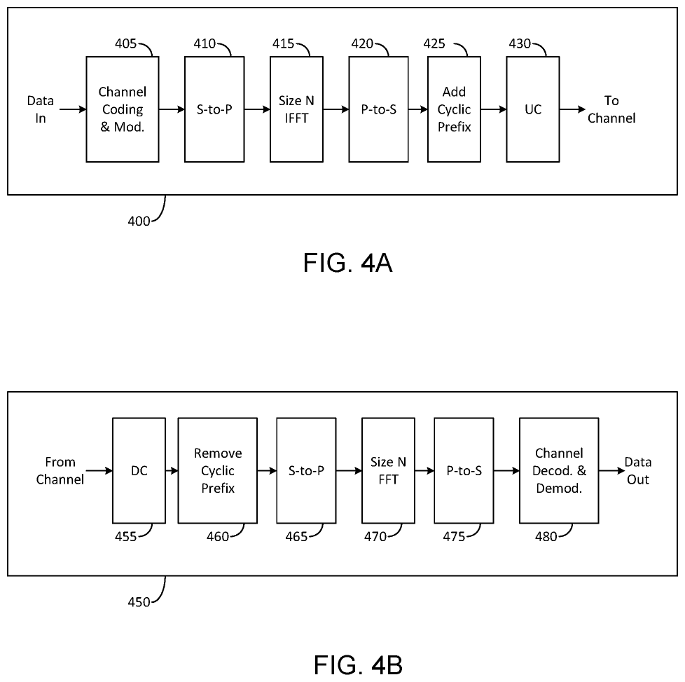

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460 and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

5G communication system use cases have been identified and described. Those use cases can be roughly categorized into three different groups. In one example, enhanced mobile broadband (eMBB) is determined to do with high bits/sec requirement, with less stringent latency and reliability requirements. In another example, ultra reliable and low latency (URLL) is determined with less stringent bits/sec requirement. In yet another example, massive machine type communication (mMTC) is determined that a number of devices can be as many as 100,000 to 1 million per km2, but the reliability/throughput/latency requirement could be less stringent. This scenario may also involve power efficiency requirement as well, in that the battery consumption may be minimized as possible.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIB s that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{EPDCCH} sub-carriers, or resource elements (REs), such as 12 REs. A unit of one RB over one subframe is referred to as a PRB. A UE can be allocated nₛ=(nₛ₀+y·N_{EPDCCH}) mod D RBs for a total of Z=O_{F}+└(nₛ₀+y·N_{EPDCCH})/D┘ REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe symbol can be used to multiplex SRS transmissions from one or more UEs. A number of subframe symbols that are available for data/UCI/DMRS transmission is N_{symb}=2·(N_{symb}^{UL}−1)−N_{SRS}, where N_{SRS}=1 if a last subframe symbol is used to transmit SRS and N_{SRS}=0 otherwise.

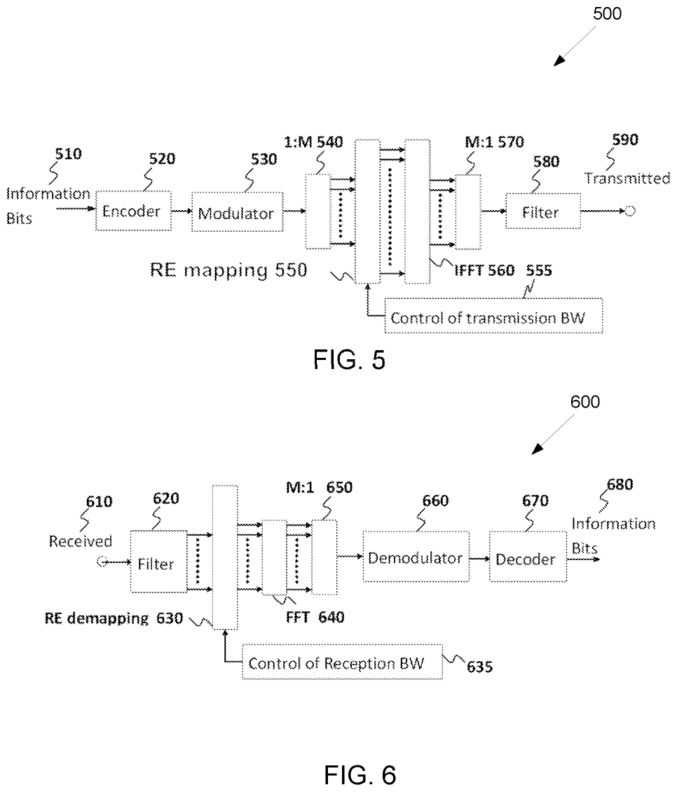

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

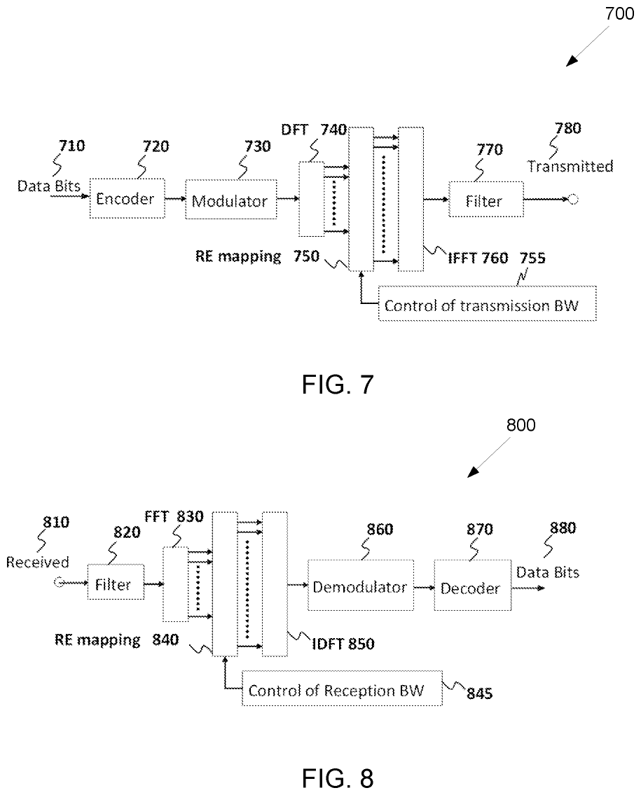

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

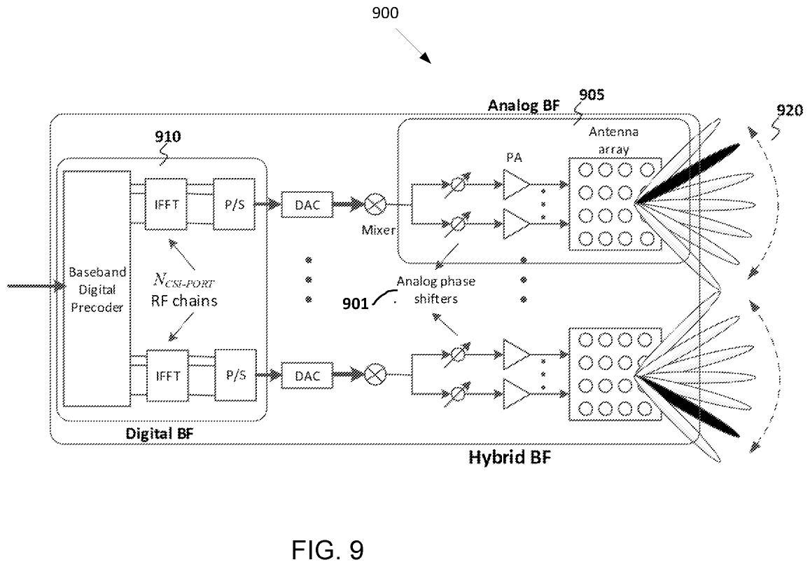

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

Rel.14 LTE and Rel.15 NR specifications support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

In 3GPP LTE and NR (new radio access or interface), network access and radio resource management (RRM) are enabled by physical layer synchronization signals and higher (MAC) layer procedures. In particular, a UE attempts to detect the presence of synchronization signals along with at least one cell ID for initial access. Once the UE is in the network and associated with a serving cell, the UE monitors several neighboring cells by attempting to detect their synchronization signals and/or measuring the associated cell-specific RSs (for instance, by measuring their RSRPs). For next generation cellular systems, efficient and unified radio resource acquisition or tracking mechanism which works for various use cases (such as eMBB, URLLC, mMTC, each corresponding to a different coverage requirement) and frequency bands (with different propagation losses) is desirable. Most likely designed with a different network and radio resource paradigm, seamless and low-latency RRM is also desirable. Such goals pose at least the following problems in designing an access, radio resource, and mobility management framework.

First, since NR is likely to support even more diversified network topology, the notion of cell can be redefined or replaced with another radio resource entity. As an example, for synchronous networks, one cell can be associated with a plurality of TRPs (transmit-receive points) similar to a COMP (coordinated multipoint transmission) scenario in LTE. In this case, seamless mobility is a desirable feature. Second, when large antenna arrays and beamforming are utilized, defining radio resource in terms of beams (although possibly termed differently) can be a natural approach. Given that numerous beamforming architectures can be utilized, an access, radio resource, and mobility management framework which accommodates various beamforming architectures (or, instead, agnostic to beamforming architecture) is desirable. For instance, the framework should be applicable for or agnostic to whether one beam is formed for one CSI-RS port (for instance, where a plurality of analog ports are connected to one digital port, and a plurality of widely separated digital ports are utilized) or one beam is formed by a plurality of CSI-RS ports. In addition, the framework should be applicable whether beam sweeping (as illustrated in FIG. 9) is used or not. Third, different frequency bands and use cases impose different coverage limitations. For example, mmWave bands impose large propagation losses. Therefore, some form of coverage enhancement scheme is needed. Several candidates include beam sweeping (cf. FIG. 9), repetition, diversity, and/or multi-TRP transmission. For mMTC where transmission bandwidth is small, time-domain repetition is needed to ensure sufficient coverage.

A prerequisite to seamless access is significant reduction of higher-layer procedures for UEs which are already connected to the network. For instance, the existence of cell boundaries (or in general the notion of cells) necessitates RRC (L3) reconfiguration as a UE moves from one cell to another (i.e., inter-cell mobility). For heterogeneous networks with closed subscriber groups, additional overhead associated with higher layer procedures may further tax the system. This can be achieved by relaxing the cell boundaries thereby creating a large “super-cell” wherein a large number of UEs can roam. In this case, high capacity MIMO transmission (especially MU-MIMO) becomes more prevalent. While this presents an opportunity to increase system capacity (measured in terms of the number of sustainable UEs), it requires a streamlined MIMO design. This poses a challenge if applied in the current system.

Therefore, there is a need for an access, radio resource, and mobility management framework which facilitates seamless access by reducing the amount of higher layer procedures. In addition, there is also a need for a streamlined MIMO design that facilitates high capacity MIMO transmission.

In the Rel. 15 NR specification, multi-beam operation is designed primarily for single transmit-receive point (TRP) and single antenna panel. Therefore, the specification supports beam indication for one TX beam wherein a TX beam is associated with a reference RS. For DL beam indication and measurement, the reference RS can be NZP (non-zero power) CSI-RS and/or SSB (synchronization signal block, which includes primary synchronization signal, secondary synchronization signal, and PBCH). Here, DL beam indication is done via the transmission configuration indicator (TCI) field in DL-related DCI which includes an index to one (and only one) assigned reference RS. A set of hypotheses or the so-called TCI states is configured via higher-layer (RRC) signaling and, when applicable, a subset of those TCI states is selected/activated via MAC CE for the TCI field code points. For UL beam indication and measurement, the reference RS can be NZP CSI-RS, SSB, and/or SRS. Here, UL beam indication is done via the SRS resource indicator (SRI) field in UL-related DCI which is linked to one (and only one) reference RS. This linkage is configured via higher-layer signaling using the SpatialRelationInfo RRC parameter. Essentially, only one TX beam is indicated to the UE.

In the 3GPP NR specification, beam management was designed to share the same framework as CSI acquisition. This, however, compromises the performance of beam management especially for FR2. This is because beam management operates mainly with analog beams (characteristic of FR2) which paradigmatically differ from CSI acquisition (designed with FR1 in mind). Consequently, the 3GPP NR specification beam management becomes cumbersome and is unlikely able to keep up with more aggressive use cases which require large number of beams and fast beam switching (e.g., higher frequency bands, high mobility, and/or larger number of narrower analog beams). In addition, the 3GPP NR specification was designed to accommodate a number of unknown or rudimentary capabilities (e.g., UEs not capable of beam correspondence). To be flexible, it results in a number of options. This becomes burdensome to L1 control signaling and therefore a number of reconfigurations are performed via RRC signaling (higher-layer configuration). While this avoids L1 control overhead, it either results in high latency (if reconfiguration is performed sparsely) or imposes high usage of PDSCH (since RRC signaling consumes PDSCH resources).

In the 3GPP NR specification, the handover procedure to handle inter-cell mobility, similar to LTE, and relies heavily on RRC (and even higher layer) reconfigurations to update cell-specific parameters. Such reconfigurations usually are slow and incur large latency (up to several milliseconds). For high mobility UEs, this issue gets worse due to the need for more frequency handovers, hence more frequency RRC reconfigurations.

For high mobility UEs in FR2, the two latency issues mentioned above, one with the hierarchical NW structure (with visible cell boundaries) and the other with the beam management, compound together and make the latency issue much worse, and lead to frequent radio link failures (RLFs). Therefore, there is a need for solutions/mechanisms which can reduce RLFs for high mobility UEs in FR2.

One such solution/mechanism which can reduce RLFs in FR2 can be based on a unified TCI state (beam indication) framework wherein a common beam (or TCI state) is used for (associated with) the transmission/reception of both data (PDSCH/PUSCH) and control (PDCCH/PUCCH), and also for DL and UL (for example, when beam correspondence holds between DL and UL). In this common beam (or TCI state) based multi-beam operation, the common beam (TCI state) indication/update has to happen prior to (separately from) the transmission/reception of the control information (e.g., DL/UL-related DCI in PDCCH) scheduling a DL assignment for DL data (PDSCH) or an UL grant for UL data (PUSCH). Note that a common beam based multi-beam operation is supported in the 3GPP NR specification beam management, wherein a common beam for DL data (PDSCH) and control (PDCCH) is indicated via a MAC CE based signaling (when the higher layer parameter tci-PresentInDCI in PDSCH-Config is not ‘enabled’). Such MAC-CE based common beam activation, however, is too sluggish due to the reasons explained above.

Since the TCI state for the data beam is updated in a time slot (or subframe) prior to the slot (or subframe) carrying the DCI scheduling the DL assignment or the UL grant, there might be some performance loss when compared with the case when the TCI state update for the data beam is performed together with the DL assignment or the UL grant. This issue can be much worse for high mobility UEs which require frequent/accurate update of data beam for seamless data transmission/reception. A solution to address this issue can be based on dynamic beam indication via DCI where the DCI can be a dedicated DCI and/or a DCI scheduling DL assignment or UL grant.

Furthermore, when the UE is configured with multiple component carriers (CCs) or bandwidth parts (BWPs) or cells for DL reception and/or UL transmission of data (PDSCH, PUSCH) and/or control (PDCCH, PUCCH), the common beam (or TCI state) indication, mentioned above, can also be common across multiple CCs. For the DMRS of PDCCH (or PDSCH), however, the UE can expect (e.g., in frequency range 2) to be configured with two source RSs for two quasi co-location types, one for QCL-Type A and another for QCL-Type D. In the Rel. 15/16 NR specification, two categories of (QCL-type A source RS, QCL-type D source RS) combinations for the DMRS of PDCCH/PDSCH are supported. The first category (CAT1) corresponds to QCL-type A source RS and QCL-type D source RS being the same (single) source RS. The following two examples of CAT1 are supported.
QCL-type A source RS is a tracking RS (TRS), which corresponds to a CSI-RS resource in an information element (IE) NZP-CSI-RS-ResourceSet configured with higher layer parameter trs-Info, and QCL-type D source RS is the same as QCL-type A source RS.
QCL-type A source RS is a CSI-RS resource in a NZP-CSI-RS-ResourceSet configured without higher layer parameter trs-Info and without higher layer parameter repetition, and QCL-type D source RS is the same as QCL-type A source RS.
   The second category (CAT2) corresponds to QCL-type A source RS and QCL-type D source RS being (two) different source RSs. The following example of CAT2 is supported.
QCL-type A source RS is tracking RS (TRS), which corresponds to a CSI-RS resource in a NZP-CSI-RS-ResourceSet configured with higher layer parameter trs-Info, and QCL-type D source RS is a CSI-RS resource in a NZP-CSI-RS-ResourceSet configured with higher layer parameter repetition.

When a common TCI state ID indication is used across multiple (a set of) CCs, then the same/single source RS is determined according to the TCI state (or states) indicated by the common TCI state ID and the same source RS is used to provide QCL-Type D indication (for DL reception of PDCCH and/or PDSCH or DMRS of PDCCH and/or DMRS of PDSCH) and to determine UL TX spatial filter (for UL transmission of PUCCH and/or PUSCH and/or PRACH) across the set of configured CCs. Since the single/same source RS for QCL-type D is common across multiple CCs, the same source RS can't be used (or it is too restrictive to be used) as the source RS for QCL-type A. Therefore, the two examples of CAT1, mentioned above, may not be used. In other words, the solution based on CAT2 can be used to configure (QCL-type A source RS, QCL-type D source RS) for multiple CCs. However, the Rel. 15/16 NR specification only supports one such solution. For better flexibility in terms of network implementation, it is preferred to support additional solutions belonging to CAT2. In this disclosure, several such embodiments and examples are provided.

In the present disclosure, the term “activation” describes an operation wherein a UE receives and decodes a signal from the network (or gNB) that signifies a starting point in time. The starting point can be a present or a future slot/subframe or symbol—the exact location either implicitly or explicitly indicated, or otherwise fixed or higher-layer configured. Upon successfully decoding the signal, the UE responds accordingly. The term “deactivation” describes an operation wherein a UE receives and decodes a signal from the network (or gNB) that signifies a stopping point in time. The stopping point can be a present or a future slot/subframe or symbol—the exact location either implicitly or explicitly indicated, or otherwise fixed or higher-layer configured. Upon successfully decoding the signal, the UE responds accordingly.

Terminology such as TCI, TCI states, SpatialRelationInfo, target RS, reference RS, and other terms is used for illustrative purposes and therefore not normative. Other terms that refer to the same functions can also be used.

A “reference RS” corresponds to a set of characteristics of DL or UL TX beam, such as direction, precoding/beamforming, number of ports, etc. For instance, as the UE receives a reference RS index/ID in a DL assigned represented by a TCI state, the UE applies the known characteristics of the reference RS to the assigned DL transmission. The reference RS can be received and measured by the UE (in this case, the reference RS is a downlink signal such as NZP CSI-RS and/or SSB) with the result of the measurement used for calculating a beam report (in the 3GPP NR specification, at least one L1-RSRP accompanied by at least one CRI). As the NW/gNB receives the beam report, the NW can be better equipped with information to assign a particular DL TX beam to the UE. Optionally, the reference RS can be transmitted by the UE (in this case, the reference RS is a downlink signal such as SRS). As the NW/gNB receives the reference RS, the NW/gNB can measure and calculate the needed information to assign a particular DL TX beam to the UE. This option is applicable when DL-UL beam pair correspondence holds.

The reference RS can be dynamically triggered by the NW/gNB (e.g., via DCI in case of aperiodic RS), preconfigured with a certain time-domain behavior (such as periodicity and offset, in case of periodic RS), or a combination of such pre-configuration and activation/deactivation (in case of semi-persistent RS).

There are two types of frequency range (FR) defined in the 3GPP NR specifications. The sub-6 GHz range is called frequency range 1 (FR1) and millimeter wave range is called frequency range 2 (FR2). An example of the frequency range for FR1 and FR2 is shown below.

| Frequency range | Corresponding frequency |
|---|---|
| designation | range |
| FR1 | 450 MHz-6000 MHz |
| FR2 | 24250 MHz-52600 MHz |

The following embodiment is an example of DL multi-beam operation that utilizes DL beam indication after the network (NW) receives some transmission from the UE. In the first example embodiment, aperiodic CSI-RS is transmitted by the NW and measured by the UE. Although aperiodic RS is used in these two examples, periodic or semi-persistent RS can also be used.

For mmWave (or FR2) or higher frequency bands (such as >52.6 GHz or FR4) where multi-beam operation is especially relevant, transmission-reception process includes the receiver to select a receive (RX) beam for a given TX beam. For UL multi-beam operation, the gNB selects an UL RX beam for every UL TX beam (which corresponds to a reference RS). Therefore, when UL RS (such as SRS and/or DMRS) is used as reference RS, the NW/gNB triggers or configures the UE to transmit the UL RS (which is associated with a selection of UL TX beam). The gNB, upon receiving and measuring the UL RS, selects an UL RX beam. As a result, a TX-RX beam pair is derived. The NW/gNB can perform this operation for all the configured reference RS s (either per reference RS or “beam sweeping”) and determine all the TX-RX beam pairs associated with all the reference RSs configured to the UE. On the other hand, when DL RS (such as CSI-RS and/or SSB) is used as reference RS (pertinent when DL-UL beam correspondence or reciprocity holds), the NW/gNB transmit the RS to the UE (for UL and by reciprocity, this corresponds to an UL RX beam). In response, the UE measures the reference RS (and in the process selects an UL TX beam) and reports the beam metric associated with the quality of the reference RS. In this case, the UE determines the TX-RX beam pair for every configured (DL) reference RS. Therefore, although this knowledge is unavailable to the NW/gNB, the UE—upon receiving a reference RS (hence UL RX beam) indication from the NW/gNB—can select the UL TX beam from the knowledge on all the TX-RX beam pairs.

In the present disclosure, the term “Resource Indicator”, also abbreviated as REI, is used to refer to an indicator of RS resource used for signal/channel and/or interference measurement. This term is used for illustrative purposes and hence can be substituted with any other term that refers to the same function. Examples of REI include the aforementioned CSI-RS resource indicator (CRI) and SSB resource indicator (SSB-RI). Any other RS can also be used for signal/channel and/or interference measurement such as DMRS.

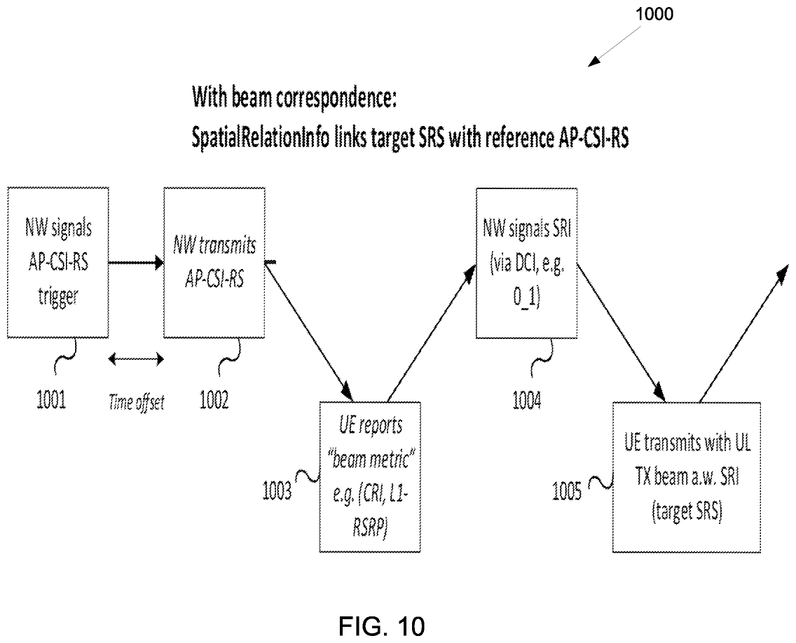

In one example illustrated in FIG. 10, an UL multi-beam operation 1000 is shown. The embodiment of the UL multi-beam operation 1000 illustrated in FIG. 10 is for illustration only. FIG. 10 does not limit the scope of this disclosure to any particular implementation of the UL multi-beam operation 1000.

The UL multi-beam operation 1000 starts with starts with the gNB/NW signaling to a UE an aperiodic CSI-RS (AP-CSI-RS) trigger or indication (step 1001). This trigger or indication can be included in a DCI (either UL-related or DL-related, either separately or jointly signaled with an aperiodic CSI request/trigger) and indicate transmission of AP-CSI-RS in a same (zero time offset) or later slot/sub-frame (>0 time offset). Upon receiving the AP-CSI-RS transmitted by the gNB/NW (step 1002), the UE measures the AP-CSI-RS and, in turn, calculates and reports a “beam metric” (indicating quality of a particular TX beam hypothesis) (step 1003). Examples of such beam reporting are CSI-RS resource indicator (CRI) or SSB resource indicator (SSB-RI) coupled with its associated L1-RSRP/L1-RSRQ/L1-SINR/CQI. Upon receiving the beam report from the UE, the NW can use the beam report to select an UL TX beam for the UE and indicate the UL TX beam selection (step 1004) using the SRI field in the UL-related DCI (that carries the UL grant, such as DCI format 0_1 in NR). The SRI corresponds to a “target” SRS resource that is linked to a reference RS (in this case, an AP-CSI-RS) via SpatialRelationInfo configuration. Upon successfully decoding the UL-related DCI with the SRI, the UE performs UL transmission (such as data transmission on PUSCH) with the UL TX beam associated with the SRI (step 1005).

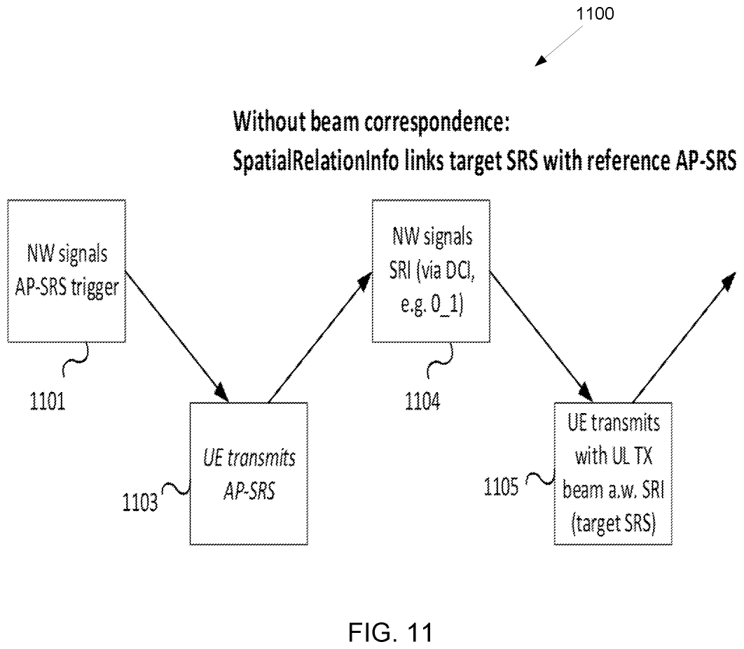

In another example illustrated in FIG. 11, an UL multi-beam operation 1100 is shown. The embodiment of the UL multi-beam operation 1100 illustrated in FIG. 11 is for illustration only. FIG. 11 does not limit the scope of this disclosure to any particular implementation of the UL multi-beam operation 1100.

The UL multi-beam operation 1100 starts with the gNB/NW signaling to a UE an aperiodic SRS (AP-SRS) trigger or request (step 1101). This trigger can be included in a DCI (either UL-related or DL-related). Upon receiving and decoding the AP-SRS trigger (step 1102), the UE transmits AP-SRS to the gNB/NW (step 1103) so that the NW (or gNB) can measure the UL propagation channel and select an UL TX beam for the UE. The gNB/NW can then indicate the UL TX beam selection (step 1104) using the SRI field in the UL-related DCI (that carries the UL grant, such as DCI format 0_1 in NR). The SRI corresponds to a “target” SRS resource that is linked to a reference RS (in this case, an AP-SRS) via SpatialRelationInfo configuration. Upon successfully decoding the UL-related DCI with the SRI, the UE performs UL transmission (such as data transmission on PUSCH) with the UL TX beam associated with the SRI (step 1105).

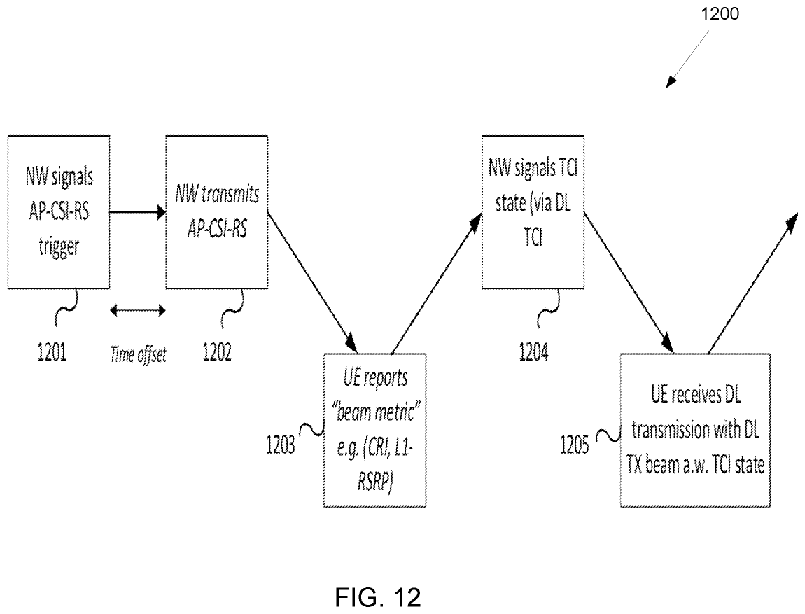

In another example illustrated in FIG. 12, a DL multi-beam operation 1200 is shown. The embodiment of the DL multi-beam operation 1200 illustrated in FIG. 12 is for illustration only. FIG. 12 does not limit the scope of this disclosure to any particular implementation of the DL multi-beam operation 1200.

In the example illustrated in FIG. 12, where a UE is configured for measuring/receiving aperiodic CSI-RS (AP-CSI-RS) and reporting aperiodic CSI (AP CSI), a DL multi-beam operation 1200 starts with the gNB/NW signaling to a UE an aperiodic CSI-RS (AP-CSI-RS) trigger or indication (step 1201). This trigger or indication can be included in a DCI (either UL-related or DL-related, either separately or jointly signaled with an aperiodic CSI request/trigger) and indicate transmission of AP-CSI-RS in a same (zero time offset) or later slot/sub-frame (>0 time offset). Upon receiving the AP-CSI-RS transmitted by the gNB/NW (step 1202), the UE measures the AP-CSI-RS and, in turn, calculates and reports a “beam metric” (included in the CSI, indicating quality of a particular TX beam hypothesis) (step 1203). Examples of such beam reporting (supported in the 3GPP NR specification) are CSI-RS resource indicator (CRI) or SSB resource indicator (SSB-RI) coupled with its associated L1-RSRP and/or L1-SINR. Upon receiving the beam report from the UE, the NW/gNB can use the beam report to select a DL TX beam for the UE and indicate the DL TX beam selection (step 1204) using the TCI field in the DL-related DCI (that carries the DL assignment, such as DCI format 1_1 in NR). The TCI state corresponds to a reference RS (in this case, an AP-CSI-RS) defined/configured via the TCI state definition (higher-layer/RRC configured, from which a subset is activated via MAC CE for the DCI-based selection). Upon successfully decoding the DL-related DCI with the TCI field, the UE performs DL reception (such as data transmission on PDSCH) with the DL TX beam associated with the TCI field (step 1205). In this example embodiment, only one DL TX beam is indicated to the UE.

To facilitate fast beam management, one requirement is to streamline the foundational components (building blocks) for beam management. One functionality of beam management is beam selection which comprises functions such as beam measurement (including training), reporting (for DL beam management, reporting via UL control channel(s)), and indication (for DL and UL beam management, indication via DL control channel(s)). Once the building blocks are streamlined [step 1], additional advanced features to facilitate faster beam management can be added [step 2].

In U.S. patent application Ser. No. 16/949,246 filed on Oct. 21, 2020, the disclosure of which is incorporated by reference herein, a “slim mode” with streamlined designs of such foundational components [step 1] is proposed for fast beam management. The slim-mode design, due to its compact nature, can facilitate faster update/reconfiguration via lower-layer control signaling. In other words, L1 control signaling will be the primary signaling mechanism and higher-layer (such as MAC CE or RRC) is used only when necessary. Here, L1 control signaling includes the use of UE-group DCI as well as dedicated (UE-specific) DCI.

The aforementioned additional advanced features can include extensions of beam management (multi-beam operation) from intra-cell to inter-cell mobility. With such mechanism, seamless access/mobility for RRC_CONNECTED UEs—as if cell boundaries were not observed unless a UE is in initial access or initial-access-like condition—can be achieved. Another advanced feature includes mechanisms to minimize beam failure (BF) or radio link failure (RLF) such as low-overhead faster beam switching/selection and UE-initiated/event-triggered beam management. With such preventive mechanisms in place, beam failure recovery (BFR) will be less likely used.

In this disclosure, signaling mechanisms for enabling the above-mentioned fast (dynamic) multi-beam operations for multiple CCs (or BWPs or cells or similar radio entity) are considered. In particular, for each CC (BWP) or at least a subset of CCs (or BWPs), a common beam (TCI state) indication via a separate DCI (or a combination of MACE CE and DCI) is considered in which the indicated beam is common for both data and control (as explained above). The DCI can be a dedicated DCI (e.g., a new DCI format) for this purpose, or an existing DCI (e.g., DCI format 1_1 or 1_2 or 0_0 or 0_1 or 0_2). When an existing DCI format is used, then some of the DCI fields (e.g., DCI fields for scheduling DL assignment or UL grant) may not be used (e.g., replaced with dummy field values, or any other values, but the UE ignores them, or those field are emptied).

In the rest of the disclosure, the term “beam”, can be associated with a spatial transmission/reception of a resource signal (RS) from a “port”, “antenna port”, or “virtual antenna/port”. Likewise, the term “transmit (TX) beam”, can be associated with a spatial transmission of a resource signal (RS) or a channel from a “port”, “antenna port”, or “virtual antenna/port”; and the term “receive (RX) beam”, can be associated with a spatial reception of a resource signal (RS) or a channel from a “port”, “antenna port”, or “virtual antenna/port”. The spatial transmission/reception of a beam can be in a three-dimension (3D) space. In a beam-formed wireless system, the transmission and reception of wireless signal can be via multiple TX and multiple RX beams.

Although the embodiments of this disclosure may refer to multiple CCs, they are applicable to both single CC (when M=1) and multiple CC cases (M>1).

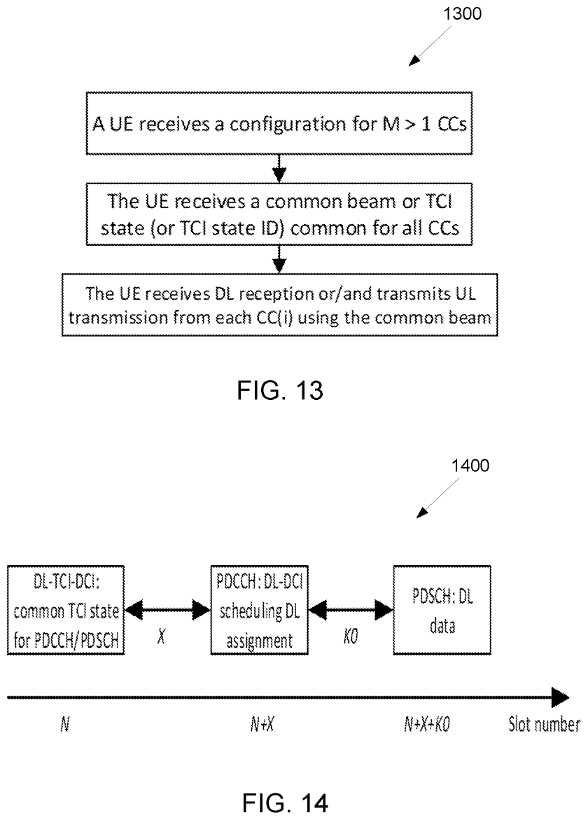

FIG. 13 illustrates an example of common beam indication across multiple CCs 1300 according to embodiments of the present disclosure. The embodiment of the common beam indication across multiple CCs 1300 illustrated in FIG. 13 is for illustration only. FIG. 13 does not limit the scope of this disclosure to any particular implementation of the common beam indication across multiple CCs 1300.

In one embodiment I.1, as shown in FIG. 13, a UE is configured with a set (list) of M>1 CCs or M>1 CCs (or DL BWPs or cells or UL BWPs) for DL reception and/or UL transmission. The UE is further configured to receive a (single) common beam or TCI state for all CCs (e.g., via L-1 control (DCI) signaling and/or MAC CE based indication). So, the UE receives a common beam (TCI state) for all CCs. Or, optionally, the UE is further configured to receive a (single) common beam ID or TCI state ID across all CCs (e.g., via L−1 control (DCI) signaling and/or MAC CE based indication). The common TCI state ID implies that the same/single RS determined according to the TCI state (or TCI states if TCI state ID indicates multiple TCI states) indicated by the common TCI state ID is used to provide QCL-Type D indication (for DL reception) and to determine UL TX spatial filter (for UL transmission) across the set of configured CCs.

In one example, the common beam or TCI state (or beam ID or TCI state ID) is used for the reception of PDSCH(i) (and/or DMRS for PDSCH(i)) of all CCs. In one example, the common beam or TCI state (or beam ID or TCI state ID) is used for the reception of both PDCCH(i) and PDSCH(i) (and/or DMRS for PDCCH(i) and PDSCH(i)) of all CCs. In one example, the common beam or TCI state (or beam ID or TCI state ID) is used for the reception of (1) PDSCH(i) only or (2) both PDCCH(i) and PDSCH(i). In one example, whether the common beam or TCI state (or beam ID or TCI state ID) is for (1) or (2) is indicated/configured (via RRC and/or MAC CE and/or DCI), where this indication/configuration can be common for all CCs or independent for each CC.

In a variation, the UE is further configured to receive two beams or TCI states (e.g., indicated by beam ID or TCI state ID) common for all CCs via L-1 control (DCI) signaling, wherein one of the two common beams is used for the reception of PDSCH(i) (and/or DMRS for PDSCH(i)) for all CCs, and another of the two common beams is used for the reception of PDCCH(i) (and/or DMRS for PDCCH(i)) for all CCs.

In another variation, the UE is further configured to receive K=1 or 2 beams common for all CCs, wherein the value K can be configured via RRC and/or MAC CE and/or DCI based signaling. When K=2, one of the two common beams is used for the reception of PDSCH(i) (and/or DMRS for PDSCH(i)) for all CCs, and another of the two common beams is used for the reception of PDCCH(i) (and/or DMRS for PDCCH(i)) for all CCs. When K=1, the common beam is used receive PDSCH(i) and/or PDCCH(i) for all CCs as explained above.

For simplicity, K=1 is assumed in the rest of this embodiment. The embodiment however is also applicable to K=2.

For brevity, the source RS for QCL-type D for DL reception is referred to as DL-beam RS, and the source RS for UL TX spatial filter (or relation) for UL transmission is referred to as UL-beam RS. The relation between the same/single RS (indicated via the common beam indication) and the DL-beam RS, and likewise, the relation between the same/single RS and the UL-beam RS is according to at least one of the following examples.

In one example I.1.1, for each CC, the DL-beam RS is the same/single RS. Likewise, for each CC, the UL-beam RS is the same/single RS.

In one example I.1.2, for each CC, the DL-beam RS can be different from the same/single RS, but it is determined based on the same/single RS. Likewise, for each CC, UL-beam RS can be different from the same/single RS (indicated via the common beam indication), but it is determined based on the same/single RS. In one example, the relation (mapping) between the same/single RS and DL-beam RS and/or the relation (mapping) between the same/single RS and UL-beam RS can be pre-determined (fixed) or configured (e.g., via higher layer signaling).

In one example I.1.3, for a subset of the M CCs, the relation between the same/single RS and the DL-beam RS is according to Example I.1.1, and for the remaining of the M CCs, the relation is according to Example I.1.2. Likewise, for a subset of the M CCs, the relation between the same/single RS and the UL-beam RS is according to Example I.1.1, and for the remaining of the M CCs, the relation is according to Example I.1.2. The subset of the M CCs can be fixed or configured. Also, the subset of CCs for the DL-beam RS and for the UL-beam RS can be the same or different. In one example, the subset of the M CCs comprises a single CC, whose CC/BWP ID for example can be fixed or configured.

In one example, the relation between the same/single RS and the DL-beam RS can be according to Example I.1.X and the relation between the same/single RS and the UL-beam RS can be according to Example I.1.Y, where X and Y can be any of 1, 2, or 3. In one example, there is restriction such that X=Y, i.e., the same example is used for DL and UL. In one example, X and Y can be different.

In the rest of the disclosure, the relation between the single/same RS and the DL-beam RS (and/or UL-beam RS) is assumed to be according to Example I.1.1. The embodiments in this disclosure however are general, and are also applicable to relations according to other examples.

In one embodiment II.1, the type of the source RS for DL and/or UL beam (i.e., DL-beam RS and/or UL-beam RS) is according to at least one of the following examples.
In one example II.1.1, the type of the source RS is a CSI-RS resource in a NZP-CSI-RS-ResourceSet configured with higher layer parameter trs-Info. This type of RSs is referred to as RS1 or CSI-RS for TRS.
In one example II.1.2, the type of the source RS is a CSI-RS resource in a NZP-CSI-RS-ResourceSet configured with higher layer parameter repetition. This type of RS s is referred to as RS2 or CSI-RS for TRS or CSI-RS for BM.
In one example II.1.3, the type of the source RS is a CSI-RS resource in a NZP-CSI-RS-ResourceSet configured without higher layer parameter trs-Info and without higher layer parameter repetition. This type of RSs is referred to as RS3 or CSI-RS for neither TRS nor BM, e.g., CSI-RS for CSI.
In one example II.1.4, the type of the source RS is a SSB/PBCH block. This type of RSs is referred to as RS4 or SS/PBCH.
In one example II.1.5, the type of the source RS is a SRS resource. This type of RSs is referred to as RS5 or SRS for BM or SRS for CSI or SRS for positioning.
In one example II.1.6, the type of the source RS is a DL positioning RS (PRS). This type of RSs is referred to as RS6. In one example, this type of RS can be configured only for positioning UEs (which can be reported by the UE its capability reporting). In one example, the DL PRS is configured on a serving cell (and it is not of a non-serving cell). In one example, the DL PRS can be of a non-serving cell (which can be indicated via higher layer), in addition to DL PRS on a serving cell.

When the UE is provided with a source RS of type RS1 or RS2 or RS3 and with index csi-RS-Index,
When configured as the DL-beam RS, the UE receives the DL transmission using a same spatial domain filter as for a reception of a CSI-RS with resource index provided by csi-RS-Index for a same serving cell or, if servingCellId is provided, for a serving cell indicated by servingCellId.
When configured as the UL-beam RS, the UE transmits the UL transmission using a same spatial domain filter as for a reception of a CSI-RS with resource index provided by csi-RS-Index for a same serving cell or, if servingCellId is provided, for a serving cell indicated by servingCellId.

When the UE is provided with a source RS of type RS4 and with index ssb-Index,
When configured as the DL-beam RS, the UE receives the DL transmission using a same spatial domain filter as for a reception of a SS/PBCH block with index provided by ssb-Index for a same serving cell or, if servingCellId is provided, for a serving cell indicated by servingCellId.
When configured as the UL-beam RS, the UE transmits the UL transmission using a same spatial domain filter as for a reception of a SS/PBCH block with index provided by ssb-Index for a same serving cell or, if servingCellId is provided, for a serving cell indicated by servingCellId.

When the UE is provided with a source RS of type RS5 and with index srs-Index,
When configured as the DL-beam RS, the UE receives the DL transmission using a same spatial domain filter as for a transmission of a SRS with resource index provided by resource for a same serving cell and/or active UL BWP or, if servingCellId and/or uplinkBWP are provided, for a serving cell indicated by servingCellId and/or for an UL BWP indicated by uplinkBWP.
When configured as the UL-beam RS, the UE transmits the UL transmission using a same spatial domain filter as for a transmission of a SRS with resource index provided by resource for a same serving cell and/or active UL BWP or, if servingCellId and/or uplinkBWP are provided, for a serving cell indicated by servingCellId and/or for an UL BWP indicated by uplinkBWP.

In one embodiment II.2, for the reception of PDCCH or DMRS of PDCCH, the UE is configured with a higher layer IE TCI-state that indicates a combination of quasi co-location types, QCL-type A and QCL-type D, where the type of source RS for QCL-Type A is one of RS1, RS2, RS3 and the type of the source RS for QCL-Type D is one of RS1 through RS6. At least one of the examples shown in Table 1 is used/configured.

Likewise, for the reception of PDSCH or DMRS of PDSCH, the UE is configured with a higher layer IE TCI-state that indicates a combination of quasi co-location types, QCL-type A and QCL-type D, where the type of source RS for QCL-Type A is one of RS1, RS2, RS3 and the type of the source RS for QCL-Type D is one of RS1 through RS6. At least one of the examples shown in Table 1 is used/configured.

TABLE 1

| | Source RS for QCL-type A | | Source RS for QCL-type D | |
|---|---|---|---|---|
| Example | Type | RS | Type | RS |
| II.2.1.a | RS1 | CSI-RS resource with | RS1 | CSI-RS resource with trs-Info (same CSI-RS |
| | | trs-Info | | resource as that for QCL-type A) |
| II.2.1.b | | | | CSI-RS resource with trs-Info (different CSI-RS |
| | | | | resource from that for QCL-type A) |
| II.2.1.c | | | RS2 | CSI-RS resource with repetition |
| II.2.1.d | | | RS3 | CSI-RS resource without trs-Info and without |
| | | | | repetition |
| II.2.1.e | | | RS4 | SSB/PBCH block |
| II.2.1.f | | | RS5 | SRS resource |
| II.2.1.g | | | RS6 | DLPRS |
| II.2.2.a | RS2 | CSI-RS resource with | RS1 | CSI-RS resource with trs-Info |
| II.2.2.b | | repetition | RS2 | CSI-RS resource with repetition (same CSI-RS |
| | | | | resource as that for QCL-type A) |
| II.2.2.c | | | | CSI-RS resource with repetition (different CSI-RS |
| | | | | resource from that for QCL-type A) |
| II.2.2.d | | | RS3 | CSI-RS resource without trs-Info and without |
| | | | | repetition |
| II.2.2.e | | | RS4 | SSB/PBCH block |
| II.2.2.f | | | RS5 | SRS resource |
| II.2.2.g | | | RS6 | DL PRS |
| II.2.3.a | RS3 | CSI-RS resource without | RS1 | CSI-RS resource with trs-Info |
| II.2.3.b | | trs-Info and without | RS2 | CSI-RS resource with repetition |
| II.2.3.c | | repetition | RS3 | CSI-RS resource without trs-Info and without |
| | | | | repetition (same CSI-RS resource as that for |
| | | | | QCL-type A) |
| II.2.3.d | | | | CSI-RS resource without trs-Info and without |
| | | | | repetition (different CSI-RS resource from that for |
| | | | | QCL-type A) |
| II.2.3.e | | | RS4 | SSB/PBCH block |
| II.2.3.f | | | RS5 | SRS resource |
| II.2.3.g | | | RS6 | DLPRS |

In one example, when the type of the source RS is the same for both QCL-type A and QCL-type D, then the configuration of TCI-State is restricted to be such that the same source RS is used for both QCL-types. That is, the combinations according to Examples II.2.1.b, II.2.2.c, or II.2.3.d can't be configured (i.e., they are not supported).

In one example, for the case of a single CC (i.e., M=1), there is no restriction on the configuration for the source RSs for QCL-type A and QCL-type D. That is, the source RSs for QCL-type A and QCL-type D is according to at least one of the combinations in Table 1.

In one example, for the case of multiple CCs (i.e., M>1), there is a restriction on the configuration for the source RSs for QCL-type A and QCL-type D. In one example of restriction, the source RS type has to be different for QCL-type A and QCL-type D. In another example of restriction, the source RS type can be same or different for QCL-type A and QCL-type D. When it is the same, two different source RSs (of the sane type) has to be used for QCL-type A and QCL-type D.

In a variation of embodiment II.1, the type of source RS for QCL-Type A can also be RS4 or RS5 or RS6. This can be subject to the condition on the bandwidth or time-frequency allocation of the corresponding sources RS (of type RS4 or RS5 or RS6). For example, the condition can be that the bandwidth or time-frequency allocation of the corresponding sources RS is sufficiently large (or larger than a threshold).

In one embodiment II.3, for the reception of PDCCH or DMRS of PDCCH, likewise, for the reception of PDSCH or DMRS of PDDCH, the UE is configured with a higher layer IE TCI-state that indicates a combination of quasi co-location types, QCL-type A and QCL-type D.
For QCL-type A, a BWP (or CC or cell) ID for the source RS can be absent (not provided/configured) in the TCI state (or in a QCL-Info included in the TCI state). When absent, the BWP (or CC or cell) ID for source RS is determined according to a target CC of the TCI state, and the configured source RS ID and the corresponding active BWP ID. That is, for each applied active BWP per CC, the location of the QCL-type A source RS is determined based on the BWP ID, the CC ID, and the RS ID, where BWP ID is the ID of the corresponding active BWP, CC ID is the ID of the corresponding CC, and the RS ID is the ID of the source RS.
For QCL-type D, a source RS determined according to the TCI state indicated by a common TCI state ID is used to provide QCL-type D indication across the set of configured CCs.

The type of source RS for QCL-Type A is one of RS1, RS2, RS3 and the type of the source RS for QCL-Type D is one of RS1 through RS6. At least one of the examples shown in Table 1 is used/configured.

In one embodiment II.4, for the reception of PDCCH or DMRS of PDCCH, likewise, for the reception of PDSCH or DMRS of PDDCH, the UE is configured with a higher layer IE TCI-state that indicates a combination of quasi co-location types, QCL-type A and QCL-type D.
For QCL-type A, a BWP (or CC or cell) ID for the source RS can be absent (not provided/configured) in the TCI state (or in a QCL-Info included in the TCI state). When absent, the BWP (or CC or cell) ID for source RS is determined according to a target CC of the TCI state, and the configured source RS ID and the corresponding active BWP ID. That is, for each applied active BWP per CC, the location of the QCL-type A source RS is determined based on the BWP ID, the CC ID, and the RS ID, where BWP ID is the ID of the corresponding active BWP, CC ID is the ID of the corresponding CC, and the RS ID is the ID of the source RS.
Likewise, for QCL-type D, a BWP (or CC or cell) ID for the source RS can be absent (not provided/configured) in the TCI state (or in a QCL-Info included in the TCI state). When absent, the BWP (or CC or cell) ID for source RS is determined according to a target CC of the TCI state, and the configured source RS ID and the corresponding active BWP ID. That is, for each applied active BWP per CC, the location of the QCL-type D source RS is determined based on the BWP ID, the CC ID, and the RS ID, where BWP ID is the ID of the corresponding active BWP, CC ID is the ID of the corresponding CC, and the RS ID is the ID of the source RS.

The type of source RS for QCL-Type A is one of RS1, RS2, RS3 and the type of the source RS for QCL-Type D is one of RS1 through RS6. At least one of the examples shown in Table 1 is used/configured.

In one embodiment II.5, for the reception of PDCCH or DMRS of PDCCH, likewise, for the reception of PDSCH or DMRS of PDDCH, the UE is configured with one of the three types of solutions in embodiment II.2, 11.3, and 11.4 to indicate a combination of quasi co-location types, QCL-type A and QCL-type D. This configuration can be based on a higher layer (RRC) signaling or MAC CE based indication or DCI based indication. Alternatively, this configuration can be based on a combination of at least two of RRC, MAC CE and DCI based signaling.

In one embodiment II.6, for the reception of PDCCH or DMRS of PDCCH, likewise, for the reception of PDSCH or DMRS of PDDCH, the UE is configured with one of the three types of solutions in embodiment II.2, II.3, and II.4 as described in embodiment II.5. However, this configuration is subject to (or conditioned on) the UE capability reporting, which is according to at least one of the following examples.
In one example II.6.1, the solution according to embodiment II.2 is mandatory (hence, can be configured without any separate capability reporting), but the solutions according to embodiment II.3 and II.4 are optional (one of them can configured only when the UE reports its support in the capability reporting).
In one example II.6.2, the solution according to embodiment II.3 is mandatory (hence, can be configured without any separate capability reporting), but the solutions according to embodiment II.2 and 11.4 are optional (one of them can configured only when the UE reports its support in the capability reporting).
In one example II.6.3, the solution according to embodiment II.4 is mandatory (hence, can be configured without any separate capability reporting), but the solutions according to embodiment II.2 and 11.3 are optional (one of them can configured only when the UE reports its support in the capability reporting).
In one example II.6.4, the solution according to embodiment II.2 and 11.3 are mandatory (hence, one of them can be configured without any separate capability reporting), but the solution according to embodiment II.4 is optional (can configured only when the UE reports its support in the capability reporting).
In one example II.6.5, the solution according to embodiment II.2 and 11.4 are mandatory (hence, one of them can be configured without any separate capability reporting), but the solution according to embodiment II.3 is optional (can configured only when the UE reports its support in the capability reporting).
In one example II.6.6, the solution according to embodiment II.3 and 11.4 are mandatory (hence, one of them can be configured without any separate capability reporting), but the solution according to embodiment II.2 is optional (can configured only when the UE reports its support in the capability reporting).
In one example II.6.7, all three solutions according to embodiment II.2, 11.3 and 11.4 are optional (one of them can be configured only when the UE reports its support in the capability reporting).

When multiple solutions are optional, their capability reporting can be via separate parameters, or via one joint parameter.

In one embodiment II.7, for the reception of PDCCH or DMRS of PDCCH, likewise, for the reception of PDSCH or DMRS of PDDCH, the UE is configured with a TCI state pool for the set of K>1 CCs, e.g., via higher layer signaling, where the TCI state pool is according to at least one of the following examples.
In example II.7.1, the TCI state pool is a common pool for both source RS for QCL-type A and source RS for QCL-type D, and one TCI state is indicated from the common pool, which indicates the same/single source RS for both QCL-types.
In example II.7.2, the TCI state pool is a common pool for both source RS for QCL-type A and source RS for QCL-type D, and either one TCI state is indicated from the common pool, which indicates two source RSs for the two QCL-types, or two TCI states are indicated from the common pool for the two QCL-types, where each TCI state indicates one source RS.

The TCI state pool can be configured common across multiple CCs. Or, the TCI state pool can be configured separately for each CC.

In one embodiment II.8, for the reception of PDCCH or DMRS of PDCCH, likewise, for the reception of PDSCH or DMRS of PDDCH, the UE is configured with two separate TCI state pools for the set of K>1 CCs, e.g., via higher layer signaling, where one TCI state pool is for the TCI state indicating the source RS for QCL-type A, and another TCI state pool is for the TCI state indicating the source RS for QCL-type D.

One or both of the two TCI state pools can be configured common across multiple CCs. Or, one or both of the two TCI state pools can be configured separately for each CC.

In one embodiment II.9, the common beam or TCI state (or TCI state ID) indication according to some embodiments of this disclosure is for the target RS(s) and/or channel(s) associated with multiple CCs, wherein the target RS(s) and/or channel(s) is according to at least one of the following examples.
In example II.9.1, the target RSs correspond to all RSs associated with multiple CCs. Likewise, the target channels correspond to all data and control channels associated with multiple CCs.
In example II.9.2, the target RSs correspond DMRSs associated with multiple CCs. Likewise, the target channels correspond to all data and control channels associated with multiple CCs.

In one embodiment 111.1, a UE is configured with a combination of source RS s for two different QCL-types, say QCL-type T1 and QCL-type T2, where the combination of sources RSs is according to at least one of the examples in this disclosure, and (T1, T2) corresponds to one of (A, D), (B, C), (B, D), (C, D), where QCL-types A, B, C, and D are defined in [REFS], which is copied below.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

In one embodiment 111.2, a solution based on CAT1 (or any other combination proposed in this disclosure) can be used/configured when a TCI state ID indication is CC-specific (per CC) for a CC. Or, a solution based on CAT1 and/or CAT2 (or any other combination proposed in this disclosure) can be used/configured when a TCI state ID indication is CC-specific (per CC) for a CC. Or, a solution based on CAT2 (or any other combination proposed in this disclosure) is used/configured (and a solution based on CAT1 can't be used/configured) when a TCI state ID indication is common (a single/same RS is indicated via the TCI state ID) across multiple CCs.

As described above, signaling mechanisms for enabling the above-mentioned fast (dynamic) multi-beam operations are considered. In particular, a common beam (TCI state) indication via a separate DCI is considered in which in the indicated beam is common for both data and control (as explained above).

In this disclosure, a dynamic, L1-control or DCI based, common beam indication mechanisms are considered. For illustration, the following notation/terminology is used in this disclosure. Other terminology can also be used to represent the same functions and operations:
a DCI indicating a common beam for data (PDSCH/PUSCH) and control (PDCCH/PUCCH) for both DL and UL is referred to as TCI-DCI (e.g., used when beam correspondence holds between DL and UL),
a DCI indicating a common beam for data (PDSCH) and control (PDCCH) for DL is referred to as DL-TCI-DCI,
a DCI indicating a common beam for data (PUSCH) and control (PUCCH) for UL is referred to as UL-TCI-DCI,
a DCI scheduling a DL assignment is referred to as DL-DCI, and
a DCI scheduling a UL grant is referred to as UL-DCI.

In some embodiments of this disclosure, a beam for DL reception refers to a reference/source RS with a QCL information with QCL-type=TypeD, and a beam for UL transmission refers to a spatial relation information (e.g., associated with a reference/source RS).

In some embodiments of this disclosure, DL-TCI-DCI (that includes common beam or TCI state) is a new DCI format that is different from DL-DCI format (e.g., DCI format 1_0, 1_1 and 1_2 in the Rel. 15 NR specification). Optionally, DL-TCI-DCI (that includes common beam or TCI state) is one of the DL-DCI formats (e.g., DCI format 1_0, 1_1 and 1_2 in the Rel. 15 NR specification). Optionally, DL-TCI-DCI (that includes common beam or TCI state) can be a new DCI format or one of the DL-DCI formats (e.g., DCI format 1_1 and 1_2 in the Rel. 15 NR specification), wherein the information whether it is a new format, or an existing format can be configured (e.g., via RRC). In an example, whether the DL-TCI-DCI can be a new TCI format is subject to a UE capability (reported by the UE), i.e., only when the UE reports that it is capable of receiving a new DCI format, the DL-TCI-DCI can be the new DCI format; otherwise it is an existing DCI format.

Likewise, in some embodiments of this disclosure, UL-TCI-DCI (that includes common beam or TCI state) is a new DCI format that is different from UL-DCI format (e.g., DCI format 0_0, 0_1 and 0_2 in the Rel. 15 NR specification). Optionally, UL-TCI-DCI (that includes common beam or TCI state) is one of the UL-DCI formats (e.g., DCI format 0_0, 0_1 and 0_2 in the Rel. 15 NR specification). Optionally, UL-TCI-DCI (that includes common beam or TCI state) can be a new DCI format or one of the DL-DCI formats (e.g., DCI format 0_0, 0_1 and 0_2 in the Rel. 15 NR specification), wherein the information whether it is a new format, or an existing format can be configured (e.g., via RRC). In an example, whether the UL-TCI-DCI can be a new TCI format is subject to a UE capability (reported by the UE), i.e., only when the UE reports that it is capable of receiving a new DCI format, the UL-TCI-DCI can be the new DCI format; otherwise it is an existing DCI format.

In some embodiments of this disclosure, TCI-DCI (that includes common beam or TCI state) is a new DCI format that is different from a DL- or UL-DCI format (e.g., DCI format 0_0, 0_1, 0_2, 1_0, 1_1 and 1_2 in the Rel. 15 NR specification). Optionally, TCI-DCI (that includes common beam or TCI state) is one of the DL- or UL-DCI formats (e.g., DCI format 0_0, 0_1, 0_2, 1_0, 1_1 and 1_2 in the Rel. 15 NR specification). Optionally, TCI-DCI (that includes common beam or TCI state) can be a new DCI format or one of the DL- or UL-DCI formats (e.g., DCI format 0_0, 0_1, 0_2, 1_0, 1_1 and 1_2 in the Rel. 15 NR specification), wherein the information whether it is a new format, or an existing format can be configured (e.g., via RRC). In an example, whether the TCI-DCI can be a new TCI format is subject to a UE capability (reported by the UE), i.e., only when the UE reports that it is capable of receiving a new DCI format, the TCI-DCI can be the new DCI format; otherwise it is an existing DCI format.

An example of a dedicated DCI indicating the common beam for the reception of DL control and data 1400 is illustrated in FIG. 14. The embodiment of the dedicated DCI indicating the common beam for the reception of DL control and data 1400 illustrated in FIG. 14 is for illustration only. FIG. 14 does not limit the scope of this disclosure to any particular implementation of the example of a dedicated DCI indicating the common beam for the reception of DL control and data 1400.

In one embodiment IV.1, as shown in FIG. 14, a UE is configured to receive a dedicated DCI (DL-TCI-DCI) indicating the common beam (TCI state) for the reception of DL control (PDCCH) and data (PDSCH). The UE receives (e.g., a DL-TCI-DCI format) and decodes DL-TCI-DCI in slot (or subframe) N, and uses the indicated beam (TCI state) to receive DL control (PDCCH) starting in the same (slot N) or later slot(s). For illustration, let X be the gap (in number of slots/subframes) between the slot carrying the DL-TCI-DCI and the slot carrying the DL control, then the UE receives DL control starting in slot N+X. The UE decodes DL-DCI (e.g., a DL-DCI format) contained in PDCCH to obtain scheduling information for the DL assignment. The UE then uses the indicated beam (TCI state) to receive DL data (PDSCH, according to the DL assignment) in slot N+X+K₀. Here, the value of X can be fixed. Alternatively, the value of X can be selected from a set of values. Optionally, the value of X is not configured or set in a particular manner due to the aperiodic nature of the DCI signaling (DL-TCI-DCI and/or DL-DCI). That is, the time unit location (e.g., slot, subframe) used to signal the DL-TCI-DCI can be different from that used to signal the DL-DCI. In some examples, X can also be referred to as a downlink beam application time (DL-BAT) value B. In some example, X is lower bounded by B, i.e., X≥B.

In an example, the unit of N and/or X and/or K₀ is defined in terms of number of OFDM symbols. The value X is measured from the end of DL-TCI-DCI decoding (i.e., the last symbol carrying DL-TCI-DCI) and the start of DL-DCI reception (i.e., the first symbol carrying DL-DCI), or the value X is determined as the first slot that is at least P ms or Q symbols after the DL-TCI-DCI with the common beam indication, where P or Q can be fixed, or configured, or determined/configured based on UE capability reporting). Likewise, the value K₀ is measured from the end of DL-DCI decoding (i.e., the last symbol carrying DL-DCI) and the start of PDSCH reception (i.e., the first symbol carrying PDSCH). In the rest of the disclosure, the unit of N, X, and K₀ is assumed to be in terms of time slots (so subframes). The embodiments of the disclosure, however, are general and are applicable to any units such as number of OFDM symbols.

In an example, the value of X is set/determined based on the UE's processing restriction (i.e., the processing latency) or capability. When a new beam (TCI state) is indicated via DL-TCI-DCI, it can be used for the reception of DL-DCI not earlier than X time (slots or subframes or OFDM symbols).

In one example, a UE is configured/triggered with a PUCCH transmission (e.g., for the HARQ-ACK feedback) that can be associated with a DL (e.g., PDSCH) reception, which is triggered (or scheduled) by DL-DCI. In this case, the TCI state (beam) for the PUCCH transmission is indicated/updated via either UL-TCI-DCI (cf. embodiment IV.4 through IV.6 below) or DL-TCI-DCI. The time gap between the DL-TCI-DCI/UL-TCI-DCI reception and the PUCCH transmission can be N+X+K₀+J, where J is the time gap (number of slots or subframes or OFDM symbols) between PDSCH reception and PUCCH transmission, and J can be fixed or configured from a set of candidate values.

When the PDCCH carrying the DL-TCI-DCI is associated with (configured) with a HARQ-ACK (or ACK/NACK) feedback (e.g., via a PUCCH transmission) indicating that the UE receives the updated common beam, then the beam application time may include the time between the PDCCH reception (either from the start or the end of PDCCH reception) and the corresponding PUCCH transmission (either from the start or the end of PUCCH transmission), i.e., X=Y₁+Y₂ where Y₁=the time between PDCCH reception and PUCCH transmission, and Y₂=the time between PUCCH transmission and DL-DCI reception. Alternatively, the beam application time equals Y₂. In this case, the TCI state (beam) for the PUCCH transmission can be the latest (previously) beam that is indicated via DL-TCI-DCI prior to the new/updated TCI state in the current slot.

The beam (or TCI state) to receive DL-TCI-DCI in slot N can be the beam (or TCI state) indicated via the latest DL-TCI-DCI in an earlier slot M<N. If the latest DL-TCI-DCI is not received or is not configured, then a default beam can be used. For instance, the default beam for PDCCH reception in the 3GPP NR specification can be used. Alternatively, the beam (or TCI state) to receive DL-TCI-DCI can be the beam to receive a DL channel and/or DL RS in an earlier slot M<N. Alternatively, the beam (or TCI state) to receive DL-TCI-DCI can be associated with the beam to transmit a UL channel and/or UL RS in an earlier slot M<N. Alternatively, the beam (or TCI state) to receive DL-TCI-DCI can be associated with a beam used to receive an SSB associated with the most recent random access procedure, e.g., random access procedure not initiated by a PDCCH order that triggers a contention-free random access procedure. Alternatively, the beam (or TCI state) to receive DL-TCI-DCI can be associated with a beam used to receive a CSI-RS associated with the most recent random access procedure, e.g., random access procedure not initiated by a PDCCH order that triggers a contention-free random access procedure. Optionally, instead of using a default beam for receiving DL-TCI-DCI in slot N, the beam (or TCI state) for receiving the DL-TCI-DCI can be signaled via MAC CE. For example, the mechanism supported in the 3GPP NR specification for updating the TCI state of PDCCH can be reused to update the TCI state (beam) for receiving the DL-TCI-DCI.

At least one of the following examples can be used to determine the value of X and K₀.

In one example IV.1.1, X is fixed, for example, to X=0 (described below) or X=1. That is, a DL-TCI-DCI is received X slots/subframes prior to every DL-DCI, or prior to the first of a plurality of DL-DCIs (when DL-TCI-DCI indicates TCI states for the reception of a plurality of DL-DCIs). The (value of the) parameter K₀ can be configured via DL-DCI. Alternatively, the parameter K₀ can be configured via MAC CE based signaling. Alternatively, the parameter K₀ can be configured via RRC signaling. Alternatively, the parameter K₀ can be configured via a combination of MAC-CE and RRC signaling. Alternatively, the parameter K₀ can be configured via a combination of MAC-CE and DL-DCI signaling. Alternatively, the parameter K₀ can be configured via a combination of DL-DCI and RRC signaling. Alternatively, the parameter K₀ can be configured via a combination of DL-DCI, MAC-CE, and RRC signaling. This example is especially relevant when DL-TCI-DCI is signaled per UE (as opposed to a group of UEs).

In one example IV.1.2, X and K₀ are configured via two separate parameters. The (value of the) parameter K₀ can be configured via DL-DCI. Alternatively, the parameter K₀ can be configured via MAC CE based signaling. Alternatively, the parameter K₀ can be configured via RRC signaling. Alternatively, the parameter K₀ can be configured via a combination of MAC-CE and RRC signaling. Alternatively, the parameter K₀ can be configured via a combination of MAC-CE and DL-DCI signaling. Alternatively, the parameter K₀ can be configured via a combination of DL-DCI and RRC signaling. Alternatively, the parameter K₀ can be configured via a combination of DL-DCI, MAC-CE, and RRC signaling.

The value of X can be selected from a set of values (which may or may not include X=0). Likewise, the (value of the) parameter X can be configured via the DL-TCI-DCI. Alternatively, the parameter X can be configured via MAC CE based signaling. Alternatively, the parameter X can be configured via RRC signaling. Alternatively, the parameter X can be configured via a combination of MAC-CE and RRC signaling. Alternatively, the parameter X can be configured via a combination of MAC-CE and DL-TCI-DCI signaling. Alternatively, the parameter X can be configured via a combination of DL-TCI-DCI and RRC signaling. Alternatively, the parameter X can be configured via a combination of DL-TCI-DCI, MAC-CE, and RRC signaling.

In one example IV.1.3, X and K₀ are configured via a joint parameter. The (value of the) parameters (X, K₀) can be configured via DL-TCI-DCI. Alternatively, the parameters (X, K₀) can be configured via MAC CE based signaling. Alternatively, the parameters (X, K₀) can be configured via RRC signaling. Alternatively, the parameters (X, K₀) can be configured via a combination of MAC-CE and RRC signaling. Alternatively, the parameters (X, K₀) can be configured via a combination of MAC-CE and DL-TCI-DCI signaling. Alternatively, the parameters (X, K₀) can be configured via a combination of TCI-DCI and RRC signaling. Alternatively, the parameters (X, K₀) can be configured via a combination of DL-TCI-DCI, MAC-CE, and RRC signaling. The value of X can be selected from a set of values for (X, K₀) (which may or may not include X=0).

In one example IV.1.4, K₀ is configured, and X can be derived implicitly based on the value of K₀. The configuration of the parameter K₀ is according to at least one example in example IV.1.1.

In one example IV.1.5, X is configured, and K₀ can be derived implicitly based on the value of X. The configuration of the parameter X is according to at least one example in example IV.1.2.

In one example IV.1.6, the value of X is not configured, used, and/or set in a particular manner due to the (aperiodic) nature of the DCI signaling (DL-TCI-DCI and/or DL-DCI). Here, the UE monitors the presence of DL-TCI-DCI as well as DL-DCI in each slot/subframe by detecting the presence of the associated IDs (such as C-RNTI or group-RNTI or TCI-RNTI). In this case, the location of the pertinent DL-TCI-DCI can be in any slot relative to the location of the DL-DCI. The applicability of the TCI state signaled in the DL-TCI-DCI can be determined from its location relative to DL-DCI, e.g., to ensure sufficient time for decoding the DL-TCI-DCI so that the TCI state is applicable to some following DL-DCI(s). For example, the UE assumes a minimum TCI state (beam) switching time (in number of slots/subframes or ODFM symbols) from the end of DL-TCI-DCI decoding (i.e., the last symbol carrying DL-TCI-DCI) and the start of DL-TCI reception (i.e., the first symbol carrying DL-DCI). In one example, this switching time is reported by the UE in its capability signaling (or is fixed or is configured to the UE).

FIG. 14 illustrates an example of receiving DL-TCI-DCI and DL-DCI in the same slot or subframe 1400. The example of receiving DL-TCI-DCI and DL-DCI in the same slot or subframe 1400 illustrated in FIG. 14 is for illustration only. FIG. 14 does not limit the scope of this disclosure to any particular implementation of the example of receiving DL-TCI-DCI and DL-DCI in the same slot or subframe 1400.

In at least one of the above embodiments (or examples), as shown in FIG. 14, when the value of the parameter X=0, the UE is configured to receive DL-TCI-DCI and DL-DCI in the same slot (or subframe) N. The UE receives/decodes DL-TCI-DCI and DL-DCI in slot (or subframe) N, and obtains the indicated beam (TCI state) from DL-TCI-DCI and scheduling information for the DL assignment from DL-DCI. The UE then receives DL data (PDSCH) according to the DL assignment using the indicated beam in slot N+K₀.

Since DL-DCI and DL-TCI-DCI are received in the same slot, the UE can't use the beam indicated via DL-TCI-DCI in the current slot for the reception of DL control (PDCCH carrying DL-DCI). The beam (or TCI state) to receive DL-TCI-DCI and DL-DCI in slot N can be the beam indicated via the latest DL-TCI-DCI in an earlier slot M<N or, optionally, the latest TCI state applicable to the DL-DCI signaled via other means. If the latest DL-TCI-DCI is not received or is not configured, then a default beam can be used. For instance, the default beam for PDCCH reception in the 3GPP NR specification can be used. Alternatively, the beam (or TCI state) to receive DL-TCI-DCI and DL-DCI can be the beam to receive a DL channel and/or DL RS in an earlier slot M<N. Alternatively, the beam (or TCI state) to receive DL-TCI-DCI and DL-DCI can be associated with the beam to transmit a UL channel and/or UL RS in an earlier slot M<N. Optionally, instead of using a default beam for receiving DL-TCI-DCI and DL-DCI in slot N, the beam (or TCI state) for receiving the DL-TCI-DCI can be signaled via MAC CE. For example, the mechanism supported in the 3GPP NR specification for updating the TCI state of PDCCH can be reused to update the TCI state (beam) for receiving the DL-TCI-DCI.

At least one of the following examples can be applicable when the DL-TCI-DCI and DL-DCI are received in the same slot.

In one example IV.1.7, DL-TCI-DCI and DL-DCI correspond to (or functionally combined into) a single (joint) DCI including all DCI fields of both DL-TCI-DCI and DL-DCI. In one example, this joint DCI is labelled as DL-TCI-DCI. In one example, this joint DCI is labelled as DL-DCI. In one example, this joint DCI is labelled as DL-TCI-DCI. In one example, this joint DCI is labelled as DL-DCI (e.g., format 1_0, 1_1, and 1_2 in NR specification). In one example, the DL DCI format can include one or both of common beam (TCI state) and DL assignment. At least one of the following examples can be used/configured.
In one example IV.1.7.1, the UE decodes the DL_DCI and determines whether only one or both of common beam (TCI state) and DL assignment are included. For example, when the TCI state field in the DCI takes a value (e.g., 0), it indicates that the TCI state (or common beam) is not indicated (or being absent). Likewise, when a parameter in the scheduling assignment field in the DCI takes a value (e.g., 0), it indicates that there is no DL assignment (absent).
In one example IV.1.7.2, the information whether only one or both of common beam (TCI state) and DL assignment are included can be configured or activated via MAC CE.

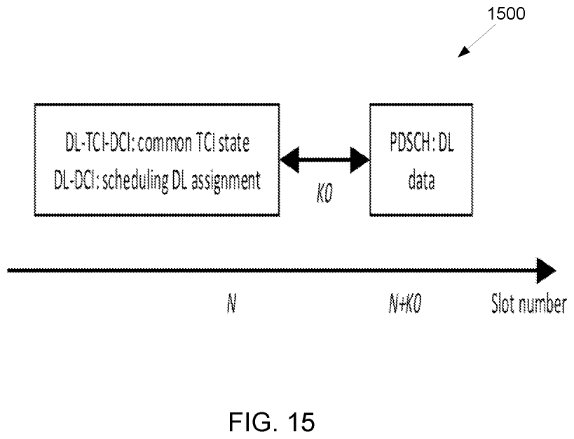

FIG. 15 illustrates an example of the decoding of DL-TCI-DCI and DL-DCI 1500. The example of decoding of DL-TCI-DCI and DL-DCI 1500 illustrated in FIG. 15 is for illustration only. FIG. 15 does not limit the scope of this disclosure to any particular implementation of the example of the decoding of DL-TCI-DCI and DL-DCI 1500.

In one example IV.1.8, DL-TCI-DCI can be separate from DL-DCI, but they are in the same slot. A few examples are shown in FIG. 15. In one example, the decoding of TCI-DCI and DL-DCI are independent. In another example, the decoding of TCI-DCI and DL-DCI are not independent. For example, the UE needs to decode DL-TCI-DCI first, and then decodes DL-DCI. If the decoding of DL-TCI-DCI fails, the decoding of DL-DCI also fails. In this later example, DL-TCI-DCI and DL-DCI respectively can be first and second stage DCIs of a two-stage DCI.

In any of the previously described and following examples and embodiments associated with X=0, the methods can stand alone and, therefore, be implemented without the use of any offset parameter X. In other words, any of such examples or embodiments can be utilized without any parameterization of X, or setting an offset parameter (such as X) to be 0.

In one embodiment IV.2, a UE can be configured with a higher layer parameter (and/or MAC CE and/or DL-DCI field) to enable the TCI state (beam) indication via DL-TCI-DCI. For example, a UE can be configured to derive its TCI state update from DL-DCI and/or DL-TCI-DCI depending on the configuration for DL-DCI and/or DL-TCI-DCI. Analogous to embodiment IV.1, as shown in FIG. 14, a UE is configured to receive a dedicated DCI (DL-TCI-DCI) indicating the common beam (TCI state) for the reception of DL control (PDCCH) and data (PDSCH). The UE receives (e.g., a DL-TCI-DCI format) and decodes DL-TCI-DCI in slot (or subframe) N, and uses the indicated beam (TCI state) to receive DL control (PDCCH) starting in slot N+X (assuming X>0). The UE decodes DL-DCI (e.g., a DL-DCI format) contained in PDCCH to obtain scheduling information for the DL assignment. The UE then uses the indicated beam (TCI state) to receive DL data (PDSCH, according to the DL assignment) in slot N+X+K₀. Here, the value of X can be fixed. Alternatively, the value of X can be selected from a set of values. Optionally, the value of X is not configured or set in a particular manner due to the aperiodic nature DCI signaling (DL-TCI-DCI and/or DL-DCI). That is, the time unit location (e.g., slot, subframe) used to signal the DL-TCI-DCI can be different from that used to signal the DL-DCI. The methods in which the values of X and K₀ are set are analogous to those applicable for embodiment IV.1.

In any of the previously described and following examples and embodiments associated with X=0, the methods can stand alone and, therefore, be implemented without the use of any offset parameter X. In other words, any of such examples or embodiments can be utilized without any parameterization of X, or setting an offset parameter (such as X) to be 0.

In one example IV.2.1, when the offset parameter X is used or configured, the resulting UE procedure can be dependent on the value of X. For example, when X=0, DL-TCI-DCI is absent (not received and/or not configured) (or DL-TCI-DCI and DL-DCI correspond to (or functionally combined into) a single (joint) DCI cf. example IV.1.7) and the TCI state indication/update is present and signaled/received in the DL-DCI (and is used for the reception of DL data); and when X>0, DL-TCI-DCI is present (configured and hence can be received), and the TCI state indication/update is present and signaled/received in the DL-TCI-DCI (and is used for the reception of both DL data associated with the DL assignment in the DL-DCI, and DL control including the DL-DCI).

In one example IV.2.2, regardless of whether the offset parameter X is used/configured or not, the resulting UE procedure can be based on a higher layer (RRC) parameter, e.g., tci-dci-IsPresent. When tci-dci-IsPresent is set to ‘enabled’, DL-TCI-DCI is present (configured and hence can be received), and the TCI state indication/update is TCI state indication/update in the DL-TCI-DCI (and is used for the reception of both DL data associated with the DL assignment in the DL-DCI, and DL control including the DL-DCI). Otherwise, DL-TCI-DCI is absent (not received and/or not configured) (or DL-TCI-DCI and DL-DCI correspond to (or functionally combined into) a single (joint) DCI cf. example IV.1.7) and the TCI state indication/update is present and signaled/received in the DL-DCI (and is used for the reception of DL data).

In one example IV.2.3, regardless of whether the offset parameter X is used/configured or not, and regardless of whether a higher-layer parameter controlling the presence of DL-TCI-DCI (e.g., tci-dci-IsPresent) is used/configured or not, the resulting UE procedure can (also) be based on the higher layer parameter tci-PresentInDCI in PDSCH-Config (which controls the presence of DL-DCI). For example, when the parameter tci-dci-IsPresent is ‘enabled’ and tci-PresentInDCI in PDSCH-Config is also ‘enabled’, both the DL-TCI-DCI and DL-DCI are present (configured and hence can be received). In this case, the TCI state indication/update applicable for decoding the DL-DCI (in the pertinent PDCCH) is signaled/received in the latest (most recent) DL-TCI-DCI while the TCI state indication/update applicable for decoding the assigned DL data in the pertinent PDSCH (associated with the DL assignment in the DL-DCI) is signaled/received in the latest (most recent) DL-DCI. When the parameter tci-dci-IsPresent is ‘enabled’ and tci-PresentInDCI in PDSCH-Config is not ‘enabled’, DL-TCI-DCI is present (configured and hence can be received), and the TCI state indication/update is TCI state indication/update in the DL-TCI-DCI (and is used for the reception of both DL data associated with the DL assignment in the DL-DCI, and DL control including the DL-DCI).

In one example IV.2.4, regardless of whether the offset parameter X is used/configured or not, the resulting UE procedure can be based on a higher layer (RRC) parameter and/or MAC CE activation.

In one example IV.2.5, regardless of whether the offset parameter X is used/configured or not, the resulting UE procedure can be based on a system information (i.e., for all UEs in a cell).

In one embodiment IV.3, a UE can be configured with semi-persistent scheduling (SPS) for DL data (PDSCH) using an RRC information element (IE) sps-Config, which includes the configuration for cs-RNTI (RNTI used for the reception of DCI activating/releasing SPS). A UE shall monitor PDCCH with CRC scrambled by the cs-RNTI in every slot as the gNB can activate/re-activate/release SPS at any time using a DCI (e.g., DCI Format 1_1 or 1_2 in NR). In SPS, the UE is configured with PDSCH reception without any DL-TCI (as in dynamic scheduling explained above).

In one example IV.3.1, a UE is configured to receive a dedicated DCI (DL-TCI-DCI) indicating the common beam (TCI state) for the reception of DL control (PDCCH) and if activated by the received PDCCH, also for the reception of DL data (PDSCH). The UE receives (e.g., a DL-TCI-DCI format) and decodes DL-TCI-DCI in slot (or subframe) N, and uses the indicated beam (TCI state) to receive DL control (PDCCH) starting in the same (slot N) or later slot(s). For illustration, let X₁ be the gap (in number of slots/subframes) between the slot carrying the DL-TCI-DCI and the slot carrying the DL control, then the UE receives DL control starting in slot N+X₁. The UE decodes DCI (e.g., a DCI format) contained in PDCCH to obtain activation information for the DL assignment (via SPS). If PDSCH is activated by the DCI, the UE uses the indicated beam (TCI state) to receive DL data (PDSCH, according to the DL assignment via SPS) in slot N+X₁+K₁. Here, the value of X₁ can be fixed. Alternatively, the value of X₁ can be selected from a set of values. Optionally, the value of X₁ is not configured or set in a particular manner due to the aperiodic nature of the DCI signaling (DL-TCI-DCI and/or DCI). That is, the time unit location (e.g., slot, subframe) used to signal the DL-TCI-DCI can be different from that used to signal the DCI. In one example, X₁=X defined earlier in this disclosure. In one example, X₁=X+K₀. In one example, K₁=K₀.

In one example IV.3.2, a UE is configured to receive a dedicated DCI (DL-TCI-DCI) via PDCCH, which includes the common beam (TCI state) for the reception of PDCCH in later slot(s) and, if activated by the received PDCCH, the common beam is also used for the reception of DL data (PDSCH) scheduled by SPS. The UE receives (e.g., a DL-TCI-DCI format) and decodes DL-TCI-DCI in slot (or subframe) N, and uses the indicated beam (TCI state) to receive DL control (PDCCH) starting in later slot(s)). If PDSCH reception is activated by the DL-TCI-DCI, the UE uses the indicated beam (TCI state) to receive DL data (PDSCH, according to the DL assignment via SPS) in slot N+X₁. Here, the value of X₁ can be fixed. Alternatively, the value of X₁ can be selected from a set of values. Optionally, the value of X₁ is not configured or set in a particular manner due to the aperiodic nature of the DCI signaling (DL-TCI-DCI). That is, the time unit location (e.g., slot, subframe) used to signal the DL-TCI-DCI can be different from that used to signal the PDSCH. In one example, X₁=X defined earlier in this disclosure. In one example, X₁=X+K₀. In one example, K₁=K₀.

In one example IV.3.3, a UE is configured to receive a dedicated DCI (e.g., DL-TCI-DCI) via PDCCH, which includes (a) a field for the common beam (TCI state) and/or (b) another field for the activation/release of PDSCH reception (according to the configured SPS). When PDSCH reception is activated by field (b), the UE can be indicated/updated with a new (TCI state) beam for PDSCH reception (with or without PDCCH reception) using the field (a). Once PDSCH reception is not activated or released by field (b), the UE can be indicated/updated with a new (TCI state) beam for PDCCH reception only using the field (a).

In this disclosure, a common beam indication for UL data (PUSCH) and UL control (PUCCH) via UL-TCI-DCI is proposed. The disclosure also proposes a common beam indication for data (PDSCH/PUSCH) and control (PDCCH/PUCCH) for both DL and UL via TCI-DCI.

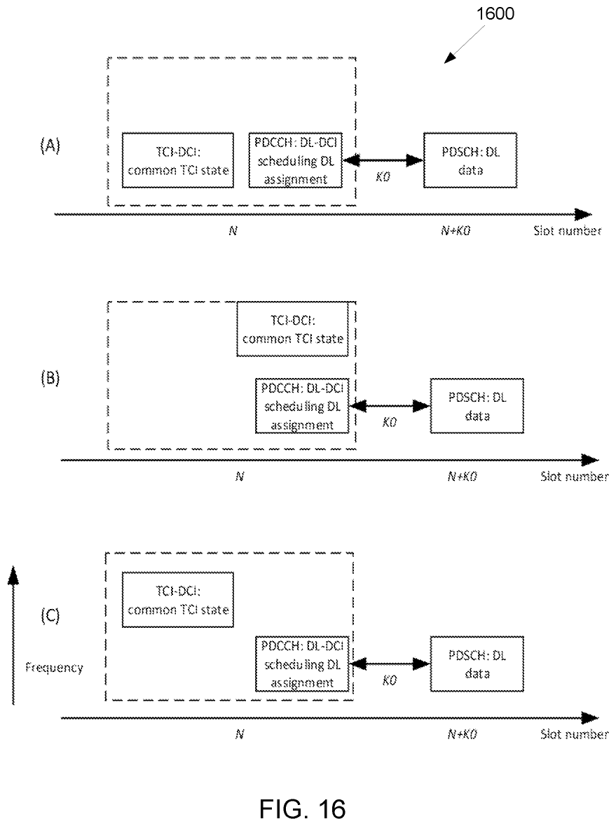

FIG. 16 illustrates an example of a dedicated DCI indicating the common beam for the transmission of UL control and data 1600. The example of a dedicated DCI indicating the common beam for the transmission of UL control and data 1600 illustrated in FIG. 16 is for illustration only. FIG. 16 does not limit the scope of this disclosure to any particular implementation of the example of a dedicated DCI indicating the common beam for the transmission of UL control and data 1600.

In one embodiment IV.4, as shown in FIG. 16, a UE is configured to receive a dedicated DCI (UL-TCI-DCI) indicating the common beam (TCI state) for the transmission of UL control (PUCCH) and data (PUSCH), wherein PUCCH can be associated with (or in response to) DL reception and/or UL transmission. Optionally, the common beam can also be used for the transmission of PRACH. The UE receives (e.g., a UL-TCI-DCI format) and decodes UL-TCI-DCI in slot (or subframe) N′, and uses either the indicated beam (TCI state) or another TCI state (beam) to receive DL control (PDCCH) starting in the same (slot N′) or later slot(s). For illustration, let X′ be the gap (in number of slots/subframes) between the slot carrying the DL-TCI-DCI and the slot carrying the DL control, then the UE receives DL control starting in slot N′+X′. The UE decodes UL-DCI (e.g., a UL-DCI format) contained in PDCCH to obtain scheduling information for the UL grant. The UE uses the indicated beam (TCI state) in UL-TCI-DCI to transmit UL control (PUCCH) and/or UL data (PUSCH, according to the UL grant) in slot N′+X′+K. Here, the value of X′ can be fixed. Alternatively, the value of X′ can be selected from a set of values. Optionally, the value of X′ is not configured or set in a particular manner due to the aperiodic nature of the DCI signaling (UL-TCI-DCI and/or UL-DCI). That is, the time unit location (e.g., slot, subframe) used to signal the UL-TCI-DCI can be different from that used to signal the UL-DCI. In some examples, X′ can also be referred to as a uplink beam application time (UL-BAT) value B′. In some example, X′ is lower bounded by B′, i.e., X′≥B′.

In an example, the unit of N′ and/or X′ and/or K₀′ is defined in terms of number of OFDM symbols. The value X′ is measured from the end of UL-TCI-DCI decoding (i.e., the last symbol carrying UL-TCI-DCI) and the start of UL-DCI reception (i.e., the first symbol carrying UL-DCI), or the value X′ is determined as the first slot that is at least P′ ms or Q′ symbols after the UL-TCI-DCI with the common beam indication, where P′ or Q′ can be fixed, or configured, or determined/configured based on UE capability reporting). Likewise, the value K₀′ is measured from the end of UL-DCI decoding (i.e., the last symbol carrying UL-DCI) and the start of PUCCH/PUSCH transmission (i.e., the first symbol carrying PUCCH/PUSCH). In the rest of the disclosure, the unit of N′, X′, and K₀′ is assumed to be in terms of time slots (or subframes). The embodiments of the disclosure, however, are general and are applicable to any units such as number of OFDM symbols.

In an example, the value of X′ is set/determined based on the UE's processing restriction (i.e., the processing latency) or capability. When a new beam (TCI state) is indicated via UL-TCI-DCI, it can be used for the reception of UL-DCI not earlier than X′ time (slots or subframes or OFDM symbols)) where X′ is subject to (or determined/configured based on) the UE capability.

In one example, a UE is configured/triggered with a PUCCH transmission (e.g., for the HARQ-ACK feedback) that can be associated with a DL (e.g., PDSCH) reception, which is triggered (or scheduled) by DL-DCI. In this case, the TCI state (beam) for the PUCCH transmission is indicated/updated via either UL-TCI-DCI (cf. embodiment IV.4 through IV.6 below) or DL-TCI-DCI.

When the PDCCH carrying the UL-TCI-DCI is associated with (configured) with a HARQ-ACK (or ACK/NACK) feedback (e.g., via a PUCCH transmission) indicating that the UE receives the updated common beam, then the beam application time may include the time between the PDCCH reception (either from the start or the end of PDCCH reception) and the corresponding PUCCH transmission (either from the start or the end of PUCCH transmission), i.e., X′=Y₁+Y₂ where Y₁=the time between PDCCH reception and PUCCH transmission, and Y₂=the time between PUCCH transmission and UL-DCI reception. Alternatively, the beam application time equals Y₂. In this case, the TCI state (beam) for the PUCCH transmission can be the latest (previously) beam that is indicated via UL-TCI-DCI prior to the new/updated TCI state in the current slot.

The beam (or TCI state) to receive UL-TCI-DCI in slot N′ can be the beam (or TCI state) indicated via the latest UL-TCI-DCI in an earlier slot M′<N′. If the latest UL-TCI-DCI is not received or is not configured, then a default beam can be used. For instance, the default beam for PDCCH reception in the 3GPP NR specification can be used. Alternatively, the beam (or TCI state) to receive UL-TCI-DCI can be the beam to receive a DL channel and/or DL RS in an earlier slot M′<N′. Alternatively, the beam (or TCI state) to receive UL-TCI-DCI can be associated with the beam to transmit a UL channel and/or UL RS in an earlier slot M′<N′. Alternatively, the beam (or TCI) to receive UL-TCI-DCI can be associated with a beam used to receive an SSB associated with the most recent random access procedure, e.g., random access procedure not initiated by a PDCCH order that triggers a contention-free random access procedure. Alternatively, the beam (or TCI) to receive UL-TCI-DCI can be associated with a beam used to receive a CSI-RS associated with the most recent random access procedure, e.g., random access procedure not initiated by a PDCCH order that triggers a contention-free random access procedure. Optionally, instead of using a default beam for receiving UL-TCI-DCI in slot N′, the beam (or TCI state) for receiving the UL-TCI-DCI can be signaled via MAC CE. For example, the mechanism supported in the 3GPP NR specification for updating the TCI state of PDCCH can be reused to update the TCI state (beam) for receiving the UL-TCI-DCI.

At least one of the following examples can be used to determine the value of X′ and K₀′.

Example IV.4.1 through example IV.4.5 in which the values of X′ and K₀′ are set are analogous to example IV.1.1 through example IV.1.5 (X and K₀) in embodiment IV.1.

In one example IV.4.6, the value of X′ is not configured, used, and/or set in a particular manner due to the (aperiodic) nature of the DCI signaling (UL-TCI-DCI and/or UL-DCI). Here, the UE monitors the presence of UL-TCI-DCI as well as UL-DCI in each slot/subframe by detecting the presence of the associated IDs (such as C-RNTI or group-RNTI or TCI-RNTI). In this case, the location of the pertinent UL-TCI-DCI can be in any slot relative to the location of the UL-DCI. The applicability of the TCI state signaled in the UL-TCI-DCI can be determined from its location relative to UL-DCI, e.g., to ensure sufficient time for decoding the UL-TCI-DCI so that the TCI state is applicable to some following UL-DCI(s). For example, the UE assumes a minimum TCI state (beam) switching time (in number of slots/subframes or ODFM symbols) from the end of UL-TCI-DCI decoding (i.e., the last symbol carrying UL-TCI-DCI) and the start of UL-TCI reception (i.e., the first symbol carrying UL-DCI). In one example, this switching time is reported by the UE in its capability signaling (or is fixed or is configured to the UE).

In any of the previously described and following examples and embodiments associated with X′=0, the methods can stand alone and, therefore, be implemented without the use of any offset parameter X′. In other words, any of such examples or embodiments can be utilized without any parameterization of X′, or setting an offset parameter (such as X′) to be 0.

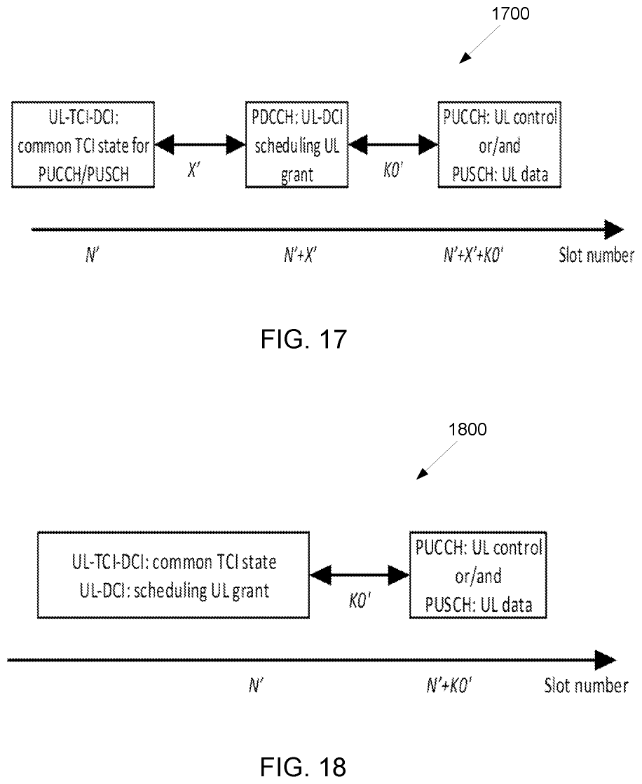

FIG. 17 illustrates an example of receiving UL-TCI-DCI and UL-DCI in the same slot or subframe 1700. The example of receiving UL-TCI-DCI and UL-DCI in the same slot or subframe 1700 illustrated in FIG. 17 is for illustration only. FIG. 17 does not limit the scope of this disclosure to any particular implementation of the example of receiving UL-TCI-DCI and UL-DCI in the same slot or subframe 1700.

In at least one of the above embodiments (or examples), as shown in FIG. 17, when the value of the parameter X′=0, i.e., the UE is configured to receive UL-TCI-DCI and UL-DCI in the same slot (or subframe) N′. The UE receives/decodes UL-TCI-DCI and UL-DCI in slot (or subframe) N′, and obtains the indicated beam (TCI state) from UL-TCI-DCI and scheduling information for the UL grant from UL-DCI. The UE then transmits UL control (PUCCH) and/or UL data (PUSCH, according to the UL grant) using the indicated beam in slot N′+K₀′.

Since UL-DCI and UL-TCI-DCI are received in the same slot, the UE can't use the beam indicated via UL-TCI-DCI in the current slot for the reception of DL control (PDCCH carrying UL-DCI). The beam (or TCI state) to receive UL-TCI-DCI and UL-DCI in slot N′ can be the beam indicated via the latest UL-TCI-DCI in an earlier slot M′<N′ or, optionally, the latest TCI state applicable to the UL-DCI signaled via other means. If the latest UL-TCI-DCI is not received or is not configured, then a default beam can be used. For instance, the default beam for PDCCH reception in the 3GPP NR specification can be used. Alternatively, the beam (or TCI state) to receive UL-TCI-DCI and UL-DCI can be the beam to receive a DL channel and/or DL RS in an earlier slot M′<N′. Alternatively, the beam (or TCI state) to receive UL-TCI-DCI and UL-DCI can be associated with the beam to transmit a UL channel and/or UL RS in an earlier slot M′<N′. Optionally, instead of using a default beam for receiving UL-TCI-DCI and UL-DCI in slot N′, the beam (or TCI state) for receiving the UL-TCI-DCI can be signaled via MAC CE. For example, the mechanism supported in the 3GPP NR specification for updating the TCI state of PDCCH can be reused to update the TCI state (beam) for receiving the UL-TCI-DCI.

At least one of the following examples can be applicable when the UL-TCI-DCI and UL-DCI are received in the same slot.

In one example IV.4.7, UL-TCI-DCI and UL-DCI correspond to (or functionally combined into) a single (joint) DCI including all DCI fields of both UL-TCI-DCI and UL-DCI. In one example, this joint DCI is labelled as UL-TCI-DCI. In one example, this joint DCI is labelled as UL-DCI (e.g., format 0_0, 0_1, or 0_2 in NR specification). In one example, the UL-DCI format can include one or both of common beam (TCI state) for UL transmission and UL grant. At least one of the following examples can be used/configured.
In example IV.4.7.1, the UE decodes the UL-DCI and determines whether only one or both of common beam (TCI state) and UL grant are included. For example, when the TCI state field in the DCI takes a value (e.g., 0), it indicates that the TCI state (or common beam) is not indicated (or being absent). Likewise, when a parameter in the scheduling assignment field in the DCI takes a value (e.g., 0), it indicates that there is no UL grant (absent).
In example IV.4.7.2, the information whether only one or both of common beam (TCI state) and UL grant are included can be configured via RRC or activated via MAC CE.

In one example IV.4.8, UL-TCI-DCI can be separate from UL-DCI, but they are in the same slot. The rest of the details are analogous to example IV.1.8.

In one example IV.4.9, UL-TCI-DCI and DL-DCI (scheduling DL assignment) correspond to (or functionally combined into) a single (joint) DCI including all DCI fields of both UL-TCI-DCI and DL-DCI. In one example, this joint DCI is labelled as UL-TCI-DCI. In one example, this joint DCI is labelled as DL-DCI (e.g., format 1_0, 1_1, or 1_2 in NR specification). In one example, the DL-DCI format can include one or both of common beam (TCI state) for UL transmission and DL assignment. At least one of the following examples can be used/configured.
In example IV.4.9.1, the UE decodes the DL-DCI and determines whether only one or both of common beam (TCI state) and DL assignment are included. For example, when the TCI state field in the DCI takes a value (e.g., 0), it indicates that the TCI state (or common beam) is not indicated (or being absent). Likewise, when a parameter in the scheduling assignment field in the DCI takes a value (e.g., 0), it indicates that there is no DL assignment (absent).
In example IV.4.9.2, the information whether only one or both of common beam (TCI state) and DL assignment are included can be configured via RRC or activated via MAC CE.

In one embodiment IV.5 a UE can be configured with a higher layer parameter (and/or MAC CE and/or DL-DCI field) to enable the TCI state (beam) indication via UL-TCI-DCI. For example, a UE can be configured to derive its TCI state update from UL-DCI and/or UL-TCI-DCI depending on the configuration for UL-DCI and/or UL-TCI-DCI. The rest of the details are analogous to the corresponding embodiment IV.2 for DL.

In one example IV.5.1, when the offset parameter X′ is used or configured, the resulting UE procedure can be dependent on the value of X′. For example, when X′=0, UL-TCI-DCI is absent (not received and/or not configured) (or UL-TCI-DCI and UL-DCI correspond to (or functionally combined into) a single (joint) DCI cf. example IV.4.7) and the TCI state indication/update is present and signaled/received in the UL-DCI (and is used for the transmission of UL data); and when X>0, UL-TCI-DCI is present (configured and hence can be received), and the TCI state indication/update is present and signaled/received in the UL-TCI-DCI (and is used for the transmission of UL data and/or UL control).

In one example IV.5.2, regardless of whether the offset parameter X′ is used/configured or not, the resulting UE procedure can be based on a higher layer (RRC) parameter, e.g., ul-tci-dci-IsPresent. When ul-tci-dci-IsPresent is set to ‘enabled’, UL-TCI-DCI is present (configured and hence can be received), and the TCI state indication/update is TCI state indication/update in the UL-TCI-DCI (and is used for the transmission of UL data and/or UL control). Otherwise, UL-TCI-DCI is absent (not received and/or not configured) (or UL-TCI-DCI and UL-DCI correspond to (or functionally combined into) a single (joint) DCI cf. example IV.4.7) and the TCI state indication/update is present and signaled/received in the UL-DCI (and is used for the transmission of UL data).

In one example IV.5.3, regardless of whether the offset parameter X′ is used/configured or not, and regardless of whether a higher-layer parameter controlling the presence of UL-TCI-DCI (e.g., ul-tci-dci-IsPresent) is used/configured or not, the resulting UE procedure can (also) be based on the higher layer parameter tci-PresentInDCI in PUSCH-Config (which controls the presence of UL-DCI) or in PDSCH-Config. For example, when the parameter ul-tci-dci-IsPresent is ‘enabled’ and tci-PresentInDCI is also ‘enabled’, both the UL-TCI-DCI and UL-DCI are present (configured and hence can be received). In this case, the TCI state indication/update applicable for decoding the UL-DCI (in the pertinent PDCCH) is signaled/received in the latest (most recent) UL-TCI-DCI while the TCI state indication/update applicable for transmission of the UL data in the pertinent PUSCH (associated with the UL grant in the UL-DCI) is signaled/received in the latest (most recent) UL-DCI. When the parameter ul-tci-dci-IsPresent is ‘enabled’ and tci-PresentInDCI is not ‘enabled’, UL-TCI-DCI is present (configured and hence can be received), and the TCI state indication/update is TCI state indication/update in the UL-TCI-DCI (and is used for the transmission of both UL data associated with the UL grant in the UL-DCI, and UL control).

In one example IV.5.4, regardless of whether the offset parameter X′ is used/configured or not, the resulting UE procedure can be based on a higher layer (RRC) parameter and/or MAC CE activation.

In one example IV.5.5, regardless of whether the offset parameter X′ is used/configured or not, the resulting UE procedure can be based on a system information (i.e., for all UEs in a cell).

In any of the previously described and following examples and embodiments associated with X′=0, the methods can stand alone and, therefore, be implemented without the use of any offset parameter X′. In other words, any of such examples or embodiments can be utilized without any parameterization of X′, or setting an offset parameter (such as X′) to be 0.

In one embodiment IV.6, a UE can be configured with PUSCH transmission(s) that correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled (SPS) by an UL grant in a valid activation DCI after the reception of higher layer parameter configuredGrantConfig not including rrc-ConfiguredUplinkGrant. If Configuredgrantconfig-ToAddModList-r16 is configured, more than one configured grant configuration of configured grant Type 1 and/or configured grant Type 2 may be active at the same time on an active BWP of a serving cell. For the configured grant Type 2 PUSCH transmission, the UE is configured with cs-RNTI (RNTI used for the reception of DCI activating/releasing SPS). A UE shall monitor PDCCH with CRC scrambled by the cs-RNTI in every slot as the gNB can activate/re-activate/release SPS at any time using a DCI (e.g., DCI Format 0_1 or 0_2 in NR).

A UE can be configured with PUCCH transmission(s) that correspond to a periodic or semi-persistent CSI-report sent on PUCCH. Such PUCCH transmissions are configured by CSI-ReportConfig, without the detection of an UL grant in a UL-DCI. The semi-persistent CSI report on PUCCH can be activated/de-activated by a MAC CE.

In one example IV.6.1, a UE is configured to receive a dedicated DCI (UL-TCI-DCI) indicating the common beam (TCI state) for the transmission of UL control (PUCCH) and/or data (PUSCH) if activated by the received PDCCH. The UE receives (e.g., a UL-TCI-DCI format) and decodes UL-TCI-DCI in slot (or subframe) N′, and uses the indicated beam (TCI state) to receive DL control (PDCCH) starting in the same (slot N′) or later slot(s). For illustration, let X₁′ be the gap (in number of slots/subframes) between the slot carrying the UL-TCI-DCI and the slot carrying the DL control, then the UE receives DL control starting in slot N′+X₁′. The UE decodes DCI (e.g., a DCI format) contained in PDCCH to obtain activation information for the UL assignment (for the configured grant Type 2 PUSCH transmission). If PUSCH is activated by the DCI, the UE uses the indicated beam (TCI state) to transmit UL data (PUSCH, according to the UL assignment) in slot N′+X₁′+K₁′. Here, the value of X₁′ can be fixed. Alternatively, the value of X₁′ can be selected from a set of values. Optionally, the value of X₁′ is not configured or set in a particular manner due to the aperiodic nature of the DCI signaling (UL-TCI-DCI and/or DCI). That is, the time unit location (e.g., slot, subframe) used to signal the UL-TCI-DCI can be different from that used to signal the DCI. In one example, X₁′=X′ defined earlier in this disclosure. In one example, X₁′=X′+K₀′. In one example, K₁′=K₀′.

In one example IV.6.2, a UE is configured to receive a dedicated DCI (UL-TCI-DCI) via PDCCH, which includes the common beam (TCI state) for the reception of PDCCH in later slot(s) and, if activated by the received PDCCH, the common beam is also used for the transmission of UL data (PUSCH) (for the configured grant Type 2 PUSCH transmission). The UE receives (e.g., a UL-TCI-DCI format) and decodes UL-TCI-DCI in slot (or subframe) N′, and uses the indicated beam (TCI state) to receive DL control (PDCCH) starting in later slot(s). If PUSCH transmission is activated by the UL-TCI-DCI, the UE uses the indicated beam (TCI state) to transmit UL data (PUSCH, according to the UL assignment) in slot N′+X₁′. Here, the value of X₁′ can be fixed. Alternatively, the value of X₁′ can be selected from a set of values. Optionally, the value of X₁′ is not configured or set in a particular manner due to the aperiodic nature of the DCI signaling (UL-TCI-DCI). That is, the time unit location (e.g., slot, subframe) used to signal the UL-TCI-DCI can be different from that used to signal the PUSCH. In one example, X₁′=X′ defined earlier in this disclosure. In one example, X₁′=X′+K₀′. In one example, K₁′=K₀′.

In one example IV.6.3, a UE is configured to receive a dedicated DCI (UL-TCI-DCI) indicating the common beam (TCI state) for the transmission of UL control (PUCCH) and/or data (PUSCH). The UE receives (e.g., a UL-TCI-DCI format) and decodes UL-TCI-DCI in slot (or subframe) N′, and uses the indicated beam (TCI state) to transmit UL control (PUCCH) (e.g., periodic PUCCH or semi-persistent PUCCH) and/or data (PUSCH) (e.g., configured grant Type 1) starting in the same (slot N′) or later slot(s). For illustration, let X₁′ be the gap (in number of slots/subframes) between the slot carrying the UL-TCI-DCI and the slot carrying the UL transmission, then the UE can start using the indicated beam (TCI state) for uplink transmission in slot N′+X₁′. Here, the value of X₁′ can be fixed. Alternatively, the value of X₁′ can be selected from a set of values. Optionally, the value of X₁′ is not configured or set in a particular manner due to the aperiodic nature of the DCI signaling (UL-TCI-DCI and/or DCI). That is, the time unit location (e.g., slot, subframe) used to signal the UL-TCI-DCI can be different from that used to signal the DCI. In one example, X₁′=X′ defined earlier in this disclosure. In one example, X₁′=X′+K₀′. In one example, K₁′=K₀′.

In one embodiment IV.7, a UE can be configured to receive a dedicated DCI (RACH-TCI-DCI) indicating the common beam (TCI state) for the transmission of PDCCH-triggered contention-free random access (CFRA) preambles, such PDCCH is known as a PDCCH order, which can be a DCI format 1_0 with the “frequency domain resource assignment” field set to all ones as described in TS 38.212. In this example and its sub-examples, a PDCCH order is for a contention free random access preamble transmission. The UE receives (e.g., a RACH-TCI-DCI format) and decodes RACH-TCI-DCI in slot (or subframe) N′, and uses either the indicated beam (TCI state) or another TCI state (beam) to receive DL control (PDCCH order) starting in the same (slot N′) or later slot(s). For illustration, let X′ be the gap (in number of slots/subframes) between the slot carrying the RACH-TCI-DCI and the slot carrying the DL control (i.e., PDCCH order), then the UE receives DL control starting in slot N′+X′. The UE decodes the PDCCH order to obtain preamble transmission parameters (i.e., preamble index and PRACH transmission occasion). The UE uses the indicated beam (TCI state) in RACH-TCI-DCI to transmit CFRA preamble starting in slot N′+X′+K₀′ in the indicated PRACH occasions. Here, the value of X′ can be fixed. Alternatively, the value of X′ can be selected from a set of values. Optionally, the value of X′ is not configured or set in a particular manner due to the aperiodic nature of the DCI signaling (RACH-TCI-DCI and/or PDCCH order). That is, the time unit location (e.g., slot, subframe) used to signal the RACH-TCI-DCI can be different from that used to signal the PDCCH order.

In an example, the unit of N′ and/or X′ and/or K₀′ is defined in terms of number of OFDM symbols. The value X′ is measured from the end of RACH-TCI-DCI decoding (i.e., the last symbol carrying RACH-TCI-DCI) and the start of PDCCH order reception (i.e., the first symbol carrying PDCCH order). Likewise, the value K₀′ is measured from the end of PDCCH order decoding (i.e., the last symbol carrying PDCCH order) and the earliest possible start of the PRACH preamble. In the rest of the disclosure, the unit of N′, X′, and K₀′ is assumed to be in terms of time slots (or subframes). The embodiments of the disclosure, however, are general and are applicable to any units such as number of OFDM symbols.

The beam (or TCI state) to receive RACH-TCI-DCI in slot N′ can be the beam (or TCI state) indicated via the latest RACH-TCI-DCI in an earlier slot M′<N′. If the latest RACH-TCI-DCI is not received or is not configured, then a default beam can be used. For instance, the default beam for PDCCH reception in the 3GPP NR specification can be used. Alternatively, the beam (or TCI state) to receive RACH-TCI-DCI can be the beam to receive a DL channel and/or DL RS in an earlier slot M′<N′. Alternatively, the beam (or TCI state) to receive RACH-TCI-DCI can be associated with the beam to transmit a UL channel and/or UL RS in an earlier slot M′<N′. Alternatively, the beam (or TCI) to receive RACH-TCI-DCI can be associated with a beam used to receive an SSB associated with the most recent random access procedure, e.g., random access procedure not initiated by a PDCCH order that triggers a contention-free random access procedure. Alternatively, the beam (or TCI) to receive RACH-TCI-DCI can be associated with a beam used to receive a CSI-RS associated with the most recent random access procedure, e.g., random access procedure not initiated by a PDCCH order that triggers a contention-free random access procedure. Optionally, instead of using a default beam for receiving RACH-TCI-DCI in slot N′, the beam (or TCI state) for receiving the RACH-TCI-DCI can be signaled via MAC CE. For example, the mechanism supported in the 3GPP NR specification for updating the TCI state of PDCCH can be reused to update the TCI state (beam) for receiving the RACH-TCI-DCI.

At least one of the following examples can be used to determine the value of X′ and K₀′.

Example IV.7.1 through example IV.7.5 in which the values of X′ and K₁′ are set are analogous to example IV.1.1 through example IV.1.5 (X and K₀) in embodiment IV.1.

In one example IV.7.6, the value of X′ is not configured, used, and/or set in a particular manner due to the (aperiodic) nature of the DCI signaling (RACH-TCI-DCI and/or PDCCH order). Here, the UE monitors the presence of RACH-TCI-DCI as well as PDCCH order in each slot/subframe by detecting the presence of the associated IDs (such as C-RNTI or group-RNTI or TCI-RNTI). In this case, the location of the pertinent RACH-TCI-DCI can be in any slot relative to the location of the PDCCH order. The applicability of the TCI state signaled in the RACH-TCI-DCI can be determined from its location relative to PDCCH order, e.g., to ensure sufficient time for decoding the RACH-TCI-DCI so that the TCI state is applicable to some following PDCCH order(s). For example, the UE assumes a minimum TCI state (beam) switching time (in number of slots/subframes or ODFM symbols) from the end of RACH-TCI-DCI decoding (i.e., the last symbol carrying RACH-TCI-DCI) and the start of PDCCH order reception (i.e., the first symbol carrying PDCCH order). In one example, this switching time is reported by the UE in its capability signaling (or is fixed or is configured to the UE).

In any of the previously described and following examples and embodiments associated with X′=0, the methods can stand alone and, therefore, be implemented without the use of any offset parameter X′. In other words, any of such examples or embodiments can be utilized without any parameterization of X′, or setting an offset parameter (such as X′) to be 0.

In at least one of the above embodiments (or examples), when the value of the parameter X′=0, i.e., the UE is configured to receive RACH-TCI-DCI and PDCCH order in the same slot (or subframe) N′. The UE receives/decodes RACH-TCI-DCI and PDCCH order in slot (or subframe) N′, and obtains the indicated beam (TCI state) from RACH-TCI-DCI and scheduling information for the UL grant from PDCCH order. The UE then transmits PRACH preamble (according to the PDCCH order) using the indicated beam in an indicated PRACH occasion starting at slot N′+K.

Since PDCCH order and RACH-TCI-DCI are received in the same slot, the UE can't use the beam indicated via RACH-TCI-DCI in the current slot for the reception of DL control (PDCCH order). The beam (or TCI state) to receive RACH-TCI-DCI and PDCCH order in slot N′ can be the beam indicated via the latest RACH-TCI-DCI in an earlier slot M′<N′ or, optionally, the latest TCI state applicable to the PDCCH order signaled via other means. If the latest RACH-TCI-DCI is not received or is not configured, then a default beam can be used. For instance, the default beam for PDCCH reception in the 3GPP NR specification can be used. Alternatively, the beam (or TCI state) to receive PDCCH-TCI-DCI and PDCCH order can be the beam to receive a DL channel and/or DL RS in an earlier slot M′<N′. Alternatively, the beam (or TCI state) to receive RACH-TCI-DCI and PDCCH order can be associated with the beam to transmit a UL channel and/or UL RS in an earlier slot M′<N′. Optionally, instead of using a default beam for receiving RACH-TCI-DCI and PDCCH order in slot N′, the beam (or TCI state) for receiving the RACH-TCI-DCI can be signaled via MAC CE. For example, the mechanism supported in the 3GPP NR specification for updating the TCI state of PDCCH can be reused to update the TCI state (beam) for receiving the RACH-TCI-DCI.

At least one of the following examples can be applicable when the RACH-TCI-DCI and PDCCH order are received in the same slot.

In one example IV.7.7, RACH-TCI-DCI and PDCCH order correspond to (or functionally combined into) a single (joint) DCI including all DCI fields of both RACH-TCI-DCI and PDCCH order. In one example, this joint DCI is labelled as RACH-TCI-DCI. In one example, this joint DCI is labelled as PDCCH order.

In one example IV.7.8, RACH-TCI-DCI can be separate from PDCCH order, but they are in the same slot. The rest of the details are analogous to example IV.1.8.

In one example IV.7.9, a RACH-TCI-DCI can be an UL-TCI-DCI in the above examples.

FIG. 18 illustrates an example of a dedicated DCI indicating the common beam for all DL and UL channels 1800. The example of a dedicated DCI indicating the common beam for all DL and UL channels 1800 illustrated in FIG. 18 is for illustration only. FIG. 18 does not limit the scope of this disclosure to any particular implementation of the example of a dedicated DCI indicating the common beam for all DL and UL channels 1800.

In embodiment IV.8, as shown in FIG. 18, a UE is configured to receive a dedicated DCI (TCI-DCI) indicating the common beam (TCI state) for all DL and UL channels. In particular, the indicated common beam is used for the reception of DL control (PDCCH) and DL data (PDSCH) as well as for the transmission of UL control (PUCCH) and UL data (PUSCH), wherein PUCCH can be associated with (or in response to) DL reception and/or UL transmission. Optionally, the common beam can also be used for the transmission of PRACH (cf. embodiment IV.7). The UE receives (e.g., a TCI-DCI format) and decodes TCI-DCI in slot (or subframe) N, and uses either the indicated beam (TCI state) or another TCI state (beam) to receive DL control (PDCCH) scheduling DL assignment (via DL-DCI) and/or UL grant (via UL-DCI) starting in the same (slot N) or later slot(s).

For DL, let X be the gap (in number of slots/subframes) between the slot carrying the TCI-DCI and the slot carrying the DL control scheduling DL assignment (via DL-DCI), then the UE receives DL control starting in slot N+X. The UE decodes DL-DCI (e.g., a DL-DCI format) contained in PDCCH to obtain scheduling information for the DL assignment. The UE then uses the indicated beam (TCI state) to receive DL data (PDSCH, according to the DL assignment) in slot N+X+K₀. Here, the value of X can be fixed. Alternatively, the value of X can be selected from a set of values. Optionally, the value of X is not configured or set in a particular manner due to the aperiodic nature of the DCI signaling (TCI-DCI and/or DL-DCI). That is, the time unit location (e.g., slot, subframe) used to signal the TCI-DCI can be different from that used to signal the DL-DCI. The methods in which the values of X and K₀ are set and their units (number of slots or subframes or OFDM symbols) are analogous to those applicable for embodiment IV.1. In some examples, X can also be referred to as a downlink beam application time (DL-BAT) B. In some examples, X is lower bounded by B, i.e., X≥B.

For UL, let X′ be the gap (in number of slots/subframes) between the slot carrying the TCI-DCI and the slot carrying the DL control scheduling UL grant (via UL-DCI), then the UE receives DL control starting in slot N′+X′. The UE decodes UL-DCI (e.g., a UL-DCI format) contained in PDCCH to obtain scheduling information for the UL grant. The UE uses the indicated beam (TCI state) in TCI-DCI to transmit UL control (PUCCH) and/or UL data (PUSCH, according to the UL grant) in slot N′+X′+K₀′. Here, the value of X′ can be fixed. Alternatively, the value of X′ can be selected from a set of values. Optionally, the value of X′ is not configured or set in a particular manner due to the aperiodic nature of the DCI signaling (TCI-DCI and/or UL-DCI). That is, the time unit location (e.g., slot, subframe) used to signal the TCI-DCI can be different from that used to signal the UL-DCI. The methods in which the values of X′ and K are set and their units (number of slots or subframes or OFDM symbols) are analogous to those applicable for embodiment IV.4. In some examples, X′ can also be referred to as a uplink beam application time (UL-BAT) B′. In some examples, X′ is lower bounded by B′, i.e., X′≥B′.

In an example, the value X is measured from the end of TCI-DCI decoding (i.e., the last symbol carrying TCI-DCI) and the start of DL-DCI reception (i.e., the first symbol carrying DL-DCI), or the value X is determined as the first slot that is at least P ms or Q symbols after the TCI-DCI with the common beam indication, where P or Q can be fixed, or configured, or determined/configured based on UE capability reporting). Likewise, the value K₀ is measured from the end of DL-DCI decoding (i.e., the last symbol carrying DL-DCI) and the start of PDSCH reception (i.e., the first symbol carrying PDSCH). The unit of N, X, and K₀ is assumed to be in terms of time slots (so subframes) or number of OFDM symbols.

In an example, the value X′ is measured from the end of TCI-DCI decoding (i.e., the last symbol carrying TCI-DCI) and the start of UL-DCI reception (i.e., the first symbol carrying UL-DCI), or the value X′ is determined as the first slot that is at least P′ ms or Q′ symbols after the TCI-DCI with the common beam indication, where P′ or Q′ can be fixed, or configured, or determined/configured based on UE capability reporting). Likewise, the value K₀′ is measured from the end of UL-DCI decoding (i.e., the last symbol carrying UL-DCI) and the start of PUSCH transmission (i.e., the first symbol carrying PUSCH). The unit of X′, and K₀′ is assumed to be in terms of time slots (so subframes) or number of OFDM symbols.

In an example, the value of X and/or X′ is set/determined based on the UE's processing restriction (i.e., the processing latency) or capability. When a new beam (TCI state) is indicated via TCI-DCI, it can be used for the reception of DL-DCI or UL-DCI not earlier than X or X′ time (slots or subframes or OFDM symbols) where X and X′ are subject to (or determined/configured based on) the UE capability.

In one example, a UE is configured/triggered with a PUCCH transmission (e.g., for the HARQ-ACK feedback) that can be associated with a DL (e.g., PDSCH) reception, which is triggered (or scheduled) by DL-DCI. In this case, the TCI state (beam) for the PUCCH transmission is indicated/updated via TCI-DCI.

When the PDCCH carrying the TCI-DCI is associated with (configured) with a HARQ-ACK (or ACK/NACK) feedback (e.g., via a PUCCH transmission) indicating that the UE receives the updated common beam, then the beam application time may include the time between the PDCCH reception (either from the start or the end of PDCCH reception) and the corresponding PUCCH transmission (either from the start or the end of PUCCH transmission), i.e., X (or X′)=Y₁+Y₂ where Y₁=the time between PDCCH reception and PUCCH transmission, and Y₂=the time between PUCCH transmission and DL-DCI (or UL-DCI) reception. Alternatively, the beam application time equals Y₂. In this case, the TCI state (beam) for the PUCCH transmission can be the latest (previously) beam that is indicated via TCI-DCI prior to the new/updated TCI state in the current slot.

The beam (or TCI state) to receive TCI-DCI in slot N can be the beam (or TCI state) indicated via the latest TCI-DCI in an earlier slot M<N. If the latest TCI-DCI is not received or is not configured, then a default beam can be used. For instance, the default beam for PDCCH reception in the 3GPP NR Specification can be used. Alternatively, the beam (or TCI state) to receive TCI-DCI can be the beam to receive a DL channel and/or DL RS in an earlier slot M<N. Alternatively, the beam (or TCI state) to receive TCI-DCI can be associated with the beam to transmit a UL channel and/or UL RS in an earlier slot M<N. Alternatively, the beam (or TCI) to receive TCI-DCI can be associated with a beam used to receive an SSB associated with the most recent random access procedure, e.g., random access procedure not initiated by a PDCCH order that triggers a contention-free random access procedure. Alternatively, the beam (or TCI) to receive TCI-DCI can be associated with a beam used to receive a CSI-RS associated with the most recent random access procedure, e.g., random access procedure not initiated by a PDCCH order that triggers a contention-free random access procedure. Optionally, instead of using a default beam for receiving TCI-DCI in slot N, the beam (or TCI state) for receiving the TCI-DCI can be signaled via MAC CE. For example, the mechanism supported in the 3GPP NR Specification for updating the TCI state of PDCCH can be reused to update the TCI state (beam) for receiving the TCI-DCI.

At least one of the following examples can be used to determine the value of X and K₀ and X′ and K₀′.

Example IV.8.1 through example IV.8.5 in which the values of X and K₀ are set are analogous to example IV.1.1 through example IV.1.5 in embodiment IV.1; and X′ and K₀′ are set are analogous to example IV.4.1 through example IV.4.5 in embodiment IV.4.

In one example IV.8.6, the value of X and/or X′ is not configured, used, and/or set in a particular manner due to the (aperiodic) nature of the DCI signaling (TCI-DCI and/or UL-DCI/DL-DCI). Here, the UE monitors the presence of TCI-DCI as well as UL-DCI/DL-DCI in each slot/subframe by detecting the presence of the associated IDs (such as C-RNTI or group-RNTI or TCI-RNTI). In this case, the location of the pertinent TCI-DCI can be in any slot relative to the location of the UL-DCI/DL-DCI. The applicability of the TCI state signaled in the TCI-DCI can be determined from its location relative to UL-DCI/DL-DCI, e.g., to ensure sufficient time for decoding the TCI-DCI so that the TCI state is applicable to some following UL-DCI(s)/DL-DCI(s). For example, the UE assumes a minimum TCI state (beam) switching time (in number of slots/subframes or ODFM symbols) from the end of TCI-DCI decoding (i.e., the last symbol carrying TCI-DCI) and the start of UL-TCI/DL-DCI reception (i.e., the first symbol carrying UL-DCI/DL-DCI). In one example, this switching time is reported by the UE in its capability signaling (or is fixed or is configured to the UE).

In any of the previously described and following examples and embodiments associated with X′=0 and/or X=0, the methods can stand alone and, therefore, be implemented without the use of any offset parameter X and/or X′. In other words, any of such examples or embodiments can be utilized without any parameterization of X and/or X′, or setting an offset parameter (such as X and/or X′) to be 0.

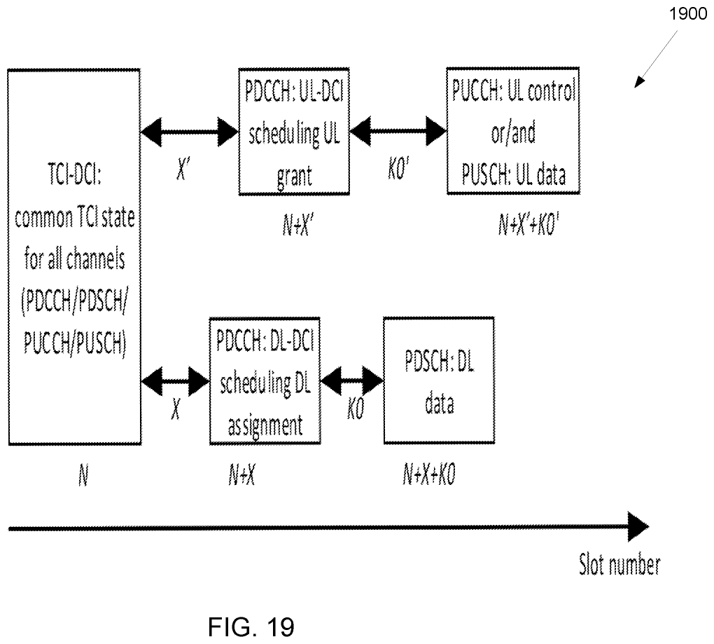

FIG. 19 illustrates an example of receiving TCI-DCI and DL-DCI in the same slot or subframe 1900. The example of receiving TCI-DCI and DL-DCI in the same slot or subframe 1900 illustrated in FIG. 19 is for illustration only. FIG. 19 does not limit the scope of this disclosure to any particular implementation of the example of receiving TCI-DCI and DL-DCI in the same slot or subframe 1900.

In at least one of the above embodiments (or examples), as shown in FIG. 19, when the value of the parameter X=0 and X′>0, i.e., the UE is configured to receive TCI-DCI and DL-DCI in the same slot (or subframe) N. The UE receives/decodes TCI-DCI and DL-DCI in slot (or subframe) N, and obtains the indicated beam (TCI state) from TCI-DCI and scheduling information for the DL assignment from DL-DCI. The UE then receives DL data (PDSCH) according to the DL assignment using the indicated beam in slot N+K₀.

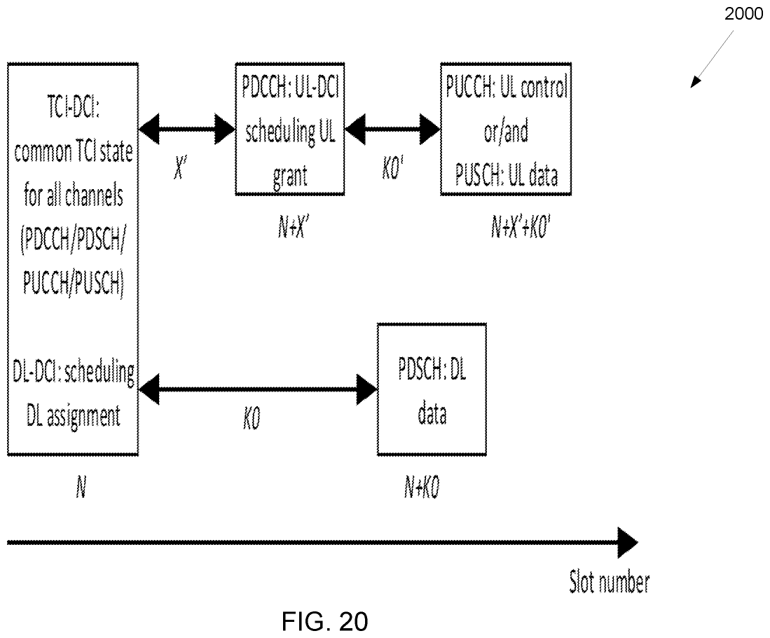

FIG. 20 illustrates an example of receiving TCI-DCI and UL-DCI in the same slot or subframe 2000. The example of receiving TCI-DCI and UL-DCI in the same slot or subframe 2000 illustrated in FIG. 20 is for illustration only. FIG. 20 does not limit the scope of this disclosure to any particular implementation of the example of receiving TCI-DCI and UL-DCI in the same slot or subframe 2000.

In at least one of the above embodiments (or examples), as shown in FIG. 20, when the value of the parameter X′=0 and X>0, i.e., the UE is configured to receive TCI-DCI and UL-DCI in the same slot (or subframe) N. The UE receives/decodes TCI-DCI and UL-DCI in slot (or subframe) N′, and obtains the indicated beam (TCI state) from TCI-DCI and scheduling information for the UL grant from UL-DCI. The UE then transmits UL control (PUCCH) and/or UL data (PUSCH, according to the UL grant) using the indicated beam in slot N′+K.

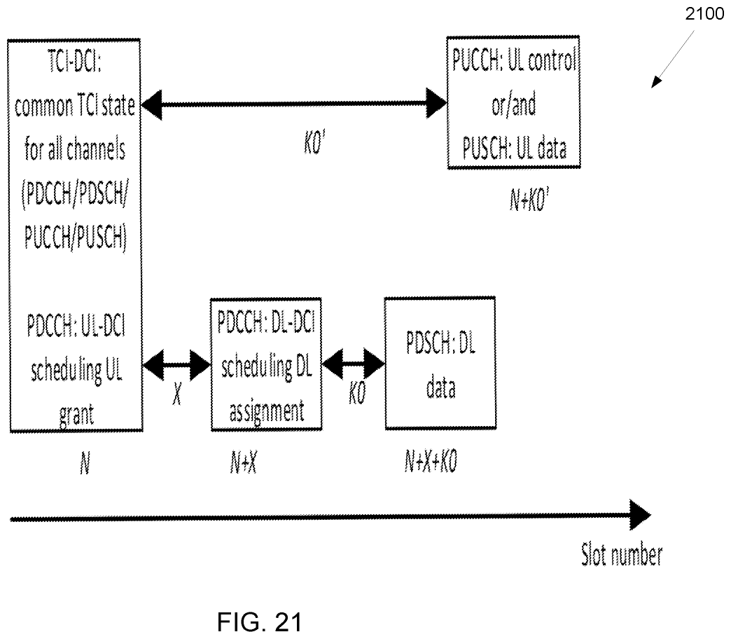

FIG. 21 illustrates an example of receiving TCI-DCI, UL-DCI, and DL-DCI in the same slot or subframe 2100. The example of receiving TCI-DCI, UL-DCI, and DL-DCI in the same slot or subframe 2100 illustrated in FIG. 21 is for illustration only. FIG. 21 does not limit the scope of this disclosure to any particular implementation of the example of receiving TCI-DCI, UL-DCI, and DL-DCI in the same slot or subframe 2100.

In at least one of the above embodiments (or examples), as shown in FIG. 21, when the value of the parameter X=X′=0, i.e., the UE is configured to receive TCI-DCI, UL-DCI, and DL-DCI in the same slot (or subframe) N. The UE receives/decodes TCI-DCI, DL-DCI, and UL-DCI in slot (or subframe) N, and obtains the indicated beam (TCI state) from TCI-DCI, scheduling information for the DL assignment from DL-DCI, and scheduling information for the UL grant from UL-DCI. The UE then receives DL data (PDSCH) according to the DL assignment using the indicated beam in slot N+K₀ and transmits UL control (PUCCH) and/or UL data (PUSCH, according to the UL grant) using the indicated beam in slot N′+K.

In the above three examples, since TCI-DCI and DL-DCI (and/or UL-DCI) are received in the same slot, the UE can't use the beam indicated via TCI-DCI in the current slot for the reception of DL control (PDCCH carrying DL-DCI (and/or UL-DCI)). The beam (or TCI state) to receive TCI-DCI and DL-DCI (and/or UL-DCI) in slot N can be the beam indicated via the latest TCI-DCI in an earlier slot M<N or, optionally, the latest TCI state applicable to the DL-DCI (and/or UL-DCI) signaled via other means. If the latest TCI-DCI is not received or is not configured, then a default beam can be used. For instance, the default beam for PDCCH reception in the 3GPP NR Specification can be used. Alternatively, the beam (or TCI state) to receive TCI-DCI and DL-DCI (and/or UL-DCI) can be the beam to receive a DL channel and/or DL RS in an earlier slot M<N. Alternatively, the beam (or TCI state) to receive TCI-DCI and DL-DCI (and/or UL-DCI) can be associated with the beam to transmit a UL channel and/or UL RS in an earlier slot M<N. Optionally, instead of using a default beam for receiving TCI-DCI and DL-DCI (and/or UL-DCI) in slot N, the beam (or TCI state) for receiving the TCI-DCI can be signaled via MAC CE. For example, the mechanism supported in the 3GPP NR Specification for updating the TCI state of PDCCH can be reused to update the TCI state (beam) for receiving the TCI-DCI.

At least one of the following examples can be applicable when the TCI-DCI and DL-DCI (and/or UL-DCI) are received in the same slot.

In one example IV.8.7, TCI-DCI and DL-DCI (and/or UL-DCI) correspond to (or functionally combined into) a single (joint) DCI including all DCI fields of both TCI-DCI and DL-DCI (and/or UL-DCI). In one example, this joint DCI is labelled as TCI-DCI. In one example, this joint DCI is labelled as DL-DCI (e.g., format 1_0, 1_1, or 1_2 in NR specification). In one example, this joint DCI is labelled as UL-DCI (e.g., format 0_0, 0_1, or 0_2 in NR specification).

In one example, when a UL-DCI is used for common beam indication for both DL and UL, the UL-DCI format can include one or both of common beam (TCI state) and UL grant. At least one of the following examples can be used/configured.
In example IV.8.7.1, the UE decodes the UL-DCI and determines whether only one or both of common beam (TCI state) and UL grant are included. For example, when the TCI state field in the DCI takes a value (e.g., 0), it indicates that the TCI state (or common beam) is not indicated (or being absent). Likewise, when a parameter in the scheduling assignment field in the DCI takes a value (e.g., 0), it indicates that there is no UL grant (absent).
In example IV.8.7.2, the information whether only one or both of common beam (TCI state) and UL grant are included can be configured via RRC or activated via MAC CE.

In one example, when a UL-DCI is used for common beam indication for both DL and UL, the DL-DCI format can include one or both of common beam (TCI state) and DL assignment. At least one of the following examples can be used/configured.
In example IV.8.7.1A, the UE decodes the DL-DCI and determines whether only one or both of common beam (TCI state) and DL assignment are included. For example, when the TCI state field in the DCI takes a value (e.g., 0), it indicates that the TCI state (or common beam) is not indicated (or being absent). Likewise, when a parameter in the scheduling assignment field in the DCI takes a value (e.g., 0), it indicates that there is no DL assignment (absent).
In example IV.8.7.2A, the information whether only one or both of common beam (TCI state) and DL assignment are included can be configured via RRC or activated via MAC CE.

In one example IV.8.8, TCI-DCI can be separate from DL-DCI (and/or UL-DCI), but they are in the same slot. The rest of the details are analogous to example IV.1.8 (and/or IV.4.8).

In any of the previously described and following examples and embodiments associated with X=0, the methods can stand alone and, therefore, be implemented without the use of any offset parameter X. In other words, any of such examples or embodiments can be utilized without any parameterization of X, or setting an offset parameter (such as X) to be 0.

In any of the previously described and following examples and embodiments associated with X′=0, the methods can stand alone and, therefore, be implemented without the use of any offset parameter X′. In other words, any of such examples or embodiments can be utilized without any parameterization of X′, or setting an offset parameter (such as X′) to be 0.

In one embodiment IV.9 a UE can be configured with a higher layer parameter (and/or MAC CE and/or DL-DCI field) to enable the TCI state (beam) indication via TCI-DCI. For example, a UE can be configured to derive its TCI state update from TCI-DCI and/or DL-DCI (and/or UL-DCI) depending on the configuration for TCI-DCI and/or DL-DCI (and/or UL-DCI). The rest of the details are analogous to the corresponding embodiment IV.2 for DL and embodiment IV.5 for UL.

In one example IV.9.1, when the offset parameter X and/or X′ is used or configured, the resulting UE procedure can be dependent on the value of X and/or X′. For example, when X=0, TCI-DCI is absent (not received and/or not configured) (or TCI-DCI and DL-DCI correspond to (or functionally combined into) a single (joint) DCI cf. example IV.1.7) and the TCI state indication/update is present and signaled/received in the DL-DCI (and is used for the reception of DL data); and when X>0, TCI-DCI is present (configured and hence can be received), and the TCI state indication/update is present and signaled/received in the TCI-DCI (and is used for the reception of both DL data associated with the DL assignment in the DL-DCI, and DL control including the DL-DCI). Likewise, for example, when X′=0, TCI-DCI is absent (not received and/or not configured) (or TCI-DCI and UL-DCI correspond to (or functionally combined into) a single (joint) DCI cf. example IV.4.7) and the TCI state indication/update is present and signaled/received in the UL-DCI (and is used for the transmission of UL data); and when X>0, TCI-DCI is present (configured and hence can be received), and the TCI state indication/update is present and signaled/received in the TCI-DCI (and is used for the transmission of UL data and/or UL control).

In one example IV.9.2, regardless of whether the offset parameter X and/or X′ is used/configured or not, the resulting UE procedure can be based on a higher layer (RRC) parameter, e.g., tci-dci-IsPresent. When tci-dci-IsPresent is set to ‘enabled’, TCI-DCI is present (configured and hence can be received), and the TCI state indication/update is TCI state indication/update in the TCI-DCI (and is used for the transmission of UL data and/or UL control, and/or is used for the reception of both DL data and DL control). Otherwise, TCI-DCI is absent (not received and/or not configured) (or TCI-DCI and DL-DCI/UL-DCI correspond to (or functionally combined into) a single (joint) DCI cf. example IV.1.7/IV.4.7) and the TCI state indication/update is present and signaled/received in the UL-DCI (and is used for the transmission of UL data) or DL-DCI (and is used for the reception of DL data).

In one example IV.9.3, regardless of whether the offset parameter X and/or X′ is used/configured or not, and regardless of whether a higher-layer parameter controlling the presence of TCI-DCI (e.g., tci-dci-IsPresent) is used/configured or not, the resulting UE procedure can (also) be based on the higher layer parameter tci-PresentInDCI in PDSCH-Config or PUSCH-Config (which controls the presence of DL-DCI or UL-DCI). For example, when the parameter tci-dci-IsPresent is ‘enabled’ and tci-PresentInDCI is also ‘enabled’, both the TCI-DCI and UL-DCI (and/or DL-DCI) are present (configured and hence can be received). In this case, the TCI state indication/update applicable for decoding the DL-DCI and/or UL-DCI (in the pertinent PDCCH) is signaled/received in the latest (most recent) TCI-DCI while the TCI state indication/update applicable for decoding the assigned DL data in the pertinent PDSCH (associated with the DL assignment in the DL-DCI) is signaled/received in the latest (most recent) DL-DCI; and/or, the TCI state indication/update applicable for transmission of the UL data in the pertinent PUSCH (associated with the UL grant in the UL-DCI) is signaled/received in the latest (most recent) UL-DCI. When the parameter tci-dci-IsPresent is ‘enabled’ and tci-PresentInDCI is not ‘enabled’, TCI-DCI is present (configured and hence can be received), and the TCI state indication/update is TCI state indication/update in the TCI-DCI (and is used for the transmission of both UL data associated with the UL grant in the UL-DCI, and UL control, and/or is used for the reception of both DL data associated with the DL assignment in the DL-DCI, and DL control including the DL-DCI).

In one example IV.9.4, regardless of whether the offset parameter X and/or X′ is used/configured or not, the resulting UE procedure can be based on a higher layer (RRC) parameter and/or MAC CE activation.

In one example IV.9.5, regardless of whether the offset parameter X and/or X′ is used/configured or not, the resulting UE procedure can be based on a system information (i.e., for all UEs in a cell).

In one embodiment IV.10, a UE can be configured with semi-persistent scheduling (SPS) for DL data (PDSCH), and/or configured with configured grant Type 1 or Type 2 PUSCH transmission. The details of SPS for PDSCH reception are according to embodiment IV.3, and that for configured grant Type 1 or Type 2 PUSCH transmission are according to embodiment IV.6.

In one example IV.10.1, a UE is configured to receive a dedicated DCI (TCI-DCI) indicating the common beam (TCI state) for (a) the reception of DL control (PDCCH) and if activated by the received PDCCH, also for the reception of DL data (PDSCH), and/or (b) the transmission of UL control (PUCCH) and/or data (PUSCH) if activated by the received PDCCH (configured grant Type 2 PUSCH). The details for (a) is according to example IV.3.1, and that for (b) is according to 1.6.1.

In one example IV.10.2, a UE is configured to receive a dedicated DCI (TCI-DCI) via PDCCH, which includes the common beam (TCI state) for the reception of PDCCH in later slot(s) and, if activated by the received PDCCH, the common beam is also used for (a) the reception of DL data (PDSCH) scheduled by SPS and/or (b) the transmission of UL data (PUSCH) (for the configured grant Type 2 PUSCH transmission). The details for (a) is according to example IV.3.2, and that for (b) is according to 1.6.2.

In one example IV.10.3, a UE is configured to receive a dedicated DCI (e.g., TCI-DCI) via PDCCH, which includes (a) a field for the common beam (TCI state) and/or (b) another field for the activation/release of PDSCH reception (according to the configured SPS) and/or PUSCH transmission (configured grant Type 2 PUSCH). When PDSCH reception and/or PUSCH transmission is activated by field (b), the UE can be indicated/updated with a new (TCI state) beam for PDSCH reception and/or PUSCH transmission (with or without PDCCH reception) using the field (a). Once PDSCH reception and/or PUSCH transmission is not activated or released by field (b), the UE can be indicated/updated with a new (TCI state) beam for PDCCH reception and/or PUSCH transmission only using the field (a).

In one example IV.10.4, a UE is configured to receive a dedicated DCI (TCI-DCI) indicating the common beam (TCI state) for (a) the reception of DL control (PDCCH) and if activated by the received PDCCH, also for the reception of DL data (PDSCH), and/or (b) the transmission of UL control (PUCCH) and/or data (PUSCH). The details for (a) is according to example IV.3.1. For (b), the UE receives (e.g., a TCI-DCI format) and decodes TCI-DCI in slot (or subframe) N′, and uses the indicated beam (TCI state) to transmit UL control (PUCCH) (e.g., periodic PUCCH or semi-persistent PUCCH) and/or data (PUSCH) (e.g., configured grant Type 1) starting in the same (slot N′) or later slot(s). The details for (b) is according to 1.6.3.

In one example IV.10.5, a UE can be configured to receive a dedicated DCI (TCI-DCI) indicating the common beam (TCI state) for the transmission of PDCCH-triggered contention-free random access (CFRA) preambles, such PDCCH is known as a PDCCH order, which can be a DCI format 1_0 with the “frequency domain resource assignment” field set to all ones as described in TS 38.212. The rest of the details are according to embodiment IV.7, except that the functionality of RACH-TCI-DCI is included in TCI-DCI. Note that in this example, TCI-DCI indicates a common beam for (a) DL control and DL data and/or (b) UL data and UL control and/or (c) PRACH.

In embodiment V, a UE is configured with a beam indication comprising either a joint DL/UL TCI for both DL reception and UL transmission (of control and/or data channels), or two separate TCIs, UL-TCI and DL-TCI, for UL transmission and DL reception, respectively, where the beam indication indicates M beam(s) for DL reception and/or N beam(s) for UL transmission. The definition of DL-TCI, UL-TCI and joint DL/UL TCI are as follows.

For M=1:
DL TCI: The source reference signal(s) (analogous to Rel.15, two, if qcl_Type2 is configured in addition to qcl_Type1) in the DL TCI provides QCL information at least for UE-dedicated reception on PDSCH and all of CORESETs in a CC.

For N=1:
UL TCI: The source reference signal in the UL TCI provides a reference for determining UL TX spatial filter at least for dynamic-grant/configured-grant based PUSCH and all of dedicated PUCCH resources in a CC.

For M=N=1:
Joint DL/UL TCI: A TCI refers to at least a common source reference RS used for determining both the DL QCL information and the UL TX spatial filter.
Separate DL/UL TCI: The DL TCI and UL TCI are distinct (therefore, separate).

For M>1:
DL TCI: Each of the M source reference signals (or 2M, if qcl_Type2 is configured in addition to qcl_Type1) in the M DL TCIs provides QCL information at least for one of the M beam pair links for UE-dedicated receptions on PDSCH and/or subset of CORESETs in a CC.

For N>1:
UL TCI: Each of the N source reference signals in the N UL TCIs provide a reference for determining UL TX spatial filter at least for one of the N beam pair links associated with dynamic-grant(s)/configured-grant(s) based PUSCH, and/or subset of dedicated PUCCH resources in a CC.

For M>1 and/or N>1:
Joint DL/UL TCI: A TCI refers to at least a common source reference RS used for determining both the DL QCL information and the UL TX spatial filter. In this case, M=N.
Separate DL/UL TCI: The M DL TCIs and N UL TCIs are distinct (therefore, separate).

In embodiment V.1, the parameters X and X′ (as described in this disclosure) are determined/configured according to at least one of the following examples.

In one example V.1.1, X=X′, where X=B or X≥B, where B is the beam application time (for DL or UL or a common value for both DL and UL). At least one of the following examples is used/configured.
In one example, X is fixed.
In one example, X is configured via higher layer RRC and/or MAC CE and/or DCI based signaling.
In one example, the value of X is determined (fixed or configured) subject to the beam application time or the minimum BAT value (which can be reported by the UE).

In one example V.1.2, X and X′ can be different, where X=B or X≥B, where B is the beam application time (for DL or a common value for both DL and UL), and likewise X′=B′ or X′≥B′, where B′ is the beam application time (for UL or a common value for both DL and UL). At least one of the following examples is used/configured.
In one example, X and X′ are fixed.
In one example, X′ is determined based on the value of X, where X is either fixed, or configured via higher layer RRC and/or MAC CE and/or DCI based signaling, or the value of X is determined (fixed or configured) subject to the beam application time or the minimum BAT value (which can be reported by the UE). The value of X′ is determined based on the value of X, where the relation between X and X′ can be fixed or determined implicitly (e.g., based on a relation) or explicitly (e.g., based on configuration).
In one example, X is determined based on the value of X′, where X′ is either fixed, or configured via higher layer RRC and/or MAC CE and/or DCI based signaling, or the value of X′ is determined (fixed or configured) subject to the beam application time or the minimum BAT value (which can be reported by the UE). The value of X is determined based on the value of X′, where the relation between X and X′ can be fixed or determined implicitly (e.g., based on a relation) or explicitly (e.g., based on configuration).
In one example, X and X′ are configured (jointly or separately) via higher layer RRC and/or MAC CE and/or DCI based signaling. This configuration can be subject to the beam application time or the minimum BAT value (which can be reported by the UE).

In embodiment V.2, the beam application time for DL reception and UL transmission (of data as well as control channels) is determined/configured according to at least one of the following examples.

In one example V.2.1, a single beam application time B is determined/configured via higher layer RRC and/or MAC CE and/or DCI based signaling. This configuration can be subject to the beam application time or the minimum BAT value reported by the UE in its capability reporting, i.e., the configured value is equal to or greater than the value reported by the UE.

The value B is applied to both X and X′, i.e., X≥B and X′≥B. Hence, the UE uses the new beam indicated via the beam indication DCI (e.g., TCI-DCI or UL-TCI-DCI or DL-TCI-DCI) to receive DL channels and/or to transmit UL channels no earlier than the beam application time B after receiving (the first or last symbol of) the beam indication DCI. This is regardless of whether the beam indication for DL reception and UL transmission (of data as well as control channels) is via a joint DL/UL TCI or two separate TCIs, namely DL-TCI and UL-TCI.

In one example V.2.2, two beam application time values B₁ and B₂ are determined/configured via higher layer RRC and/or MAC CE and/or DCI based signaling. This configuration can be subject to the beam application time or the minimum BAT value reported by the UE in its capability reporting. At least one of the following examples is used/configured.
In one example, the value B₁ is applied for receiving DL channels (PDCCH and PDSCH), and the value B₂ is applied for transmission UL channels (PUCCH and PUSCH).
In one example, the value B₁ is applied for receiving DL control (PDCCH), and the value B₂ is applied for transmission UL control (PUCCH).
In one example, the value B₁ is applied when either (A) the beam indication for DL reception and UL transmission (of data as well as control channels) is via a joint DL/UL TCI or (B) the beam indication for DL reception (of data as well as control channels) is via DL-TCI; and the value B₂ is applied when the beam indication for UL transmission (of data as well as control channels) is via UL-TCI.
In one example, the value B₁ is applied when the beam indication for DL reception and UL transmission (of data as well as control channels) is via a joint DL/UL TCI, and the value B₂ is applied when the beam indication for DL reception and UL transmission (of data as well as control channels) is via two separate TCIs, namely DL-TCI and UL-TCI.
In one example, the value B₁ is applied for receiving DL channels (PDCCH and PDSCH) from and/or transmitting UL channels (PUCCH and PUSCH) to a serving cell, and the value B₂ is applied for receiving DL channels (e.g., PDSCH) from a non-serving cell.
In one example, the value B₁ is applied for receiving DL channels (PDCCH and PDSCH) and/or transmitting UL channels (PUCCH and PUSCH) when the UE doesn't need to change/switch its antenna panel(s), and the value B₂ is applied for receiving DL channels (PDCCH and PDSCH) and/or transmitting UL channels (PUCCH and PUSCH) when the UE needs to change/switch its antenna panel(s).

In one example V.2.3, three beam application time values B₁, B₂, and B₃ are determined/configured via higher layer RRC and/or MAC CE and/or DCI based signaling. This configuration can be subject to the beam application time or the minimum BAT value reported by the UE in its capability reporting. At least one of the following examples is used/configured.
In one example, the value B₁ is applied when the beam indication for DL reception and UL transmission (of data as well as control channels) is via a joint DL/UL TCI, the value B₂ is applied when the beam indication for DL reception (of data as well as control channels) is via DL-TCI, and the value B₃ is applied when the beam indication for UL transmission (of data as well as control channels) is via UL-TCI

In embodiment V.3, the UE reports Z minimum BAT values in its capability reporting. At least one of the following examples is used/configured.

In one example V.3.1, Z=1, i.e., UE reports one minimum BAT value that is common (same) for both DL and UL channels. In one example, such reporting is conditioned on (restricted to) the UE supporting only joint DL/UL TCI for the beam indication (e.g., the UE can report this in its capability reporting). In one example, there is no additional condition or restriction for UE reporting only one minimum BAT value.

In one example V.3.2, Z=2, i.e., the UE reports two different minimum BAT values, one for DL channels and another for UL channels. In one example, such reporting is conditioned on (restricted to) the UE supporting two separate TCIs (DL-TCI and ULTCI) for the beam indication (e.g., the UE can report this in its capability reporting). In one example, there is no additional condition or restriction for UE reporting only two minimum BAT values.

In one example V.3.3, Z=2, i.e., the UE reports two different minimum BAT values, one for joint DL/UL TCI based beam indication, and another for two separate TCIs (DL-TCI and UL-TCI) based beam indication. In one example, such reporting is conditioned on (restricted to) the UE supporting both joint DL/UL TCI and separate TCIs for the beam indication (e.g., the UE can report this in its capability reporting). In one example, there is no additional condition or restriction for UE reporting only one minimum BAT value.

In one example V.3.4, Z=2, i.e., the UE reports two different minimum BAT values, one value for joint DL/UL TCI based beam indication and DL-TCI based beam indication (for DL channels), and another value for UL-TCI based beam indication (for UL channels). In one example, such reporting is conditioned on (restricted to) the UE supporting both joint DL/UL TCI and separate TCIs for the beam indication (e.g., the UE can report this in its capability reporting). In one example, there is no additional condition or restriction for UE reporting only one minimum BAT value.

In one example V.3.5, Z=2, i.e., the UE reports two different minimum BAT values, one value for joint DL/UL TCI based beam indication and UL-TCI based beam indication (for UL channels), and another value for DL-TCI based beam indication (for DL channels). In one example, such reporting is conditioned on (restricted to) the UE supporting both joint DL/UL TCI and separate TCIs for the beam indication (e.g., the UE can report this in its capability reporting). In one example, there is no additional condition or restriction for UE reporting only one minimum BAT value.

In one example V.3.6, Z=3, i.e., the UE reports three different minimum BAT values, a first value for joint DL/UL TCI based beam indication, a second value for DL-TCI based beam indication (for DL channels), and a third value for UL-TCI based beam indication (for UL channels). In one example, such reporting is conditioned on (restricted to) the UE supporting both joint DL/UL TCI and separate TCIs for the beam indication (e.g., the UE can report this in its capability reporting). In one example, there is no additional condition or restriction for UE reporting only one minimum BAT value.

In one example V.3.7, the value of Z depends on the number of antenna port groups, N₉ (or number of panels) at the UE. In one example, Z=N_{g}, i.e., the UE reports one minimum BAT value for each antenna port group (or antenna panel). In one example, Z=2, i.e., the UE reports two minimum BAT values, one value for the case when the UE doesn't need to change its antenna panel(s) for DL reception and/or UL transmission, and another value for the case when the UE needs to change its antenna panel(s) for DL reception and/or UL transmission.

In one example V.3.8, Z=1, i.e., the UE reports one different minimum BAT value, for the case when the beam indication is via joint DL-UL TCI, and Z=2, i.e., the UE reports two different minimum BAT values, for the case when the beam indication is via separate TCIs (DL-TCI and UL-TCI). In one example, such reporting depends on whether the UE supports the joint DL/UL TCI or two separate TCIs or both. For example, Z=1 when the UE supports only joint DL/UL TCI or only separate TCIs, and Z=2 when the UE supports both.

In one example V.3.9, Z=2, i.e., the UE reports two different minimum BAT values, one value for receiving DL channels (PDCCH and PDSCH) from and/or transmitting UL channels (PUCCH and PUSCH) to a serving cell, and another value for receiving DL channels (e.g., PDSCH) from a non-serving cell.

In this disclosure, examples embodiments for determining the beam application time (BAT) value(s) for the case of multiple component carriers (CCs) and/or multiple subcarrier spacings (SCSs) are provided.

In Rel. 15 NR, the subcarrier spacing (SCS), denoted as μ, is configured from a set of values {0, 1, 2, 3, 4} that corresponds to {15, 30, 60, 120, 240} KHz SCS, respectively. The details about the SCS configuration is according to [Section 4.3.2, REF6], which is copied below.

For subcarrier spacing configuration μ, slots are numbered nₛ^{μ}∈{0, . . . Nₛₗₒₜ^{subframe,μ}−1} in increasing order within a subframe and n_{s,f}^{μ}∈{0, . . . , Nₛₗₒₜ^{subframe,μ}−1} in increasing order within a frame. There are N_{symb}^{slot} consecutive OFDM symbols in a slot where N_{symb}^{slot} depends on the cyclic prefix as given by Table 2 and Table 3. The start of slot nₛ^{μ} in a subframe is aligned in time with the start of OFDM symbol nₛ^{μ}N_{symb}^{slot} in the same subframe.

TABLE 2
Number of OFDM symbols per slot, slots per frame,
and slots per subframe for normal cyclic prefix

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3
Number of OFDM symbols per slot, slots per frame,
and slots per subframe for extended cyclic prefix

| μ | N_{symb}^{slot} | Nₛₗₒₜ^{frame, μ} | Nₛₗₒₜ^{subframe, μ} |
|---|---|---|---|
| 2 | 12 | 40 | 4 |

In one embodiment V.4, the beam application time (cf. embodiment V.2 and/or V.3) depends on the sub-carrier spacing (SCS) configured to the UE. Let the SCS of the channel conveying the beam indication (via DCI or MAC CE) be μ_{TCI}, the SCS of the UL channel(s) (in active/indicated UL BWP) the beam indication applies to be μ_{UL}, and the SCS of the DL channel(s) (in active/indicated DL BWP) the beam indication applies to be μ_{DL}. At least one of the following examples is used/configured.

In one example V.4.1, when μ_{TCI}=μ_{DL}=μ_{UL} (same numerology/SCS case), one or multiple BAT values are determined/configured (and/or reported by the UE) according to at least one example or a combination of examples in embodiment V.2 and/or V.3.

In one example V.4.2, when μ_{TCI}≠μ_{DL}=μ_{UL} (mixed numerology/SCS case), then at least one of the following examples is used/configured.
In one example, one or multiple BAT values are determined/configured and/or reported by the UE (according to at least one example or a combination of examples in embodiment V.2 and/or V.3), and they are applied regardless of the same/mixed numerologies. The one or multiple BAT values can be defined in the numerology μ_{TCI}. Or, the one or multiple BAT values can be defined in the numerology μ_{DL}.
In one example, one or multiple BAT values are determined/configured and/or reported by the UE (according to at least one example or a combination of examples in embodiment V.2 and/or V.3) for the numerology μ_{TCI}, and the one or multiple BAT values are scaled for the numerology μ_{DL}=μ_{UL}. In one example, the scaling factor is given by

$$\frac{{2}^{{μ}_{DL}}}{{2}^{{μ}_{TCI}}} or ⌈ \frac{{2}^{{μ}_{DL}}}{{2}^{{μ}_{TCI}}} ⌉ or ⌈ \frac{{2}^{{μ}_{DL}}}{{2}^{{μ}_{TCI}}} ⌉ .$$

In one example, one or multiple BAT values are determined/configured and/or reported by the UE (according to at least one example or a combination of examples in embodiment V.2 and/or V.3) for the numerology μ_{TCI} and an additional (processing) delay is added for the numerology μ_{DL}=μ_{UL}. That is, for the numerology μ_{DL}=μ_{UL}, the BAT value is given by U+d×S, where U is the one or multiple BAT values, the scaling factor S is given by

$$\frac{{2}^{{μ}_{DL}}}{{2}^{{μ}_{TCI}}} or ⌈ \frac{{2}^{{μ}_{DL}}}{{2}^{{μ}_{TCI}}} ⌉ or ⌈ \frac{{2}^{{μ}_{DL}}}{{2}^{{μ}_{TCI}}} ⌉ ,$$

and the additional (processing) delay d can be fixed (e.g., 10 OFDM symbols) or depends on the SCS, e.g., Table 4 where μ=_{TCI} or μ=μ_{DL} or can be configured (e.g., via RRC). In one example, if the μ_{TCI}<μ_{DL}, d is defined in Table 4, else d is zero.
In one example, one or multiple BAT values are determined/configured and/or reported by the UE (according to at least one example or a combination of examples in embodiment V.2 and/or V.3) for the numerology μ_{DL}=μ_{UL}, and the one or multiple BAT values are scaled for the numerology μ_{TCI}. In one example, the scaling factor is given by

$$\frac{{2}^{{μ}_{TCI}}}{{2}^{{μ}_{DL}}} or ⌈ \frac{{2}^{{μ}_{TCI}}}{{2}^{{μ}_{DL}}} ⌉ or ⌈ \frac{{2}^{{μ}_{TCI}}}{{2}^{{μ}_{DL}}} ⌉ .$$

In one example, one or multiple BAT values are determined/configured and/or reported by the UE (according to at least one example or a combination of examples in embodiment V.2 and/or V.3) for the numerology μ_{DL}=μ_{UL}, and an additional (processing) delay is added for the numerology μ_{TCI}. That is, for the numerology μ_{TCI}, the BAT value is given by U+d×S, where U is the configured/determined one or multiple BAT values, the scaling factor S is given by

$$\frac{{2}^{{μ}_{TCI}}}{{2}^{{μ}_{DL}}} or ⌈ \frac{{2}^{{μ}_{TCI}}}{{2}^{{μ}_{DL}}} ⌉ or ⌈ \frac{{2}^{{μ}_{TCI}}}{{2}^{{μ}_{DL}}} ⌉ ,$$

and the additional (processing) delay d can be fixed (e.g., 10 OFDM symbols) or depends on the SCS, e.g., Table 4 where μ=_{TCI} or μ=μ_{DL}, or can be configured (e.g., via RRC). In one example, if the μ_{DL}<μ_{TCI}, d is defined in Table 4, else d is zero.
In one example, a first set comprising one or multiple BAT values are determined/configured and/or reported by the UE (according to at least one example or a combination of examples in embodiment V.2 and/or V.3) for the numerology μ_{TCI}, and a second set comprising one or multiple BAT values are determined/configured and/or reported by the UE (according to at least one example or a combination of examples in embodiment V.2 and/or V.3) for the numerology μ_{DL}=μ_{UL}.
In one example, one or multiple BAT values are determined/configured (according to at least one example or a combination of examples in embodiment V.2 and/or V.3) for the numerology μ_{TCI} where the unit of the BAT value in terms of number of time slots, and an additional (processing) delay is added for the numerology μ_{DL}=μ_{UL} (also in terms of number of time slots). That is, for the numerology μ_{DL}=μ_{UL}, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{{μ}_{DL}}}{{2}^{{μ}_{TCI}}} or ⌈ n \times \frac{{2}^{{μ}_{DL}}}{{2}^{{μ}_{TCI}}} ⌉ or ⌈ n \times \frac{{2}^{{μ}_{DL}}}{{2}^{{μ}_{TCI}}} ⌉ ,$$

where n is the slot (index) containing the beam indication channel, or can be configured (e.g., via RRC).
In one example, one or multiple BAT values are determined/configured (according to at least one example or a combination of examples in embodiment V.2 and/or V.3) for the numerology μ_{TCI}, where the unit of the BAT value in terms of number of time slots, and an additional (processing) delay is added for the numerology μ_{DL}=μ_{UL} (also in terms of number of time slots). That is, for the numerology μ_{DL}=μ_{UL}, the BAT value is given by U+D+E, where U and D are as in previous example, and

$$E = ⌊ ( \frac{{N}_{slot , offset , TCI}^{CA}}{{2}^{{μ}_{offset , TCI}}} - \frac{{N}_{slot , offset , DL}^{CA}}{{2}^{{μ}_{offset , DL}}} ) \cdot {2}^{{μ}_{DL}} ⌋$$

if UE is configured with ca-SlotOffset for at least one of the triggered and triggering cell, and E=0, otherwise, and where N_{slot,offset,TCI}^{CA} and μ_{offset,TCI} are the N_{slot,offset}^{CA} and the μ_{offset}, respectively, which are determined by higher-layer configured ca-SlotOffset for the cell transmitting the beam indication channel, N_{slot,offset,DL}^{CA} and μ_{offset,DL} are the N_{slot,offset}^{CA} and the μ_{offset}, respectively, which are determined by higher-layer configured ca-SlotOffset for the cell transmitting the DL channels or receiving the UL channels respectively, as defined in [4, REF6] clause 4.5.
In one example, one or multiple BAT values are determined/configured (according to at least one example or a combination of examples in embodiment V.2 and/or V.3) for the numerology μ_{DL}=μ_{UL}, where the unit of the BAT value in terms of number of time slots, and an additional (processing) delay is added for the numerology μ_{TCI} (also in terms of number of time slots). That is, for the numerology μ_{TCI}, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{{μ}_{TCI}}}{{2}^{{μ}_{DL}}} or ⌈ n \times \frac{{2}^{{μ}_{TCI}}}{{2}^{{μ}_{DL}}} ⌉ or ⌈ n \times \frac{{2}^{{μ}_{TCI}}}{{2}^{{μ}_{DL}}} ⌉ ,$$

where n is the slot (index) containing the beam indication channel, or can be configured (e.g., via RRC).
In one example, one or multiple BAT values are determined/configured (according to at least one example or a combination of examples in embodiment V.2 and/or V.3) for the numerology μ_{DL}=μ_{UL}, where the unit of the BAT value in terms of number of time slots, and an additional (processing) delay is added for the numerology μ_{TCI} (also in terms of number of time slots). That is, for the numerology μ_{TCI}, the BAT value is given by U+D+E, where U and D are as in previous example, and

$$E = ⌊ ( \frac{{N}_{slot , offset , DL}^{CA}}{{2}^{{μ}_{offset , DL}}} - \frac{{N}_{slot , offset , TCI}^{CA}}{{2}^{{μ}_{offset , TCI}}} ) \cdot {2}^{{μ}_{TCI}} ⌋$$

if UE is configured with ca-SlotOffset for at least one of the triggered and triggering cell, and E=0, otherwise, and where N_{slot,offset,TCI}^{CA} and μ_{offset,TCI} are the N_{slot,offset}^{CA} and the μ_{offset}, respectively, which are determined by higher-layer configured ca-SlotOffset for the cell transmitting the beam indication channel, N_{slot,offset,DL}^{CA} and μ_{offset,DL} are the N_{slot,offset}^{CA} and the μ_{offset}, respectively, which are determined by higher-layer configured ca-SlotOffset for the cell transmitting the DL channels or receiving the UL channels respectively, as defined in [4, REF6] clause 4.5.

TABLE 4
Additional Beam Switching Timing Delay d

| μ | d [symbols] |
|---|---|
| 0 | 8 |
| 1 | 8 |
| 2 | 14 |
| 3 | 14 |

In one example V.4.3, when μ_{DL}≠μ_{UL}=μ_{TCI} (mixed numerology/SCS case), then at least one of the examples in example V.4.1 is used/configured except that the term/notation μ_{TCI} and μ_{DL}=μ_{UL} are replaced with μ_{DL} and μ_{UL}=μ_{TCI} respectively in all examples.

In one example V.4.4, when μ_{UL}·μ_{DL}=μ_{TCI} (mixed numerology/SCS case), then at least one of the examples in example V.4.1 is used/configured except that the term/notation μ_{TCI} and μ_{DL}=μ_{UL} are replaced with μ_{UL} and μ_{DL}=μ_{TCI}, respectively in all examples.

In one example V.4.5, when μ_{TCI}≠μ_{DL}≠μ_{DL} (mixed numerology/SCS case), then at least one of the following examples is used/configured.
In one example, one or multiple BAT values are determined/configured and/or reported by the UE (according to at least one example or a combination of examples in embodiment V.2 and/or V.3), and they are applied regardless of the same/mixed numerologies. The one or multiple BAT values can be defined in the numerology μ_{TCI}. Or, the one or multiple BAT values can be defined in the numerology μ_{DL}. Or, the one or multiple BAT values can be defined in the numerology μ_{UL}.
In one example, a first set comprising one or multiple BAT values are determined/configured and/or reported by the UE (according to at least one example or a combination of examples in embodiment V.2 and/or V.3) for the numerology μ_{TCI}, a second set comprising one or multiple BAT values are determined/configured and/or reported by the UE (according to at least one example or a combination of examples in embodiment V.2 and/or V.3) for the numerology μ_{UL}, and a third set comprising one or multiple BAT values are determined/configured and/or reported by the UE (according to at least one example or a combination of examples in embodiment V.2 and/or V.3) for the numerology μ_{UL}.
In one example, one or multiple BAT values are determined/configured and/or reported by the UE (according to at least one example or a combination of examples in embodiment V.2 and/or V.3) for the numerology μ₁, and the one or multiple BAT values are scaled for the numerologies μ₂ and μ₃. In one example, the scaling factor is given by

$$\frac{{2}^{μ′}}{{2}^{{μ}_{1}}} or ⌈ \frac{{2}^{μ′}}{{2}^{{μ}_{1}}} ⌉ or ⌈ \frac{{2}^{μ′}}{{2}^{{μ}_{1}}} ⌉ ,$$

where and μ′=μ₂ or μ₃. In one example, (μ₁, μ₂,μ₃)=(μ_{TCI},μ_{DL},μ_{UL}). In one example, (μ₁,μ₂,μ₃)=(μ_{UL},μ_{DL},μ_{TCI}). In one example, (μ₁,μ₂,μ₃)=(μ_{DL},μ_{TCI},μ_{UL}).
In one example, one or multiple BAT values are determined/configured and/or reported by the UE and/or reported by the UE (according to at least one example or a combination of examples in embodiment V.2 and/or V.3) for the numerology μ₁, and an additional (processing) delay is added for the numerologies μ₂ and μ₃. That is, for the numerology μ′=μ₂ or μ₃, the BAT value is given by U+d×S, where U is the configured/determined one or multiple BAT values, the scaling factor S is given by

$$\frac{{2}^{μ′}}{{2}^{{μ}_{1}}} or ⌈ \frac{{2}^{μ′}}{{2}^{{μ}_{1}}} ⌉ or ⌈ \frac{{2}^{μ′}}{{2}^{{μ}_{1}}} ⌉ ,$$

and the additional (processing) delay d can be fixed (e.g., 10 OFDM symbols) or depends on the SCS, e.g., Table 4 where μ=μ₁ or μ=μ′, or can be configured (e.g., via RRC). In one example, (μ₁,μ₂,μ₃)=(μ_{TCI},μ_{DL},μ_{UL}). In one example, (μ₁,μ₂,μ₃)=(μ_{UL},μ_{DL},μ_{TCI}). In one example, (μ₁,μ₂,μ₃)=(μ_{DL},μ_{TCI},μ_{UL}). In one example, if the μ₁<μ′. d is defined in Table 4, else d is zero.
In one example, one or multiple BAT values are determined/configured (according to at least one example or a combination of examples in embodiment V.2 and/or V.3) for the numerology μ₁, where the unit of the BAT value in terms of number of time slots, and an additional (processing) delay is added for the numerologies μ₂ and μ₃ (also in terms of number of time slots). That is, for the numerology μ′=μ₂ or μ₃, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{μ′}}{{2}^{{μ}_{1}}} or ⌈ n \times \frac{{2}^{μ′}}{{2}^{{μ}_{1}}} ⌉ or ⌈ n \times \frac{{2}^{μ′}}{{2}^{{μ}_{1}}} ⌉ ,$$

where n is the slot (index) containing the channel corresponding to numerology μ₁, or can be configured (e.g., via RRC). In one example, (μ₁,μ₂,μ₃)=(μ_{TCI},μ_{DL},μ_{UL}). In one example, (μ₁,μ₂,μ₃)=(μ_{UL},μ_{UL},μ_{TCI}). In one example, (μ₁,μ₂,μ₃)=(μ_{DL},μ_{TCI},μ_{UL}).
In one example, one or multiple BAT values are determined/configured (according to at least one example or a combination of examples in embodiment V.2 and/or V.3) for the numerology μ₁, where the unit of the BAT value in terms of number of time slots, and an additional (processing) delay is added for the numerologies μ₂ and μ₃ (also in terms of number of time slots). That is, for the numerology μ′=μ₂ or μ₃, the BAT value is given by U+D+E, where U and D are as in previous example, and

$$E = ⌊ ( \frac{{N}_{slot , offset , 1}^{CA}}{{2}^{{μ}_{offset , 1}}} - \frac{{N}_{slot , offset , μ′}^{CA}}{{2}^{{μ}_{offset , μ′}}} ) \cdot {2}^{μ′} ⌋$$

if UE is configured with ca-SlotOffset for at least one of the triggered and triggering cell, and E=0, otherwise, and where N_{slot,offset,1}^{CA} and μ_{offset,1} are the N_{slot,offset}^{CA} and the μ_{offset}, respectively, which are determined by higher-layer configured ca-SlotOffset for the cell transmitting the channel corresponding to numerology μ₁, N_{slot,offset,μ′}^{CA} and 2^{μ}^{_{offset,μ′}} are the N_{slot,offset}^{CA} and the μ_{offset}, respectively, which are determined by higher-layer configured ca-SlotOffset for the cell transmitting the channels corresponding to numerology μ′, as defined in [4, REF6] clause 4.5. In one example, (μ₁,μ₂,μ₃)=(μ_{TCI},μ_{DL},μ_{UL}). In one example, (μ₁,μ₂,μ₃)=(μ_{UL},μ_{DL},μ_{TCI}). In one example, (μ₁,μ₂,μ₃)=(μ_{DL},μ_{TCI},μ_{UL})

In one example V.4.6, one or multiple BAT values are determined/configured and/or reported by the UE (according to at least one example or a combination of examples in embodiment V.2 and/or V.3) for each numerology. For two different numerologies, the UE applies either a minimum or a maximum of the two BAT values associated with the two different numerologies.

In one embodiment V.5, the beam application time (cf. embodiment V.2 and/or V.3) depends on the component carriers (CCs) configured to the UE. Let the CC of the channel conveying the beam indication (via DCI or MAC CE) be CC_{TCI}, the CC of the UL channel(s) (in active/indicated UL BWP) the beam indication applies to be CC_{UL}, and the CC of the DL channel(s) (in active/indicated DL BWP) the beam indication applies to be CC_{DL}. At least one of the following examples is used/configured.

In one example V.5.1, when CC_{TCI}=CC_{DL}=CC_{UL} (same CC case), one or multiple BAT values are determined/configured (and/or reported by the UE) according to at least one example or a combination of examples in embodiment V.2 and/or V.3.

In example V.5.2, when CC_{TCI}≠CC_{DL}=CC_{UL} (different CC case), then at least one of the following examples is used/configured.
In one example, one or multiple BAT values are determined/configured (according to at least one example or a combination of examples in embodiment V.2 and/or V.3), and they are applied regardless of the CCs. The one or multiple BAT values can be defined in the numerology of CC_{TCI}. Or, the one or multiple BAT values can be defined in the numerology of CC_{DL}.
In one example, one or multiple BAT values are determined/configured (according to at least one example or a combination of examples in embodiment V.2 and/or V.3) for CC_{TCI}, and the one or multiple BAT values are scaled for CC_{DL}=CC_{UL}. In one example, the scaling factor is given by

$$\frac{{2}^{{μ}_{DL}}}{{2}^{{μ}_{TCI}}} or ⌈ \frac{{2}^{{μ}_{DL}}}{{2}^{{μ}_{TCI}}} ⌉ or ⌈ \frac{{2}^{{μ}_{DL}}}{{2}^{{μ}_{TCI}}} ⌉$$

where μ_{DL} and μₘ are SCSs for CC_{DL} and CC_{TCI}, respectively.
In one example, one or multiple BAT values are determined/configured (according to at least one example or a combination of examples in embodiment V.2 and/or V.3) for CC_{TCI}, and an additional (processing) delay is added for CC_{DL}=CC_{UL}. That is, for CC_{DL}=CC_{UL}, the BAT value is given by U+d×S, where U is the one or multiple BAT values, the scaling factor S is given by

$$\frac{{2}^{{μ}_{DL}}}{{2}^{{μ}_{TCI}}} or ⌈ \frac{{2}^{{μ}_{DL}}}{{2}^{{μ}_{TCI}}} ⌉ or ⌈ \frac{{2}^{{μ}_{DL}}}{{2}^{{μ}_{TCI}}} ⌉ ,$$

and the additional (processing) delay d can be fixed (e.g., 10 OFDM symbols) or depends on the SCS, e.g., Table 4 where μ=μ_{TCI} or μ=μ_{DL}, or can be configured (e.g., via RRC). In one example, if the μ_{TCI}<μ_{DL}, d is defined in Table 4, else d is zero.
In one example, one or multiple BAT values are determined/configured (according to at least one example or a combination of examples in embodiment V.2 and/or V.3) for CC_{DL}=CC_{UL}, and the one or multiple BAT values are scaled for CC_{TCI}. In one example, the scaling factor is given by

$$\frac{{2}^{{μ}_{TCI}}}{{2}^{{μ}_{DL}}} or ⌈ \frac{{2}^{{μ}_{TCI}}}{{2}^{{μ}_{DL}}} ⌉ or ⌈ \frac{{2}^{{μ}_{TCI}}}{{2}^{{μ}_{DL}}} ⌉ .$$

In one example, one or multiple BAT values are determined/configured (according to at least one example or a combination of examples in embodiment V.2 and/or V.3) for CC_{DL}=CC_{UL}, and an additional (processing) delay is added for CC_{TCI}. That is, for CC_{TCI}, the BAT value is given by U+d×S, where U is the configured/determined one or multiple BAT values, the scaling factor S is given by

$$\frac{{2}^{{μ}_{TCI}}}{{2}^{{μ}_{DL}}} or ⌈ \frac{{2}^{{μ}_{TCI}}}{{2}^{{μ}_{DL}}} ⌉ or ⌈ \frac{{2}^{{μ}_{TCI}}}{{2}^{{μ}_{DL}}} ⌉ ,$$

and the additional (processing) delay d can be fixed (e.g., 10 OFDM symbols) or depends on the SCS, e.g., Table 4 where μ=T_{TCI} or μ=μ_{DL}, or can be configured (e.g., via RRC). In one example, if the μ_{DL}<μ_{TCI}, d is defined in Table 4, else d is zero.
In one example, a first set comprising one or multiple BAT values are determined/configured (according to at least one example or a combination of examples in embodiment V.2 and/or V.3) for CC_{TCI}, and a second set comprising one or multiple BAT values are determined/configured (according to at least one example or a combination of examples in embodiment V.2 and/or V.3) for CC_{DL}=CC_{UL}.
In one example, one or multiple BAT values are determined/configured (according to at least one example or a combination of examples in embodiment V.2 and/or V.3) for CC_{TCI}, where the unit of the BAT value in terms of number of time slots, and an additional (processing) delay is added for CC_{DL}=CC_{UL} (also in terms of number of time slots). That is, for CC_{DL}=CC_{UL}, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{{μ}_{DL}}}{{2}^{{μ}_{TCI}}} or ⌈ n \times \frac{{2}^{{μ}_{DL}}}{{2}^{{μ}_{TCI}}} ⌉ or ⌈ n \times \frac{{2}^{{μ}_{DL}}}{{2}^{{μ}_{TCI}}} ⌉ ,$$

where n is the slot (index) containing the beam indication channel, or can be configured (e.g., via RRC).
In one example, one or multiple BAT values are determined/configured (according to at least one example or a combination of examples in embodiment V.2 and/or V.3) for CC_{TCI}, where the unit of the BAT value in terms of number of time slots, and an additional (processing) delay is added for CC_{DL}=CC_{UL} (also in terms of number of time slots). That is, for CC_{DL}=CC_{UL}, the BAT value is given by U+D+E, where U and D are as in previous example, and

$$E = ⌊ ( \frac{{N}_{slot , offset , TCI}^{CA}}{{2}^{{μ}_{offset , TCI}}} - \frac{{N}_{slot , offset , DL}^{CA}}{{2}^{{μ}_{offset , DL}}} ) \cdot {2}^{{μ}_{DL}} ⌋$$

if UE is configured with ca-SlotOffset for at least one of the triggered and triggering cell, and E=0, otherwise, and where N_{slot,offset,TCI}^{CA} and μ_{offset,TCI} are the N_{slot,offset}^{CA} and the μ_{offset}, respectively, which are determined by higher-layer configured ca-SlotOffset for the cell transmitting the beam indication channel, N_{slot,offset,DL}^{CA} and μ_{offset,DL} are the N_{slot,offset}^{CA} and the μ_{offset}, respectively, which are determined by higher-layer configured ca-SlotOffset for the cell transmitting the DL channels or receiving the UL channels respectively, as defined in [4, REF6] clause 4.5.
In one example, one or multiple BAT values are determined/configured (according to at least one example or a combination of examples in embodiment V.2 and/or V.3) for CC_{DL}=CC_{UL}, where the unit of the BAT value in terms of number of time slots, and an additional (processing) delay is added for CC_{TCI} (also in terms of number of time slots). That is, for CC_{TCI}, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{{μ}_{TCI}}}{{2}^{{μ}_{DL}}} or ⌈ n \times \frac{{2}^{{μ}_{TCI}}}{{2}^{{μ}_{DL}}} ⌉ or ⌈ n \times \frac{{2}^{{μ}_{TCI}}}{{2}^{{μ}_{DL}}} ⌉ ,$$

where n is the slot (index) containing the beam indication channel, or can be configured (e.g., via RRC).
In one example, one or multiple BAT values are determined/configured (according to at least one example or a combination of examples in embodiment V.2 and/or V.3) for CC_{DL}=CC_{UL}, where the unit of the BAT value in terms of number of time slots, and an additional (processing) delay is added for CC_{TCI} (also in terms of number of time slots). That is, for CC_{TCI}, the BAT value is given by U+D+E, where U and D are as in previous example, and

$$E = ⌊ ( \frac{{N}_{slot , offset , DL}^{CA}}{{2}^{{μ}_{offset , DL}}} - \frac{{N}_{slot , offset , TCI}^{CA}}{{2}^{{μ}_{offset , TCI}}} ) \cdot {2}^{{μ}_{TCI}} ⌋$$

if UE is configured with ca-SlotOffset for at least one of the triggered and triggering cell, and E=0, otherwise, and where N_{slot,offset,TCI}^{CA} and μ_{offset,TCI} are the N_{slot,offset}^{CA} and the μ_{offset}, respectively, which are determined by higher-layer configured ca-SlotOffset for the cell transmitting the beam indication channel, N_{slot,offset,DL}^{CA} and μ_{offset,DL} are the N_{slot,offset}^{CA} and the μ_{offset}, respectively, which are determined by higher-layer configured ca-SlotOffset for the cell transmitting the DL channels or receiving the UL channels respectively, as defined in [4, REF6] clause 4.5.

In one example V.5.3, when CC≠CC_{UL}=CC_{TCI} (different CC case), then at least one of the examples in example V.5.1 is used/configured except that the term/notation CC_{TCI} and CC_{DL}=CC_{UL} are replaced with CC_{DL} and CC_{UL}=CC_{TCI}, respectively in all examples.

In one example V.5.4, when CC_{UL}≠CC_{DL}=CC_{TCI} (different CC case), then at least one of the examples in example V.5.1 is used/configured except that the term/notation CC_{TCI} and CC_{DL}=CC_{UL} are replaced with CC_{UL} and CC_{DL}=CC_{TCI}, respectively in all examples.

In one example V.5.5, when CC_{TCI}≠CC_{DL}≠CC_{UL} (different CC case), then at least one of the following examples is used/configured.
In one example, one or multiple BAT values are determined/configured (according to at least one example or a combination of examples in embodiment V.2 and/or V.3), and they are applied regardless of the same/mixed numerologies. The one or multiple BAT values can be defined in the numerology CC_{TCI}. Or, the one or multiple BAT values can be defined in the numerology CC_{DL}. Or, the one or multiple BAT values can be defined in the numerology CC_{UL}.
In one example, a first set comprising one or multiple BAT values are determined/configured (according to at least one example or a combination of examples in embodiment V.2 and/or V.3) for the numerology CC_{TCI}, a second set comprising one or multiple BAT values are determined/configured (according to at least one example or a combination of examples in embodiment V.2 and/or V.3) for the numerology CC_{DL}, and a third set comprising one or multiple BAT values are determined/configured (according to at least one example or a combination of examples in embodiment V.2 and/or V.3) for the numerology CC_{UL}.
In one example, one or multiple BAT values are determined/configured (according to at least one example or a combination of examples in embodiment V.2 and/or V.3) for CC₁, and the one or multiple BAT values are scaled for CCs CC₂ and CC₃. In one example, the scaling factor is given by

$$\frac{{2}^{μ′}}{{2}^{{μ}_{1}}} or ⌈ \frac{{2}^{μ′}}{{2}^{{μ}_{1}}} ⌉ or ⌈ \frac{{2}^{μ′}}{{2}^{{μ}_{1}}} ⌉ ,$$

where and μ′ is the SCS for CC₂ or CC₃, and μ₁ is the SCS for CC₁. In one example, (CC₁, CC₂, CC₃) (CC_{TCI}, CC_{DL}, CC_{UL}). In one example, (CC₁, CC₂, CC₃)=(CC_{UL}, CC_{DL}, CC_{TCI}). In one example, (CC₁, CC₂, CC₃)=(CC_{DL}, CC_{TCI}, CC_{UL}).
In one example, one or multiple BAT values are determined/configured (according to at least one example or a combination of examples in embodiment V.2 and/or V.3) for CC₁, and an additional (processing) delay is added for CCs CC₂ and CC₃. That is, for CC₂ or CC₃, the BAT value is given by U+d×S, where U is the configured/determined one or multiple BAT values, the scaling factor S is given by

$$\frac{{2}^{μ′}}{{2}^{{μ}_{1}}} or ⌈ \frac{{2}^{μ′}}{{2}^{{μ}_{1}}} ⌉ or ⌈ \frac{{2}^{μ′}}{{2}^{{μ}_{1}}} ⌉ ,$$

where μ′ is the SCS for CC₂ or CC₃, and μ₁ is the SCS for CC₁, and the additional (processing) delay d can be fixed (e.g., 10 OFDM symbols) or depends on the SCS, e.g., Table 4 where μ=μ₁ or μ=μ′, or can be configured (e.g., via RRC). In one example, (CC₁, CC₂, CC₃)=(CC_{TCI}, CC_{DL}, CC_{UL}). In one example, (CC₁, CC₂, CC₃)=(CC_{UL}, CC_{DL}, CC_{TCI}). In one example, (CC₁, CC₂, CC₃)=(CC_{DL}, CC_{TCI}, CC_{UL}). In one example, if the μ₁<μ′, d is defined in Table 4, else d is zero.
In one example, one or multiple BAT values are determined/configured (according to at least one example or a combination of examples in embodiment V.2 and/or V.3) for CC₁ with SCS μ₁, where the unit of the BAT value in terms of number of time slots, and an additional (processing) delay is added for CC₂ and CC₃ (also in terms of number of time slots). That is, for CC₂ and CC₃, the BAT value is given by U+D, where U is the one or multiple BAT values (in terms of number of time slots), and the additional (processing) delay D can be fixed (e.g., 1 time slot) or depends on the SCS, e.g.,

$$D = n \times \frac{{2}^{μ′}}{{2}^{{μ}_{1}}} or ⌈ n \times \frac{{2}^{μ′}}{{2}^{{μ}_{1}}} ⌉ or ⌈ n \times \frac{{2}^{μ′}}{{2}^{{μ}_{1}}} ⌉ ,$$

where μ′ is the SCS for CC₂ or CC₃, n is the slot (index) containing the channel corresponding to numerology μ₁, or can be configured (e.g., via RRC). In one example, (CC₁, CC₂, CC₃)=(CC_{TCI}, CC_{DL}, CC_{UL}). In one example, (CC₁, CC₂, CC₃)=(CC_{UL}, CC_{DL}, CC_{TCI}). In one example, (CC₁, CC₂, CC₃)=(CC_{DL}, CC_{TCI} CC_{UL}).
In one example, one or multiple BAT values are determined/configured (according to at least one example or a combination of examples in embodiment V.2 and/or V.3) for CC₁ with SCS where the unit of the BAT value in terms of number of time slots, and an additional (processing) delay is added for CC₂ and CC₃ (also in terms of number of time slots). That is, for CC₂ and CC₃, the BAT value is given by U+D+E, where U and D are as in previous example, and

$$E = ⌊ ( \frac{{N}_{slot , offset , 1}^{CA}}{{2}^{{μ}_{offset , 1}}} - \frac{{N}_{slot , offset , μ′}^{CA}}{{2}^{{μ}_{offset , μ′}}} ) \cdot {2}^{μ′} ⌋$$

if UE is configured with ca-SlotOffset for at least one of the triggered and triggering cell, and E=0, otherwise, and where μ′ is the SCS for CC₂ or CC₃, N_{slot,offset,1}^{CA} and μ_{offset,1} are the N_{slot,offset}^{CA} and the μ_{offset}, respectively, which are determined by higher-layer configured ca-SlotOffset for the cell transmitting the channel corresponding to numerology μ₁, N_{slot,offset,μ′}^{CA} and 2^{μ}^{_{offset,μ′}} are the N_{slot,offset}^{CA} and the μ_{offset}, respectively, which are determined by higher-layer configured ca-SlotOffset for the cell transmitting the channels corresponding to numerology μ′, as defined in [4, REF6] clause 4.5. In one example, (CC₁, CC₂, CC₃)=(CC_{TCI} CC_{DL}, CC_{UL}). In one example, (CC₁, CC₂, CC₃)=(CC_{UL}, CC_{DL}, CC_{TCI}). In one example, (CC₁, CC₂, CC₃)=(CC_{DL}, CC_{TCI}, CC_{UL}).

In one example V.5.6, one or multiple BAT values are determined/configured and/or reported by the UE (according to at least one example or a combination of examples in embodiment V.2 and/or V.3) for each CC. For two different CCs, the UE applies either a minimum or a maximum of the two BAT values associated with the two different CCs.

In one embodiment VI, a UE is configured with a set S₁ (list) of M₁>1 CCs (or BWPs or cells) for DL reception (of PDCCH or/and PDSCH) or/and UL transmission (of PUCCH or/and PUSCH). The UE is further configured with a common beam or TCI state or TCI state ID indication/activation, where the common TCI state ID update and activation provides common DL beam (e.g. QCL information) at least for UE-dedicated PDCCH/PDSCH reception (by the UE) and/or common UL beam (e.g. UL TX spatial filter(s)) at least for UE-dedicated PUSCH/PUCCH transmission (from the UE) across a set (S₂) of M₂>1 CCs/BWPs, where S₂ belongs to S₁. In one example, S₁=S₂ (and M₁=M₂). In one example, S₂ can be a strict subset of S₁, hence may not include all M₁ CCs/BWPs, i.e., M₁>M₂. The common TCI state ID can be transmitted via DCI or/and MAC CE.

The common TCI state ID activates/indicates a TCI state from a TCI state pool. In one example, the TCI state pool is configured via RRC. For example, the TCI state pool is configured via PDSCH configuration PDSCH-Config for a CC/BWP. When the PDSCH configuration PDSCH-Config includes multiple TCI state pools, then the common TCI state ID activates/indicates a TCI state from one of the multiple TCI state pools. The number of configured TCI state pools in a CC/BWP can be subject to (conditioned on) the UE capability information reported by the UE, the UE capability information can include information on the number of or the maximum number of TCI state pools that the UE can be configured with within a CC/BWP.

In one example, a CC with index i or CC(i) in the set S₂ can indicate a TCI state pool that is common TCI state pool for multiple CCs in the set S₂, i.e., the TCI state pool indicated via the CC(i) is shared among multiple CCs in the set S₂. In this case, the common TCI state ID indicates a common TCI state from the common TCI state pool for multiple CCs. The multiple CCs corresponds to a set S₃ of M₃>1 CCs/BWPs. In one example, S₂=S₃ (and M₂=M₃). In one example, S₃ can be a strict subset of S₂, hence may not include all M₂ CCs/BWPs, i.e., M₂>M₃. So, in general, the set S₃ can be a subset of S₂, which in turn can be a subset of S₁. In summary, S₁ is a full set of CCs, S₂ is a set of CCs for common TCI state ID indication, and S₃ is a set of CCs for common TCI state pool for the common TCI state ID.

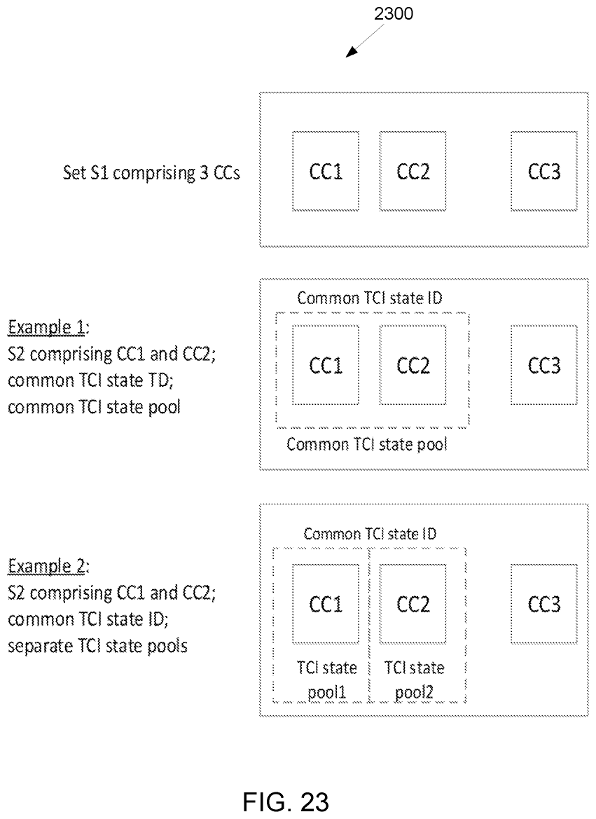

FIG. 23 illustrates examples of configuring common TCI state pool and common TCI state ID across multiple CCs 2300 according to embodiments of the present disclosure The embodiment of the examples of configuring common TCI state pool and common TCI state ID across multiple CCs 2300 illustrated in FIG. 23 is for illustration only. FIG. 23 does not limit the scope of this disclosure to any particular implementation of the examples of configuring common TCI state pool and common TCI state ID across multiple CCs 2300.

FIG. 23 illustrates two examples for the case when S₁ comprises M₁=3 CCs (CC1, CC2, CC3). For both examples, CC1 and CC2 comprises S₂ with M₂=2. In example 1, a common TCI state ID is indicated/activated for both CCs; and the common TCI state ID indicates/activates a TCI state from a common TCI state pool across the two CCs. In example 2, a common TCI state ID is indicated/activated for both CCs; however, the common TCI state ID indicates a TCI state for each CC from their respective separate TCI state pool.

The CC index i or CC(i) indicating the common TCI state pool is either fixed or configured via RRC and/or MAC CE and/or DCI signaling. In one example, the index i or CC(i) is referred to a reference CC/BWP index that indicates the common TCI state pool for multiple CCs in S₃. The details about the reference CC/BWP (or index) and the common TCI state pool are according to at least one of the following embodiments.

In one embodiment VI.1, S₁=S₂ (and M₁=M₂), and there is one reference CC/BWP indicating one common TCI state pool for multiple CCs in S₃. The reference CC/BWP is determined according to at least one of the following examples.
In one example, the reference CC/BWP CC(i) can be fixed, for example, to a CC with the smallest CC index, or CC(1), in S₃. Hence, there is no need for any signaling/configuration regarding the reference CC/BWP.
In one example, the reference CC/BWP CC(i) is configured, e.g., via PDSCH-Config or via a RRC parameter that is not included in PDSCH-Config.
In one example, the reference CC/BWP CC(i) is derived implicitly.
In one example, the reference CC/BWP CC(i) is outside the set of CCs/BWPs S₃. That is, the common TCI state pool is configured via a reference CC/BWP that may not belong to S₃, and whose TCI state may not be indicated via the common TCI state ID indicating the common TCI state for CCs in S₃.

The TCI state pool can be configured in the PDSCH configuration (PDSCH-Config) for each BWP/CC. In one example, tci-StateToAddModList and tci-StateToReleaseList in PDSCH-Config together determine the TCI state pool, the details of which is illustrated in Table 5 and can be found in TS 38.331. The PDSCH-Config is configured via the information element (IE) BWP-DownlinkDedicated, which also includes the BWP-Id. The set of configured BWP-Ids is provided via the IE ServingCellConfig, which in turn is provided via the IEs SpCellConfig or SCellConfig in CellGroupConfig. The corresponding cell indices are also provided via SpCellConfig and SCellConfig.

TABLE 5

| | |
|---|---|
| CellGroupConfig : : = | SEQUENCE { |
| cellGroupId | CellGroupId, |
| . . . | OPTIONAL, -- Need M |
| spCellConfig | SpCellConfig |

OPTIONAL, -- Need M

| | |
|---|---|
| sCellToAddModList | SEQUENCE (SIZE (1 . . maxNrofSCells) ) OF SCellConfig |

OPTIONAL, -- Need N
. . . ,
}

| | |
|---|---|
| SpCellConfig : : = | SEQUENCE { |
| servCellIndex | ServCellIndex |

OPTIONAL, -- Cond SCG
. . .

| | |
|---|---|
| spCellConfigDedicated | ServingCellConfig |

OPTIONAL, -- Need M
. . .
}

| | |
|---|---|
| SCellConfig : : = | SEQUENCE { |
| sCellIndex | SCellIndex, |

. . .

| | |
|---|---|
| sCellConfigDedicated | ServingCellConfig |

```
OPTIONAL, -- Cond SCellAddMod
  . . . ,
  }
```

| | |
|---|---|
| ServingCellConfig : : = | SEQUENCE { |

. . .

| | |
|---|---|
| downlinkBWP-ToReleaseList | SEQUENCE (SIZE (1 . . maxNrofBWPs) ) OF BWP-Id |

OPTIONAL, -- Need N

| | |
|---|---|
| downlinkBWP-ToAddModList | SEQUENCE (SIZE (1 . . maxNrofBWPs) ) OF BWP-Downlink |

OPTIONAL, -- Need N
...
}

| | |
|---|---|
| BWP-Downlink : : = | SEQUENCE { |
| bwp-Id | BWP-Id, |

. . .

| | |
|---|---|
| bwp-Dedicated | BWP-DownlinkDedicated |

OPTIONAL, -- Cond SetupOtherBWP
. . .
}

| | |
|---|---|
| BWP-DownlinkDedicated : : = | SEQUENCE { |

. . .

| | |
|---|---|
| pdsch-Config | SetupRelease { PDSCH-Config } |

OPTIONAL, -- Need M
. . .
}

| | |
|---|---|
| PDSCH-Config : : = | SEQUENCE { |

. . .

| | |
|---|---|
| tci-StatesToAddModList | SEQUENCE (SIZE(1 . . maxNrofTCI-States) ) OF TCI-State |

OPTIONAL, -- Need N

| | |
|---|---|
| tci-StatesToReleaseList | SEQUENCE (SIZE(1 . . maxNrofTCI-States) ) OF TCI-StateId |

OPTIONAL, -- Need N
. . .
}

For a CC/BWP in S₃ that is not a reference CC/BWP, the TCI state pool is absent in the corresponding PDSCH configuration (PDSCH-Config) for that BWP/CC, and the TCI state pool for this CC/BWP is obtained via a reference CC/BWP or (a reference to) the TCI state pool in the reference BWP/CC. In one example, the reference is indicated via higher layer parameter/information, e.g., via reference-Id or tci-PoolReference-Id. In the PDSCH configuration (PDSCH-Config) of the reference BWP/CC, the (common) TCI state pool shall be configured. In one example, the parameter/information indicates the cell-Id and/or the BWP-Id of the reference CC/BWP, as shown in Table 6.

TABLE 6

| | |
|---|---|
| tci-PoolReference-Id : : = | SEQUENCE { |
| cell | ServCellIndex |
| bwp-Id | BWP-Id |

}

A few examples of the signaling of this parameter/information are provided below.

TABLE 7

| | |
|---|---|
| PDSCH-Config : : = | SEQUENCE { |

. . .

| | |
|---|---|
| tci-StatesToAddModList | SEQUENCE (SIZE(1 . . maxNrofTCI-States) ) OF TCI-State |

OPTIONAL, -- Need N

| | |
|---|---|
| tci-StatesToReleaseList | SEQUENCE (SIZE(1 . . maxNrofTCI-States) ) OF TCI-StateId |

OPTIONAL, -- Need N

| | |
|---|---|
| tci-PoolReference | tci-PoolReference-Id |

. . .
}

In one example VI.1.1, the higher layer parameter/information (e.g., reference-Id or tci-PoolReference-Id) is included in the PDSCH-Config for each CC/BWP, as shown in Table 7. For a BWP/CC whose PDSCH configuration contains the information/parameter about the reference (as explained above), the UE applies the TCI state pool in the reference BWP/CC indicated via the information/parameter.

In one example, the TCI state pool is replaced with an information/parameter, where the information/parameter either indicates the reference CC/BWP or (a reference to) the TCI state pool in the reference BWP/CC.

The TCI state pool being absent in a CC/BWP implies that the information/parameter about the reference is present in the respective PDSCH-Config and at least one of the following can happen.
Both tci-StateToAddModList and tci-StateToReleaseList are absent (not provided or configured) in the respective PDSCH-Config.
Or, tci-StateToAddModList is absent (not provided or configured) and tci-StateToReleaseList is present and releases all TCI-StateIds.
Or, both tci-StateToAddModList and tci-StateToReleaseList are present (configured), but they are ignored by the UE if the information/parameter about the reference is provided.

In one example, either the TCI state pool or the information/parameter about the reference (not both) can be included in the PDSCH-Config, i.e., if one of the two is configured (provided), the other must be absent (not provided).

In one example, the information/parameter about the reference is via a separate parameter in PDSCH-Config from the parameters for the TCI state pool. An example is shown in Table 7.

In one example, the information/parameter about the reference is included with one of the parameters for the TCI state pool. An example is shown in Table 8, wherein tci-StatesToAddModList-r17 included PDSCH-Config has two components: a list of TCI states (tci-StatesToAddModList) and tci-PoolReference.

TABLE 8

| | |
|---|---|
| PDSCH-Config : : = | SEQUENCE { |

. . .

| | |
|---|---|
| tci-StatesToAddModList | SEQUENCE (SIZE(1 . . maxNrofTCI-States) ) OF TCI-State |

OPTIONAL, -- Need N

| | |
|---|---|
| tci-StatesToReleaseList-r17 | SEQUENCE (SIZE(1 . . maxNrofTCI-States) ) OF TCI-StateId |

OPTIONAL, -- Need N
. . .
}

| | |
|---|---|
| tci-StatesToAddModList-r17 | SEQUENCE { |
| tci-StatesToAddModList | SEQUENCE (SIZE(1 . . maxNrofTCI-States) ) OF TCI-State |

OPTIONAL, -- Need N

| | |
|---|---|
| tci-PoolReference | tci-PoolReferenee-Id |

}

In one example VI.1.2, the higher layer parameter/information (e.g., reference-Id or tci-PoolReference-Id) about the reference CC/BWP is not included in PDSCH-Config, it is rather provided via CellGroupConfig IE that is used to configure a master cell group (MCG) or secondary cell group (SCG). A cell group comprises of one MAC entity, a set of logical channels with associated RLC entities and of a primary cell (SpCell) and one or more secondary cells (SCells). Two examples are provided in Table 9 for the case when only one reference can be configured (Example 1), and for the case when multiple references can be configured (Example 2 shows two references). The parameter commonTCIPool_CCList indicates the list of CCs/BWPs the common TCI state pool applies for, and the parameter tci-PoolReference indicates the reference BWP/CC from which the common TCI state pool can be obtained. An equivalent description of the two examples is shown in Table 10, wherein the CCList and the reference are included as components of one parameter Tci_PoolReference.

TABLE 9
Example 1

| | |
|---|---|
| CellGroupConfig : : = | SEQUENCE { |

. . .

| | | |
|---|---|---|
| commonTCIPool_CCList | SEQUENCE (SIZE (1 . . maxNrofServingCellsCommonTCI) ) OF ServCellIndex | OPTIONAL, |
| tci-PoolReference | Tci-PoolReference-Id | OPTIONAL, |

...
}
Example 2

| | |
|---|---|
| CellGroupConfig : : = | SEQUENCE { |

. . .

| | | |
|---|---|---|
| commonTCIPool_CCList1 | SEQUENCE (SIZE (1 . . maxNrofServingCellsCommonTCI) ) OF ServCellIndex | OPTIONAL, |
| tci-PoolReference1 | Tci-PoolReference-Id | OPTIONAL, |
| commonTCIPool_CCList2 | SEQUENCE (SIZE (1 . . maxNrofServingCellsCommonTCI) ) OF ServCellIndex | OPTIONAL, |
| tci-PoolReference2 | Tci-PoolReference-Id | OPTIONAL, |

...
}

TABLE 10
Example 1

| | |
|---|---|
| CellGroupConfig : : = | SEQUENCE { |

. . .

| | |
|---|---|
| Tci-PoolReference-r17 | Tci-PoolReference |

...
}
Example 2

| | |
|---|---|
| CellGroupConfig : : = | SEQUENCE { |

. . .

| | | |
|---|---|---|
| Tci-PoolReference-r17 | SEQUENCE (SIZE (1 . . maxNrTciPoolReference) ) OF Tci-PoolReference | OPTIONAL, |

...
}

| Tci-PoolReference : : = | SEQUENCE { | |
|---|---|---|
| commonTCIPool_CCList | SEQUENCE (SIZE (1 . . maxNrofServingCellsCommonTCI) ) OF ServCellIndex | OPTIONAL, |
| tci-PoolReference | Tci-PoolReference-Id | OPTIONAL, |

}

In one example VI.1.3, which is a variation of example I.1.2, the higher layer parameter/information (e.g., reference-Id or tci-PoolReference-Id) about the reference CC/BWP is not included in PDSCH-Config, it is rather provided via CellGroupConfig IE. Two examples are provided in Table 11 for the case when only one reference can be configured (Example 1), and for the case when multiple references can be configured (Example 2 shows two references). The parameter commonTCIPool_CCList indicates the list of CCs/BWPs the common TCI state pool applies for. Note that the parameter tci-PoolReference indicating the reference BWP/CC (as in example VI.1.2) is not provided explicitly, it is rather obtained implicitly. For example, the reference CC/BWP for a list of CCs/BWPs is one of the CCs in the list, and which corresponds to the CC/BWP whose PDSCH-Config includes the TCI state pool. In this example, the TCI state pool is included in PDSCH-Config of only one CC/BWP from the list of CCs/BWPs, and TCI state pool is not included in PDSCH-Config of the remaining CCs/BWPs from the list of CCs/BWPs. An equivalent description of the two examples is shown in Table 12, wherein the CCList is included as a component of one parameter Tci_PoolReference.

TABLE 11
Example 1

| | |
|---|---|
| CellGroupConfig : : = | SEQUENCE { |

. . .

| | | |
|---|---|---|
| commonTCIPool_CCList | SEQUENCE (SIZE (1 . . maxNrofServingCellsCommonTCI) ) OF ServCellIndex | OPTIONAL, |

...
}
Example 2

| | |
|---|---|
| CellGroupConfig : : = | SEQUENCE { |

. . .

| | | |
|---|---|---|
| commonTCIPool_CCList1 | SEQUENCE (SIZE (1 . . maxNrofServingCellsCommonTCI) ) OF ServCellIndex | OPTIONAL, |
| commonTCIPool_CCList2 | SEQUENCE (SIZE (1 . . maxNrofServingCellsCommonTCI) ) OF ServCellIndex | OPTIONAL, |

...
}

TABLE 12
Example 1

| | |
|---|---|
| CellGroupConfig : : = | SEQUENCE { |

. . .

| | |
|---|---|
| Tci-PoolReference-r17 | Tci-PoolReference |

...
}
Example 2

| | |
|---|---|
| CellGroupConfig : : = | SEQUENCE { |

. . .

| | | |
|---|---|---|
| Tci-PoolReference-r17 | SEQUENCE (SIZE (1 . . maxNrTciPoolReference) ) OF Tci-PoolReference | OPTIONAL, |

...
}

| Tci-PoolReference | SEQUENCE { | |
|---|---|---|
| commonTCIPool_CCList | SEQUENCE (SIZE (1 . . maxNrofServingCellsCommonTCI) ) OF ServCellIndex | OPTIONAL, |

}

When there is only one TCI state pool configured across CCs in S₂, then that configured TCI state pool is the common TCI state pool, hence S₂=S₃ implying M₁=M₂=M₃.

When there are multiple TCI state pools configured across CCs in S₂, then one of the configured TCI state pool is the common TCI state pool across CCs in S₃, and other TCI state pools are configured for CCs in S₂ but outside S₃, hence S₃ is a strict subset of S₂ implying M₁=M₂>M₃.

In one embodiment VI.2, S₁=S₂ (and M₁=M₂), and there is two reference CCs/BWPs indicating two common TCI state pools for two different subsets of CCs in S₃, namely S_{3,1} and S_{3,2}, where the union of S_{3,1} and S_{3,2} equals S₃ and S_{3,1} and S_{3,2} are disjoint sets, i.e., with no common CC. Each reference CC/BWP iₖ, k∈{1,2} is determined according to at least one of the following examples.
In one example, the reference CC/BWP CC(iₖ) can be fixed, for example, to a CC with the smallest CC index, or CC(1), in S_{3,k} or iₖ=1 indicating the 1^{st} CC in S_{3,k}. Hence, there is no need for any signaling/configuration regarding the reference CC/BWP.
In one example, the reference CC/BWP CC(iₖ) is configured, e.g., via PDSCH-Config or via a RRC parameter that is not included in PDSCH-Config.
In one example, the reference CC/BWP CC(iₖ) is derived implicitly.
In one example, the reference CC/BWP CC(iₖ) is outside the set of CCs/BWPs S_{3,k}. That is, the common TCI state pool is configured via a reference CC/BWP that may not belong to S_{3,k}, and whose TCI state may not be indicated via the common TCI state ID indicating the common TCI state for CCs in S_{3,k}.

The TCI state pool can be configured in the PDSCH configuration (PDSCH-Config) for each BWP/CC, as explained in embodiment I.1 (cf. Table 5).

For a CC/BWP in S_{3,k}, k∈{1,2}, that is not a reference CC/BWP iₖ or CC(iₖ), the TCI state pool is absent in the corresponding PDSCH configuration (PDSCH-Config) for that BWP/CC, and the TCI state pool for this CC/BWP is obtained via k-th reference CC/BWP or (a reference to) the TCI state pool in the k-th reference BWP/CC. In one example, the k-th reference is indicated via higher layer parameter/information, e.g., via reference-Id or tci-PoolReference-Id. In the PDSCH configuration (PDSCH-Config) of the k-th reference BWP/CC, the (common) TCI state pool shall be configured. In one example, the parameter/information indicates the cell-Id and/or the BWP-Id of the k-th reference CC/BWP, as shown in Table 6.

A few examples of the signaling of this parameter/information are provided below.

In one example I.2.1, the higher layer parameter/information (e.g., reference-Id or tci-PoolReference-Id) in included in the PDSCH-Config for each CC/BWP in S_{3,k}, k∈{1,2}, as shown in Table 7. For a BWP/CC in S_{3,k} whose PDSCH configuration contains the k-th information/parameter about the reference iₖ or CC(iₖ) (as explained above), the UE applies the TCI state pool in the reference BWP/CC iₖ or CC(iₖ) indicated via the information/parameter. Note that there are 2 separate information/parameters for the two sets S_{3,k}, k∈{1,2}. The rest of the details about each of the two reference CCs/BWPs are according to example VI.1.1.

In one example VI.2.2, the higher layer parameter/information (e.g., reference-Id or tci-PoolReference-Id) about the two reference CCs/BWPs are not included in PDSCH-Config, they are rather provided via CellGroupConfig IE, as explained in example VI.1.2. Example 2 in Table 9 can be used for the case when two references are configured. The parameters commonTCIPool_CCList1 and commonTCIPool_CCList2 indicate the two lists of CCs/BWPs the two common TCI state pools apply for, respectively, and the parameters tci-PoolReference1 and tci-PoolReference2 indicate the two reference BWPs/CCs from which the two common TCI state pools can be obtained. An equivalent description is shown in Example in Table 10, wherein the CCList and the reference are included as components of one parameter Tci_PoolReference.

In one example VI.2.3, which is a variation of example VI.2.2, the higher layer parameter/information (e.g., reference-Id or tci-PoolReference-Id) about the two reference CCs/BWPs are not included in PDSCH-Config, they are rather provided via CellGroupConfig IE, as explained in example VI.1.2. Example 2 in Table 11 can be used for the case when two references are configured. The parameters commonTCIPool_CCList1 and commonTCIPool_CCList2 indicate the two lists of CCs/BWPs the two common TCI state pools apply for, respectively. Note that the parameters tci-PoolReference1 and tci-PoolReference2 indicating the two reference BWPs/CCs (as in example I.2.2) is not provided explicitly, it is rather obtained implicitly. For example, the k-th reference CC/BWP for a k-th list of CCs/BWPs is one of the CCs in the k-th list, and which corresponds to the CC/BWP whose PDSCH-Config includes the TCI state pool. In this example, the TCI state pool is included in PDSCH-Config of only one CC/BWP from the list of CCs/BWPs, and TCI state pool is not included in PDSCH-Config of the remaining CCs/BWPs from the list of CCs/BWPs. An equivalent description is shown in Example in Table 12, wherein the CCList is included as a component of one parameter Tci_PoolReference.

When there are two TCI state pools configured across CCs in S₂, then the configured TCI state pools are the two common TCI state pools, hence S₂=S₃ implying M₁=M₂=M₃ where M₃=M_{3,1}+M_{3,2}, and M_{3,k} is the number of CCs/BWPs in S_{3,k}.

When there are more than 2 TCI state pools configured across CCs in S₂, then two of the configured TCI state pools are the two common TCI state pools across CCs in S_{3,1} and S_{3,2}, respectively, and other TCI state pools are configured for CCs in S₂ but outside S₃ or outside S_{3,1} and S_{3,2}, hence S₃ is a strict subset of S₂ implying M₁=M₂>M₃ where M₃=M_{3,1}+M_{3,2}.

In one embodiment VI.3, the UE is configured with one reference CC/BWP (and common TCI state pool) or two reference CCs/BWPs (and common TCI state pools) subject to the UE capability information reported by the UE. When the UE is configured with one reference CC/BWP, the details are according to embodiment VI.1, and when the UE is configured with two reference CCs/BWPs, details according to embodiment VI.2.
In one example, the UE reports via the capability information whether it supports 1 or 2 or both 1 and 2 reference CCs/BWPs.
In one example, the UE supports 1 reference CC/BWP without any separate capability information, however, the UE needs to report via the separate capability information whether it supports 2 reference CCs/BWPs. For example, a UE supporting common TCI state ID and/or common TCI state pool, as described in this disclosure, shall support 1 reference CC/BWP, hence can be configured with 1 reference CC/BWP. However, the UE can only be configured with 2 reference CCs/BWPs only when the UE reports its support via a separate/dedicated capability signaling.

In one embodiment VI.4, which is an extension of embodiment I.2, S₁=S₂ (and M₁=M₂), and there is N>1 reference CCs/BWPs indicating N common TCI state pools for N different subsets of CCs in S₃, namely S_{3,1} . . . S_{3,N}, where the union of S_{3,1} . . . S_{3,N} equals S₃ and S_{3,1} . . . S_{3,2} are disjoint sets, i.e., with no common CC. Each reference CC/BWP iₖ, k∈{1, . . . ,N} is determined according to at least one of the following examples.
In one example, the reference CC/BWP CC(iₖ) can be fixed, for example, to a CC with the smallest CC index, or CC(1), in S_{3,k} or iₖ=1 indicating the 1^{st} CC in S_{3,k}. Hence, there is no need for any signaling/configuration regarding the reference CC/BWP.
In one example, the reference CC/BWP CC(iₖ) is configured, e.g., via PDSCH-Config or via a RRC parameter that is not included in PDSCH-Config.
In one example, the reference CC/BWP CC(iₖ) is derived implicitly.
In one example, the reference CC/BWP CC(iₖ) is outside the set of CCs/BWPs S_{3,k}. That is, the common TCI state pool is configured via a reference CC/BWP that may not belong to S_{3,k}, and whose TCI state may not be indicated via the common TCI state ID indicating the common TCI state for CCs in S_{3,k}.

The TCI state pool can be configured in the PDSCH configuration (PDSCH-Config) for each BWP/CC, as explained in embodiment VI.1 (cf. Table 5).

For a CC/BWP in S_{3,k}, k∈{1, . . . ,N}, that is not a reference CC/BWP iₖ or CC(iₖ), the TCI state pool is absent in the corresponding PDSCH configuration (PDSCH-Config) for that BWP/CC, and the TCI state pool for this CC/BWP is obtained via k-th reference CC/BWP or (a reference to) the TCI state pool in the k-th reference BWP/CC. In one example, the k-th reference is indicated via higher layer parameter/information, e.g., via reference-Id or tci-PoolReference-Id. In the PDSCH configuration (PDSCH-Config) of the k-th reference BWP/CC, the (common) TCI state pool shall be configured. In one example, the parameter/information indicates the cell-Id and/or the BWP-Id of the k-th reference CC/BWP, as shown in Table 6.

At least one of example I.2.1 through 1.2.3 is used (after extending to N references) can be used regarding the signaling of this parameter/information.

When there are N TCI state pools configured across CCs in S₂, then the configured TCI state pools are the N common TCI state pools, hence S₂=S₃ implying M₁=M₂=M₃ where M₃=M_{3,1}+ . . . +M_{3,N}, and M_{3,k} is the number of CCs/BWPs in S_{3,k}.

When there are more than N TCI state pools configured across CCs in S₂, then N of the configured TCI state pools are the N common TCI state pools across CCs in S_{3,1} . . . S_{3,2}, respectively, and other TCI state pools are configured for CCs in S₂ but outside S₃ or outside S_{3,1} . . . S_{3,2}, hence S₃ is a strict subset of S₂ implying M₁=M₂>M₃ where M₃=M_{3,1}+ . . . +M_{3,N}.

At least one of the following examples is used regarding the value of N.
In one example, the value of N is fixed, e.g., N=2.
In one example, the value of N is configured, e.g., via higher layer (RRC), MAC CE or DCI signaling.
In one example, the value of N is reported by the UE, e.g., as part of the UE capability information reported by the UE.
In one example, the value of N is configured, e.g., via higher layer (RRC), MAC CE or DCI signaling, and the configured value is subject to the reported value(s) of N by the UE, e.g., as part of the UE capability information reported by the UE.
In one example, the value of N depends on the number of configured CCs/BWPs. For example, N=1 when the number of configured CCs/BWPs<=x, and N=2, otherwise, where x is threshold.

In one embodiment VI.5, the UE is configured with N reference CCs/BWPs (and common TCI state pools) subject to the UE capability information reported by the UE, where N∈T and T is the set of possible values for N.
In one example, T={1, . . . , Nₘₐₓ}, and Nₘₐₓ is the max value of N, which can be fixed or reported by the UE, e.g., as part of the UE capability reporting.
In one example, T={1,2} or {1,2,3} or {1,2,4} or {1,2,3,4}.

When the UE is configured with one reference CC/BWP, the details are according to embodiment I.1, when the UE is configured with two reference CCs/BWPs, details according to embodiment VI.2, and when the UE is configured with N>1 reference CCs/BWPs, details according to embodiment VI.4.
In one example, the UE reports via the capability information whether it supports only one or multiple values from T.
In one example, the UE supports 1 reference CC/BWP without any separate capability information, however, the UE needs to report via the separate capability information whether it supports N>1 reference CCs/BWPs. For example, a UE supporting common TCI state ID and/or common TCI state pool, as described in this disclosure, shall support 1 reference CC/BWP, hence can be configured with 1 reference CC/BWP. However, the UE can only be configured with N>1 reference CCs/BWPs only when the UE reports its support via a separate/dedicated capability signaling.

In one embodiment VI.6, S₂ is a strict subset of S₁, hence does not include all M₁ CCs/BWPs in S₁, i.e., M₁>M₂. So, S₂ can be expressed as a union of two subsets S_{2,1} and S_{2,2}, where S_{2,1} includes M_{2,1}>1 CCs/BWPs for common TCI state ID indication/activation, and S_{2,2} includes M_{2,2} CCs/BWPs for independent (separate) per CC TCI state ID indication/activation, where M_{2,1}+M_{2,2}=M₂=M₁. For the CCs/BWPs in the set S_{2,1}, there is one reference CC/BWP indicating one common TCI state pool for multiple CCs in S₃, where either S₃=S_{2,1} or S₃ is a subset of S_{2,1}. The rest of the details about the one reference CC/BWP and one common TCI state pool are according to embodiment VI.1 except that S₂ is replaced with S_{2,1} everywhere in embodiment VI.1.

When there is only one TCI state pool configured across CCs in S_{2,1}, then that configured TCI state pool is the common TCI state pool, hence S_{2,1}=S₃ implying M₁>M_{2,1}=M₃.

When there are multiple TCI state pools configured across CCs in S_{2,1}, then one of the configured TCI state pool is the common TCI state pool across CCs in S₃, and other TCI state pools are configured for CCs in S_{2,1} but outside S₃, hence S₃ is a strict subset of S_{2,1} implying M₁>M_{2,1}>M₃.

For each CC/BWP in S_{2,2}, a TCI state ID is indicated/activated separately (independently) that indicates a TCI state from a TCI state pool which is configured in PDSCH-Config of that particular CC/BWP.

In one embodiment VI.7, S₂ is a strict subset of S₁, hence does not include all M₁ CCs/BWPs in S₁, i.e., M₁>M₂. So, S₂ can be expressed as a union of two subsets S_{2,1} and S_{2,2}, where S_{2,1} includes M_{2,1}>1 CCs/BWPs for common TCI state ID indication/activation, and S_{2,2} includes M_{2,2} CCs/BWPs for independent (separate) per CC TCI state ID indication/activation, where M_{2,1}+M_{2,2}=M₂=M₁. For the CCs/BWPs in the set S_{2,1}, there is two reference CCs/BWPs indicating two common TCI state pools for two subsets of CCs in S₃, namely S_{3,1} and S_{3,2}, where the union of S_{3,1} and S_{3,2} equals S₃ and S_{3,1} and S_{3,2} are disjoint sets, i.e., with no common CC, and either S₃=S_{2,1} or S₃ is a subset of S_{2,1}. The rest of the details about the two reference CCs/BWPs and two common TCI state pools are according to embodiment VI.2 except that S₂ is replaced with S_{2,1} everywhere in embodiment VI.2.

When there are two TCI state pools configured across CCs in S₂, then the configured TCI state pools are the two common TCI state pools, hence S_{2,1}=S₃ implying M₁>M_{2,1}=M₃ where M₃=M_{3,1}+M_{3,2}, and M_{3,k} is the number of CCs/BWPs in S_{3,k}.

When there are more than 2 TCI state pools configured across CCs in S_{2,1}, then two of the configured TCI state pools are the two common TCI state pools across CCs in S_{3,1} and S_{3,2}, respectively, and other TCI state pools are configured for CCs in S_{2,1} but outside S₃ or outside S_{3,1} and S_{3,2}, hence S₃ is a strict subset of S_{2,1} implying M₁>M_{2,1}>M₃ where M₃=M_{3,1}+M_{3,2}.

For each CC/BWP in S_{2,2}, a TCI state ID is indicated/activated separately (independently) that indicates a TCI state from a TCI state pool which is configured in PDSCH-Config of that particular CC/BWP.

In one embodiment VI.8, the UE is configured with one reference CC/BWP (and common TCI state pool) or two reference CCs/BWPs (and common TCI state pools) subject to the UE capability information reported by the UE. When the UE is configured with one reference CC/BWP, the details are according to embodiment I.1 or I.6, and when the UE is configured with two reference CCs/BWPs, details according to embodiment I.2 or I.7.
In one example, the UE reports via the capability information whether it supports 1 or 2 or both 1 and 2 reference CCs/BWPs.
In one example, the UE supports 1 reference CC/BWP without any separate capability information, however, the UE needs to report via the separate capability information whether it supports 2 reference CCs/BWPs. For example, a UE supporting common TCI state ID and/or common TCI state pool, as described in this disclosure, shall support 1 reference CC/BWP, hence can be configured with 1 reference CC/BWP. However, the UE can only be configured with 2 reference CCs/BWPs only when the UE reports its support via a separate/dedicated capability signaling.

In one embodiment VI.9, which is an extension of embodiment VI.7, S₂ is a strict subset of S₁, hence S₂ can be expressed as a union of two subsets S_{2,1} and S_{2,2}, details as in embodiment VI.7, and there is N>1 reference CCs/BWPs indicating N common TCI state pools for N different subsets of CCs in S₃, namely S_{3,1} . . . S_{3,N}, where the union of S_{3,1} . . . S_{3,N} equals S₃ and S_{3,1} . . . S_{3,2} are disjoint sets, i.e., with no common CC, and either S₃=S_{2,1} or S₃ is a subset of S_{2,1}. The rest of the details about the N reference CCs/BWPs and N common TCI state pools are according to embodiment VI.4 except that S₂ is replaced with S_{2,1} everywhere in embodiment VI.4.

When there are N TCI state pools configured across CCs in S_{2,1}, then the configured TCI state pools are the N common TCI state pools, hence S_{2,1}=S₃ implying M₁>M_{2,1}=M₃ where M₃=M_{3,1}+ . . . M_{3,N}, and M_{3,k} is the number of CCs/BWPs in S_{3,k}.

When there are more than N TCI state pools configured across CCs in S_{2,1}, then N of the configured TCI state pools are the N common TCI state pools across CCs in S_{3,1} . . . S_{3,2}, respectively, and other TCI state pools are configured for CCs in S_{2,1} but outside S₃ or outside S_{3,1} . . . S_{3,2}, hence S₃ is a strict subset of S_{2,1} implying M₁>M_{2,1}>M₃ where M₃=M_{3,1}+ . . . M_{3,N}.

In one embodiment VI.10, the UE is configured with N reference CCs/BWPs (and common TCI state pools) subject to the UE capability information reported by the UE, where N∈T and T is the set of possible values for N.
In one example, T={1, . . . , Nₘₐₓ}, and Nₘₐₓ is the max value of N, which can be fixed or reported by the UE, e.g., as part of the UE capability reporting.
In one example, T={1,2} or {1,2,3} or {1,2,4} or {1,2,3,4}.

When the UE is configured with one reference CC/BWP, the details are according to embodiment VI.1 or 1.6, when the UE is configured with two reference CCs/BWPs, details according to embodiment VI.2 or VI.7, and when the UE is configured with N>1 reference CCs/BWPs, details according to embodiment VI.4 or VI.9.
In one example, the UE reports via the capability information whether it supports only one or multiple values from T.
In one example, the UE supports 1 reference CC/BWP without any separate capability information, however, the UE needs to report via the separate capability information whether it supports N>1 reference CCs/BWPs. For example, a UE supporting common TCI state ID and/or common TCI state pool, as described in this disclosure, shall support 1 reference CC/BWP, hence can be configured with 1 reference CC/BWP. However, the UE can only be configured with N>1 reference CCs/BWPs only when the UE reports its support via a separate/dedicated capability signaling.

In embodiment VI, the three sets of CCs/BWPs, S₁, S₂, and S₃, in embodiment VI (and VI.1 through VI.10) that corresponds to three levels:
Level 1 (based on S₁): all CCs/BWPs/cells that are configured.
Level 2 (based on S₂): CCs/BWPs/cells that are indicated with the common TCI state ID.

There can be one or multiple of these groups within the first level.
Level 3 (based on S₃): CCs/BWPs/cells that share the common TCI state pool. There can be one or multiple of these within the second level.

In one embodiment VII.1, the three sets of CCs/BWPs, S₁, S₂, and S₃, in embodiment VI (and VI.1 through VI.10) that corresponds to three levels are rearranged or reordered. For example, the order of sets S₂ and S₃ are switched, i.e., from S₁, S₂, and S₃ to S₁, S₃, and S₂. Hence, level 2 is based on S₃ comprising CCs/BWPs that share the common TCI state pool(s), and within the common TCI state pool(s) set, level 3 is based on S₂ comprising CCs/BWPs that are indicated with common TCI state ID. In general, levels 2 and 3 and hence sets S₂ and S₃ might be partially overlapping.
Level 1 (based on S₁): all CCs/BWPs/cells that are configured.
Level 2 (based on S₃): CCs/BWPs/cells that share the common TCI state pool. There can be one or multiple of these within the first level.
Level 3 (based on S₂): CCs/BWPs/cells that are indicated with the common TCI state ID.

There can be one or multiple of these groups within the second level.

The rest of the details of embodiment VI (and VI.1 through VI.10), including the signaling for the reference CC/BWP, apply to this embodiment in a straightforward manner.

In one example VII.1.1, the level 2 and 3 have the same set of CCs/BWPs, i.e., S₂=S₃.

In one example VII.1.2, the level 2 includes the set of CCs/BWPs in level 3, i.e., S₃ is a subset of S₂.

In one example VII.1.3, the level 3 includes the set of CCs/BWPs in level 2, i.e., S₂ is a subset of S₃.

In one embodiment VII.2, the sets or grouping of CCs/BWPs/cells for the common TCI state ID indication for UL and DL can be different. For example, for DL, the UE can be configured with a common TCI state pool for a set of CCs/BWPs/cells S_{d}, and for UL, there can be multiple sets of cells S_{ul,k}, k=1, . . . , K within S_{d}, and each set S_{u,k} has its own common TCI state pool, and K is the number of sets for UL. So, there are K sets for UL, and they are within one set for DL, hence, there are one common TCI state pool for DL and K TCI state pools for UL.

Similarly, for TCI state ID indication, a similar approach can be used. For DL beam indication, the UE is indicated with a common TCI state ID for a set of CCs/BWPs/cells S_{d}, and for UL beam indication, there are multiple sets of cells S_{ul,k}, k=1, . . . , K within this set S_{d}, and the UE is configured with a common TCI state ID for each set S_{u,k}. So, there are K sets for UL, and they are within one set for DL, hence, there are one common TCI state ID for DL and K TCI state IDs for UL.

The rests of the details of embodiment VI (and VIA through VI.10), including the signaling for the reference CC/BWP, apply to this embodiment in a straightforward manner.

Any of the above variation embodiments can be utilized independently or in combination with at least one other variation embodiment.

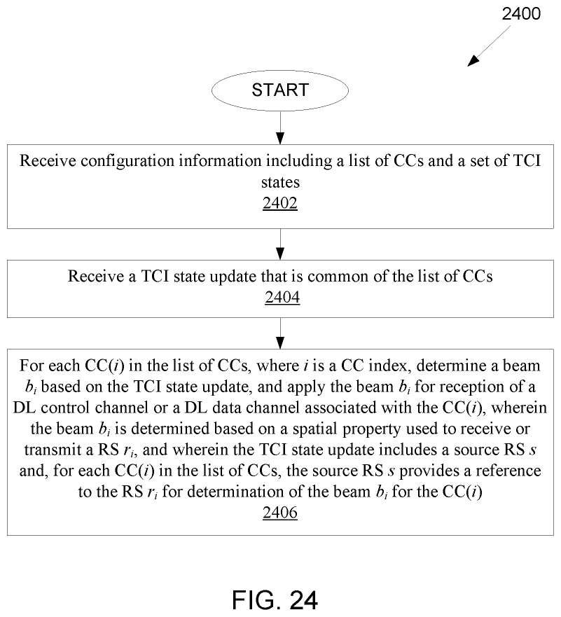

FIG. 24 illustrates a flow chart of a method 2400 for operating a user equipment (UE), as may be performed by a UE such as UE 116, according to embodiments of the present disclosure. The embodiment of the method 2400 illustrated in FIG. 24 is for illustration only. FIG. 24 does not limit the scope of this disclosure to any particular implementation.

As illustrated in FIG. 24, the method 2400 begins at step 2402. In step 2402, the UE (e.g., 111-116 as illustrated in FIG. 1) receives configuration information including a list of CCs and a set of TCI states.

In step 2404, the UE receives a TCI state update that is common for the list of CCs.

In step 2406, the UE, for each CC(i) in the list of CCs, where i is a CC index: determines a beam bᵢ based on the TCI state update, and applies the beam bᵢ for reception of a DL control channel or a DL data channel associated with the CC(i), wherein the beam bᵢ is determined based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

In one embodiment, the reference to the RS rᵢ for a CC(i) is the source RS s indicated via the TCI state update.

In one embodiment, reference RSs for the list of CCs are associated with a single common reference RS, and the single common reference RS is determined based on the source RS s indicated via the TCI state update.

In one embodiment, when a bandwidth part identifier (BWP-ID) or a component carrier identifier (CC-ID) for the source RS s, indicated via the TCI state update, is not configured, the source RS s is configured in a CC/BWP where the TCI state applies.

In one embodiment, when the TCI state update indicates to a joint TCI state for both DL and uplink (UL), the UE is configured to apply the beam bᵢ for the CC(i) for a transmission of an UL control channel or an UL data channel associated with the CC(i).

In one embodiment, when the TCI state update indicates one or both of two separate TCI states, a DL TCI state and an uplink (UL) TCI state, then for each CC(i), the UE is configured to: when the DL TCI state is indicated, determine the beam bᵢ based on the DL TCI state, when the UL TCI state is indicated, determine an UL transmit beam based on the UL TCI state, and apply the UL transmit beam for a transmission of an UL control channel or an UL data channel associated with the CC(i).

In one embodiment, for DL, the spatial property corresponds to quasi co-location (QCL)-Type D indicating a spatial receive (Rx) filter, and for UL, the spatial property corresponds to an UL spatial filter.

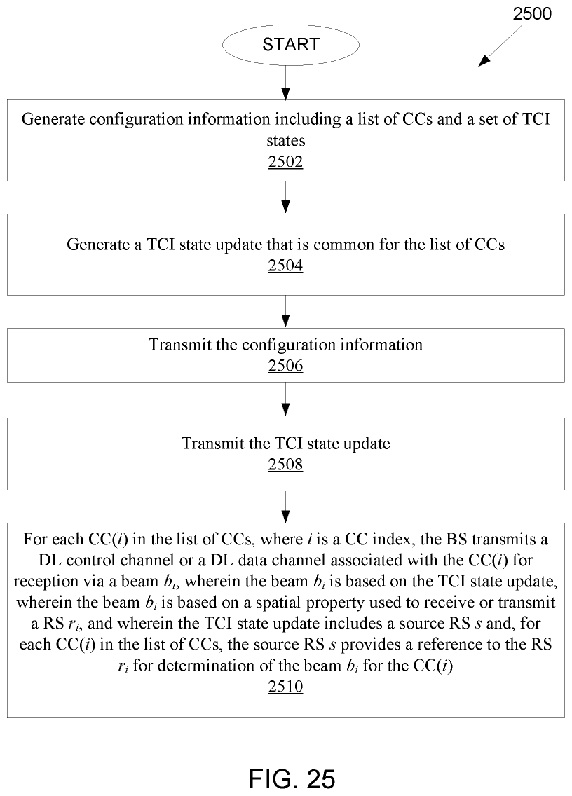

FIG. 25 illustrates a flow chart of another method 2500, as may be performed by a base station (BS) such as BS 102, according to embodiments of the present disclosure. The embodiment of the method 2500 illustrated in FIG. 25 is for illustration only. FIG. 25 does not limit the scope of this disclosure to any particular implementation.

As illustrated in FIG. 25, the method 2500 begins at step 2502. In step 2502, the BS (e.g., 101-103 as illustrated in FIG. 1), generates configuration information including a list of CCs and a set of TCI states.

In step 2504, the BS generates a TCI state update that is common for the list of CCs.

In step 2506, the BS transmits the configuration information.

In step 2508, the BS transmits the TCI state update.

In step 2510, for each CC(i) in the list of CCs, where i is a CC index, the BS transmits a DL control channel or a DL data channel associated with the CC(i) for reception via a beam bᵢ, wherein the beam bᵢ is based on the TCI state update, wherein the beam bᵢ is based on a spatial property used to receive or transmit a RS rᵢ, and wherein the TCI state update includes a source RS s and, for each CC(i) in the list of CCs, the source RS s provides a reference to the RS rᵢ for determination of the beam bᵢ for the CC(i).

In one embodiment, the reference to the RS rᵢ for a CC(i) is the source RS s indicated via the TCI state update.

In one embodiment, reference RSs for the list of CCs are associated with a single common reference RS, and the single common reference RS is determined based on the source RS s indicated via the TCI state update.

In one embodiment, when a bandwidth part identifier (BWP-ID) or a component carrier identifier (CC-ID) for the source RS s, indicated via the TCI state update, is not configured, the source RS s is configured in a CC/BWP where the TCI state applies.

In one embodiment, when the TCI state update indicates to a joint TCI state for both DL and uplink (UL), the BS is configured to receive an UL control channel or an UL data channel associated with the CC(i) transmitted via the beam bᵢ.

In one embodiment, when the TCI state update indicates one or both of two separate TCI states, a DL TCI state and an uplink (UL) TCI state, then for each CC(i), the BS is configured to: for each CC(i): when the DL TCI is indicated, transmit a DL control channel or a DL data channel for reception via the beam bᵢ based on the DL TCI state, and when the UL TCI is indicated, receive an UL control channel or an UL data channel transmitted via an UL transmit beam that is determined based on the UL TCI state.

In one embodiment, for DL, the spatial property corresponds to quasi co-location (QCL)-Type D indicating a spatial receive (Rx) filter, and for UL, the spatial property corresponds to an UL spatial filter.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to:
receive configuration information including a list of component carriers (CCs) and a set of transmission configuration indicator (TCI) states; and
receive a TCI state update that is common for the list of CCs; and
a processor operably coupled to the transceiver, the processor configured to:
for each CC(i) in the list of CCs, where i is a CC index:
determine a beam bᵢ based on the TCI state update, and
apply the beam bᵢ for reception of a downlink (DL) control channel or a DL data channel associated with the CC(i),
wherein the beam bᵢ is determined based on a spatial property used to receive or transmit a reference signal (RS) rᵢ, and
wherein the TCI state update includes a source RS s and, for each CC(i) in the list of CCs, the source RS s provides a reference to the RS r₁ for determination of the beam bᵢ for the CC(i).

2. The UE of claim 1, wherein the reference to the RS rᵢ for a CC(i) is the source RS s indicated via the TCI state update.

3. The UE of claim 1, wherein:
reference RSs for the list of CCs are associated with a single common reference RS, and
the single common reference RS is determined based on the source RS s indicated via the TCI state update.

4. The UE of claim 1, wherein when a bandwidth part identifier (BWP-ID) or a component carrier identifier (CC-ID) for the source RS s, indicated via the TCI state update, is not configured, the source RS s is configured in a CC/BWP where the TCI state applies.

5. The UE of claim 1, wherein, when the TCI state update indicates to a joint TCI state for both DL and uplink (UL), the processor is configured to apply the beam bᵢ for the CC(i) for a transmission of an UL control channel or an UL data channel associated with the CC(i).

6. The UE of claim 1, wherein when the TCI state update indicates one of or both of two separate TCI states, a DL TCI state and an uplink (UL) TCI state, then for each CC(i), the processor is configured to:
when the DL TCI state is indicated, determine the beam bᵢ based on the DL TCI state,
when the UL TCI state is indicated, determine an UL transmit beam based on the UL TCI state, and
apply the UL transmit beam for a transmission of an UL control channel or an UL data channel associated with the CC(i).

7. The UE of claim 6, wherein:
for DL, the spatial property corresponds to quasi co-location (QCL)-Type D indicating a spatial receive (Rx) filter, and
for UL, the spatial property corresponds to an UL spatial filter.

8. A base station (BS) comprising:
a processor configured to:
generate configuration information including a list of component carriers (CCs) and a set of transmission configuration indicator (TCI) states; and
generate a TCI state update that is common for the list of CCs; and
a transceiver operably coupled to the processor, the transceiver configured to:
transmit the configuration information;
transmit the TCI state update; and
for each CC(i) in the list of CCs, where i is a CC index:
transmit a downlink (DL) control channel or a DL data channel associated with the CC(i) for reception via a beam bᵢ,
wherein the beam bᵢ is based on the TCI state update,
wherein the beam bᵢ is based on a spatial property used to receive or transmit a reference signal (RS) rᵢ, and
wherein the TCI state update includes a source RS s and, for each CC(i) in the list of CCs, the source RS s provides a reference to the RS rᵢ for determination of the beam bᵢ for the CC(i).

9. The BS of claim 8, wherein the reference to the RS rᵢ for a CC(i) is the source RS s indicated via the TCI state update.

10. The BS of claim 8, wherein:
reference RSs for the list of CCs are associated with a single common reference RS, and
the single common reference RS is determined based on the source RS s indicated via the TCI state update.

11. The BS of claim 8, wherein when a bandwidth part identifier (BWP-ID) or a component carrier identifier (CC-ID) for the source RS s, indicated via the TCI state update, is not configured, the source RS s is configured in a CC/BWP where the TCI state applies.

12. The BS of claim 8, wherein, when the TCI state update indicates to a joint TCI state for both DL and uplink (UL), the transceiver is configured to receive an UL control channel or an UL data channel associated with the CC(i) transmitted via the beam bᵢ.

13. The BS of claim 8, wherein when the TCI state update indicates one of or both of two separate TCI states, a DL TCI state and an uplink (UL) TCI state, the transceiver is configured to:
for each CC(i):
when the DL TCI state is indicated, transmit a DL control channel or a DL data channel for reception via the beam bᵢ based on the DL TCI state, and
when the UL TCI state is indicated, receive an UL control channel or an UL data channel transmitted via an UL transmit beam that is determined based on the UL TCI state.

14. The BS of claim 13, wherein:
for DL, the spatial property corresponds to quasi co-location (QCL)-Type D indicating a spatial receive (Rx) filter, and
for UL, the spatial property corresponds to an UL spatial filter.

15. A method for operating a user equipment (UE), the method comprising:
receiving configuration information including a list of component carriers (CCs) and a set of transmission configuration indicator (TCI) states;
receiving a TCI state update that is common for the list of CCs; and
for each CC(i) in the list of CCs, where i is a CC index:
determining a beam bᵢ based on the TCI state update, and
applying the beam bᵢ for reception of a downlink (DL) control channel or a DL data channel associated with the CC(i),
wherein the beam bᵢ is determined based on a spatial property used to receive or transmit a reference signal (RS) rᵢ, and
wherein the TCI state update includes a source RS s and, for each CC(i) in the list of CCs, the source RS s provides a reference to the RS rᵢ for determination of the beam bᵢ for the CC(i).

16. The method of claim 15, wherein the reference to the RS rᵢ for a CC(i) is the source RS s indicated via the TCI state update.

17. The method of claim 15, wherein:
reference RSs for the list of CCs are associated with a single common reference RS, and
the single common reference RS is determined based on the source RS s indicated via the TCI state update.

18. The method of claim 15, wherein when a bandwidth part identifier (BWP-ID) or a component carrier identifier (CC-ID) for the source RS s, indicated via the TCI state update, is not configured, the source RS s is configured in a CC/BWP where the TCI state applies.

19. The method of claim 15, wherein, when the TCI state update indicates to a joint TCI state for both DL and uplink (UL), the method further comprise applying the beam bᵢ for the CC(i) for a transmission of an UL control channel or an UL data channel associated with the CC(i).

20. The method of claim 15, wherein when the TCI state update indicates one of or both of two separate TCI states, a DL TCI state and an uplink (UL) TCI state, the method further comprises:
for each CC(i):
when the DL TCI state is indicated, determining the beam bᵢ based on the DL TCI state,
when the UL TCI state is indicated, determining an UL transmit beam based on the UL TCI state, and
applying the UL transmit beam for a transmission of an UL control channel or an UL data channel associated with the CC(i).
